(19) United States
(12) Patent Application Publication
(10) Pub. No.: US 2026/0035969 A1
(43) Pub. Date: Feb. 5, 2026

(54) SECURITY DOORSTOP AND ALARM

(71) Applicant: BEESTOP LLC, Scottsdale, AZ (US)

(72) Inventor: Mitchell R. Cooper, Cave Creek, AZ (US)

(73) Assignee: BEESTOP LLC, Scottsdale, AZ (US)

(21) Appl. No.: 19/230,062

(22) Filed: Jun. 5, 2025

Related U.S. Application Data
(63) Continuation-in-part of application No. PCT/US2024/058833, filed on Dec. 6, 2024.
(60) Provisional application No. 63/607,246, filed on Dec. 7, 2023.
(60) Provisional application No. 63/666,990, filed on Jul. 2, 2024.
(60) Provisional application No. 63/702,793, filed on Oct. 3, 2024.

(51) Int. Cl. E05C 17/16; E05C 17/30; E05C 17/58

(52) U.S. Cl. CPC E05C 17/163; E05C 17/166; E05C 17/30; E05C 17/58

(57) ABSTRACT

Security doorstop assemblies configured for securing a door closed or partially closed. The doorstop assemblies include a detent (e.g., arm) assembly attachable to a wall proximate a header of a doorframe associated with the door. The detent assembly includes means for allowing movement of the detent assembly between an inactive position, in which the detent assembly is proximate the wall and out of the contact with the door, and an active position, in which the detent assembly is remote from the wall and oriented to arrest the movement of the door as it is being swung open. Methods for securing a door using the doorstop assemblies are also disclosed.

### CROSS-REFERENCE TO RELATED APPLICATIONS

This application is a continuation-in-part of International Patent Application No. PCT/US2024/058833 filed Dec. 6, 2024, which claims priority to (1) U.S. Provisional Patent Application Ser. No. 63/607,246 filed Dec. 7, 2023; (2) U.S. Provisional Patent Application Ser. No. 63/666,990 filed Jul. 2, 2024; and (3) U.S. Provisional Patent Application Ser. No. 63/702,793 filed Oct. 3, 2024, and incorporates by reference herein the entire disclosure of each of the aforesaid applications.

### FIELD OF THE INVENTION

This application and the inventions disclosed herein relate to systems for barricading a door, such as is useful in preventing forced entry into a dwelling or business.

### BACKGROUND OF THE INVENTION

Schools and other facilities are constantly attempting to prevent an intruder from entering classrooms, offices, and the like. In intruder situations, many places go into a lockdown situation where people remain in place. The responders often take many minutes before they can reach the situation if no security is readily present and, as such, keeping the occupants of a room safe from entry by a potential intruder is critically important while waiting for responders. An effective door barricade is needed to allow time for the responders to arrive and protect the room occupants.

The devices attempting to deal with the aforementioned security situations have used various approaches. There are devices that attach to the doorjamb (e.g., U.S. Patent Publication 2018/0128025), but the door can still easily by kicked in, thereby breaking the doorjamb. There are a number of other devices that attach between the inside face of the door and the floor (see U.S. Pat. No. 5,590,918), but they all have a removable pin, key or the like, which can be lost or stolen, rendering the device useless in an emergency.

Various physical security measures can be used with doors at a dwelling or business that are designed to discourage forced entry into the premises. Conventionally, there is known a door stopper for locking a door in an open state. Such a door stopper is generally constituted by a hook member arranged on the door, and a mating part that is arranged to be protruding from the floor surface or the wall surface and that can engage and thereby lock the hook (see U.S. Patent Publication No. 2021/0388652).

However, the foregoing solutions all face a myriad of problems. For instance, protrusions from a floor could lead to trip hazards, while latching mechanisms typically require manual deployment, are bulky and/or require modification of the door itself.

Therefore, it is an object of the present invention to provide solutions for securing a door that can be easily actuated, do not require modifications of the door itself and are concealable so as not to stand out visually.

### SUMMARY OF THE INVENTION

The present invention involves a security doorstop that is convenient to deploy and easily actuated. The doorstop is detached from the door itself, minimizing the number of modifications needed to make use of the present invention. Moreover, there are times when a user of a door will want to partially open a door (e.g., to receive a package), but wants to remain safe from forced entry. The present invention therefore provides a means to allow for the door to be opened partially while blocking the door from opening beyond a certain point.

In a first embodiment of the present invention, a deployable arm element, which includes a pair of connected segments, is adapted to be situated on a wall or doorframe adjacent to a hinged (i.e., pivotable) door such that the arm interfaces with the door when the arm is deployed from its inactive (i.e., stowed) position to its active position. When the arm is deployed, the first arm segment extends from the adjacent wall and is coupled to same. The second arm segment meets the first arm segment at a joint and is bent at an angle relative to the first arm segment, thereby allowing the second arm segment to come into contact with the door at a pre-determined location when the arm is deployed. As will be described hereinbelow, multiple deployable arm elements can be available on the same door. When deployed, the arm element prevents the door from opening beyond a certain point, which can, in some embodiments, be varied by adjusting the arm element (e.g., adjusting the length of the arm). When not in use, the one or more deployable arm elements can be folded or otherwise compacted to avoid contact with the door altogether, allowing the door to open completely without interference from the arm element(s).

In other embodiments, the doorstop arm element can be integrated within the frame of the door. Specifically, a specialized doorframe element (e.g., a header) can be implemented around the door, which frame is attached to the door stop element (e.g., an arm element). For instance, the arm element can be contiguous with the doorframe when the doorstop is not in use, but is deployable to an active position when actuated. In such embodiments, the deployable arm element can extend and retract from the frame. Furthermore, the arm element can be adapted for concealment in the frame when not in use, such that it is effectively camouflaged in the frame. The doorframe can also include a stop that prevents the arm element from pivoting, for instance, past a certain extended or rest position (e.g., ninety degrees from its initial retracted position).

In some embodiments, a second pivoting arm element can be integrated with the doorframe, including the sides and/or the top of the door. This second pivoting arm element can be used in combination with the first pivoting arm element to provide a second point of contact and further reinforce the door against forced opening. Alternatively, the arm elements could be used independently. In some embodiments, the arm elements are the same length. This might be useful, if, for instance, the different positions of the arms would permit the door to open different distances. Specifically, this could be implemented by having the second arm element closer to the hinged side of the door, thereby allowing for greater opening of the door before the stop position is reached. In such an embodiment, a user or an automated system can modify the stop position of the door in a selective and customized fashion. This concept can be replicated for embodiments in which the doorstop arms are positioned to the sides of the door and/or doorframe. Similarly, positioning one doorstop arm to a side of the door and another doorstop along the top of the door can also be used in combination to provide two points of contact and further reinforce the door against forced opening.

In some embodiments, a pressure switch can be provided that would trigger an alarm when actuated by an attempt at forced entry through the arrested door. To accommodate such a switch, a slotted pocket or other docking receptacle can be provided on the doorframe such that the switch and, hence, the alarm would not be triggered when the door is in a closed position.

In other embodiments, a piston arrangement can be used in combination with a slidable doorstop member. When in use, the doorstop member slides along an angled track to achieve a position in which the door is arrested and the opening created thereby is obstructed. Just as easily, the doorstop member can be slid back into its original position along the angled track allowing the door to be opened fully.

In further embodiments, a doorstop element integrated in the doorframe can be adapted to pop-out or be pulled out of the doorframe. It can then be rotated (e.g., by ninety degrees) into an active position in which the door is arrested and therefore obstructed from opening fully. To return it to its inactive state, the doorstop element can be rotated and then pushed back into its original inactive position in which it is contiguous with the doorframe, thereby allowing the door to be opened fully.

In another embodiment of the present invention, the doorstop can be adapted to reciprocate into and out of a cavity in the floor near the door. In such an embodiment, the doorstop is adapted to protrude from the floor to provide a physical barrier to the opening of the door, again allowing only a partial opening of the door when the floor-mounted doorstop is deployed. This floor-mounted doorstop can be actuated manually, or automatically (e.g., through a mobile phone application). In certain embodiments, the top of the floor-mounted doorstop can be stylized to match the adjacent flooring. For instance, in a wooden floor, the top of the doorstop could resemble a knot in the nearby wooden flooring. In such an embodiment, when retracted into the floor, the doorstop would blend in with its surroundings by imitating a knot in the flooring. In embodiments with multiple floor-mounted doorstops, they could be placed such that the door contacts all of them simultaneously upon their actuation, whereby multiple points of contact would be provided. Alternatively, such floor-mounted doorstops could be placed for individual operation by arresting the door in different positions depending on which doorstops are activated (i.e., extended upwardly from their retracted positions).

As an added safety measure, a pressure switch can be disposed on the doorstop. When sufficient force is exerted on a door which has been arrested by such a floor-mounted doorstop, a local alarm can be sounded for the potential intruder to hear, or a remote security system can be notified of the potential intruder.

In other embodiments of the present invention, the doorstop assembly includes an elongated arm member, an actuator subassembly including an electromechanical solenoid and a piston subassembly. The actuator subassembly is positioned on a first end of the arm member, and the piston subassembly is positioned on a second end of the arm member. The actuator subassembly and piston subassembly function together to rotate the arm member, and thereby the doorstop assembly, from a stowed position to an operational position, whereby the doorstop assembly is deployed to arrest movement of the door after it has been partially opened a desired distance. A piston of the piston subassembly also is configured to engage the door and thereby enables the doorstop assembly to function as a deadbolt lock to increase security.

In some embodiments of the present invention, the doorstop assembly includes a base and stopper arm assembly that is at least partially contained in the base. In one such embodiment, the stopper arm assembly includes a rod that pivots to move the doorstop assembly between a stowed position and an operational position in which a portion of the stopper arm is capable of arresting the movement of a door that is being opened. The degree to which the door is allowed to open can be varied by adjusting the length of the rod, which adjustment can be achieved without requiring disassembly of the doorstop assembly.

In other embodiments of the present invention, the doorstop assembly includes a base and stopper arm assembly that is at least partially contained in the base. In one such embodiment, the stopper arm assembly includes a rod that rotates to move the doorstop assembly between a stowed position and an operational position in which a portion of the stopper arm is brought into contact with the door. In another such embodiment, the stopper arm includes a linear actuator that rotates to move the doorstop assembly between a stowed position and an operational position in which a portion of the stopper arm is brought into contact with the door. The linear actuator also enables the doorstop assembly to close the door and function as a deadbolt lock to increase security.

In other embodiments of the present invention, the doorstop assembly is configured for a swingable entranceway door having an upper edge bordered by a header of a doorframe. The doorstop assembly comprises a detent assembly attachable to a wall at a location proximate the header of the doorframe. The detent assembly includes means for allowing movement of the detent assembly between an inactive position, in which the detent assembly is located proximate the wall and out of contact with the door, whether it is closed or being swung open, and an active position, in which the detent assembly is remote from the wall and oriented to arrest the movement of the door as it is being swung open, thereby preventing the door from being fully opened.

In an embodiment of the doorstop assembly, the movement allowing means is automatically actuatable. In some embodiments, the movement allowing means is remotely actuatable.

In some embodiments of the doorstop assembly, the detent assembly is pivotable between the inactive position and the active position.

In some embodiments of the doorstop assembly, the detent assembly directly or indirectly contacts the door to arrest its movement. In some embodiments, the detent assembly includes a member configured to physically contact the door to arrest its movement.

In some embodiments of the doorstop assembly, the detent assembly is an arm assembly. In the description of such embodiments, the terms “detent assembly” and “arm assembly” are used interchangeably.

In some embodiments of the present invention, the doorstop assembly further comprises a base configured to be secured to the wall at a location above and proximate the header of the doorframe, wherein the arm assembly is pivotably attached to the base.

In some embodiments of the doorstop assembly, the arm assembly is configured to pivot vertically from its inactive position to its active position.

In some embodiments of the doorstop assembly, at least a portion of the arm assembly has an adjustable length such that a distance between the wall and an end of the arm assembly farthest from the wall is variable.

In some embodiments of the present invention, the doorstop assembly further comprises a housing configured to contain at least a portion of the arm assembly when the arm assembly is in its inactive position, wherein the base forms part of the housing. In some embodiments, at least a portion of the arm assembly is stored substantially within the base when the arm assembly is in its inactive position, and at least a portion of the arm assembly is deployed substantially outside of the base when the arm assembly is in its active position.

In some embodiments of the doorstop assembly, the base has an open face and a removable cover configured to be secured to the open face. The cover defines a slot therein that is configured to allow passage of the arm assembly from the base through the cover.

In some embodiments of the doorstop assembly, the arm assembly includes a pivotable rod having an adjustable length. In some embodiments, the pivotable rod is pivotably connected to the movement allowing means.

In some embodiments of the doorstop assembly, the pivotable rod is configured to adjust a length of said pivotable rod without having to disassemble said doorstop assembly. The pivotable rod includes a first rod portion with opposed first and second ends; a second rod portion with opposed first and second ends; and a threaded bolt that extends between and connects the first and second rod portions. In some embodiments, the doorstop assembly further comprises a nut threadably engaging the threaded bolt, wherein the threaded bolt and nut are configured to cooperate to enable adjustment of the length of the pivotable rod to accommodate doors of different dimensions and/or adjust the distance an associated door may be opened when the arm assembly is in its active position. In some embodiments, the first end of the second rod portion includes an opening that is configured to threadably and rotatably receive a proximal end of the threaded bolt such that the distance the threaded bolt extends from the second rod portion can be varied to adjust the length of the pivotable rod. In some embodiments, a distal end of the threaded bolt is fixedly secured within the second end of the first rod portion such that the threaded bolt does not rotate relative to the first rod portion, whereby the first rod portion is configured to conjointly rotate the threaded bolt and thereby adjust the length of the pivotable rod. In some embodiments, the threaded bolt is moveable between a fixed position in relation to the second rod portion, in which the nut is in contact with the first end of the second rod portion, and an adjustable position in which the threaded bolt is free to rotate relative to the second rod portion, in which the nut is rotated to not be in contact with the first end of the second rod portion.

In some embodiments of the doorstop assembly, the pivotable rod includes a first end and the arm assembly further includes a hollow leg being configured to receive at least the first end of the pivotable rod therein. In some embodiments, the doorstop assembly further comprises connection means for releasably securing the first end of the pivotable rod within the hollow leg. In some embodiments, the connection means includes a bolt, an aperture formed in the pivotable rod, and an aligned aperture formed in the hollow leg, where the aperture and aligned aperture are configured to receive the bolt therethrough. In some embodiments, an internal threading mechanism is provided within the pivotable rod and is configured to enable adjustment of the length of the pivotable rod to accommodate doors of different dimensions and/or adjust the distance which the door may be opened when the arm assembly is in its active position.

In some embodiments of the doorstop assembly, the arm assembly includes a rotating linear actuator having an inner member and an outer member telescopically engaging the inner member and having opposed first and second ends. The first end of the outer member is pivotably connected to the movement allowing means. In some embodiments, the arm assembly further includes a first leg extending from the first end of the outer member of the linear actuator, and at least part of the first leg is configured to contact the door.

In some embodiments of the doorstop assembly, the arm assembly is configured to pivot horizontally from its inactive position to its active position. In some embodiments, the arm assembly includes an arm member having opposed first and second ends, and the movement allowing means includes one component of a hinge positioned on the first arm end, another cooperating component of a hinge positioned on the base member, and a pin. Both hinge components interdigitate to define a cylindrical space configured to receive the pin therethrough. In some embodiments, the doorstop assembly further comprises an actuator subassembly positioned proximate the first arm end and configured to cause the arm assembly to rotate away from the wall between its active position and its inactive position. In some embodiments, the doorstop assembly further comprises a piston subassembly positioned proximate the second arm end and includes a housing and a piston that extends from within the housing; and a door dock having a first portion configured to be secured to the door and a second portion configured to receive a portion of the piston therethrough when the arm assembly is in its inactive position.

In some embodiments of the present invention, the doorstop assembly further comprises means for attaching the base to the wall, wherein the attachment means includes a reinforcement member.

In some embodiments of the doorstop assembly, the door-contacting member includes a protective pad.

In some embodiments of the present invention, the doorstop assembly further comprises a pressure switch and an alarm operably connected to the pressure switch.

In another embodiment of the present invention, a method for securing a swingable entranceway door having an upper edge bordered by a header of a doorframe in a partially open position is provided. The method includes a step of providing a doorstop assembly comprising a detent assembly attachable to a wall at a location proximate the header of the doorframe. The detent assembly includes means for allowing movement of the detent assembly between an inactive position, in which the detent assembly is located proximate the wall and out of contact with the door, whether it is closed or being swung open, and an active position, in which the detent assembly is remote from the wall and oriented to arrest the movement of the door as it is being swung open, thereby preventing the door from being fully opened. The method further includes a step of mounting the doorstop assembly on the wall at a location adjacent the door.

In still another embodiment of the present invention, a doorstop assembly is provided for a swingable entranceway door having an upper edge bordered by a header of a doorframe mounted in a wall. The doorstop assembly includes a housing, stopper arm assembly and a gear train bracket assembly configured to operatively connect the stopper arm assembly to the housing and facilitate the movement of the stopper arm assembly. The housing is configured to be secured to the wall, adjacent the header of the doorframe, and includes a base having a wall plate, sidewalls extending from the wall plate and an open face opposite the wall plate, and a removable cover configured to be secured to the open face of the base. The stopper arm assembly is pivotably attached to the base and includes an L-shaped arm member having a first section that extends along and generally parallel to the housing and a second section that extends generally perpendicular to the first section in a direction away from the housing. The first section has a first end that is continuous with the second section and a second end opposite the first end, and the second section has a third end that is continuous with the first end of the first section, and a fourth end that is distal to the first section and constitutes a free end. The stopper arm assembly further includes a rotatable shaft having a first end and a second end configured to interconnect with the second end of the first section of the L-shaped arm member, the shaft having a D-shaped cross-section that extends from the first end to a point between the first and second ends. The gear train bracket assembly is configured to operatively connect the shaft and arm member to the housing and facilitate the movement of the stopper arm assembly, and thereby the doorstop assembly, between different positions during deployment thereof (i.e., between an inactive (i.e., stowed) position, in which the L-shaped arm member is located proximate the wall and out of contact with the door, whether it is closed or being swung open, and an active (i.e., passthrough or deadbolt) position, in which at least a portion of the L-shaped arm member is remote from the wall and oriented to arrest the movement of the door as it is being swung open, thereby preventing the door from being fully opened). The gear train bracket assembly includes a motor/gear subassembly configured to be mounted on the shaft and having a first gear worm wheel with a D-shaped opening therethrough and a second gear worm wheel with a D-shaped opening therethrough, the D-shaped openings being sized and shaped to receive the D-shaped cross-section of the shaft therein and thereby secure the cross-section of the shaft therein to immobilize the shaft within the motor/gear subassembly and thereby ensure that the shaft rotates with the first and second gear worm wheels during operation. The motor/gear subassembly includes a gear train bracket configured to house the first and second gear worm wheels, first and second worm shafts operatively engaging the first and second gear worm wheels, respectively, and first and second gear drive motors configured and arranged to rotate the first and second worm shafts. Rotation of the first and second worm shafts causes the first and second gear worm wheels to rotate and thereby rotate the shaft.

### BRIEF DESCRIPTION OF THE DRAWINGS

For a more complete understanding of the present invention, reference is made to the following detailed description of various representative embodiments considered in conjunction with the accompanying drawings, in which:

FIG. 1 is a partial top perspective view of a door shown in combination with a pair of concealed and deployable (i.e., pivotable) doorstop assemblies integrated with a doorframe member (i.e., header), the doorstop assemblies being shown in their stowed positions;

FIG. 2 is a top perspective view of the door of FIG. 1 with one of the doorstop assemblies shown in a deployed (i.e., operational) position, in which the door's movement has been arrested;

FIG. 3 is a top perspective view of the door of FIG. 1 with the other doorstop assembly in a deployed (i.e., operational) position, in which the door's movement has been arrested;

FIG. 4 is a top perspective view of another door with concealed doorstop assemblies in the flooring beneath the door, the doorstop assemblies being shown in their retracted (i.e. stowed) positions;

FIG. 5 is a top perspective view the door of FIG. 4 with a pair of floor-mounted doorstop assemblies in their extended (i.e., operational) positions, in which the door's movement has been arrested;

FIG. 6 is a top perspective view of a door shown in combination with a pair of concealed and deployable (i.e., slidable) doorstop assemblies integrated with side and top doorframe members, the doorstop assemblies being shown in their retracted (i.e., stowed) positions;

FIG. 7 is a top perspective view of the door of FIG. 6 with one of the doorstop assemblies having been slid into its deployed (i.e., operational) position, in which the door's movement has been arrested;

FIG. 8 is a top perspective view of the door of FIG. 6 with the other of the doorstop assemblies having been slid into its deployed (i.e., operational) position, in which the door's movement has been arrested;

FIG. 9 is a side elevational view, shown in partial cross section, of the deployed doorstop assembly depicted in FIG. 7;

FIG. 10 is a side elevational view, shown in partial cross section, of the deployed doorstop assembly depicted in FIG. 8;

FIG. 11 is a partial top perspective view of a door and associated frame shown in combination with a doorstop assembly that is a modified version of the doorstop assemblies of FIGS. 6-10, the modified doorstop assembly of FIG. 11 being depicted, via solid lines, in its retracted (i.e. stowed) position and, via broken lines, in its extended, but not operational, position;

FIG. 12 is a partial top perspective view of the door of FIG. 11 with the doorstop assembly having been rotated from its non-operational position (depicted via broken lines) to its operational position (depicted via solid lines), in which the door's movement has been arrested;

FIG. 13 is a side elevational view, shown in partial cross section, of the doorstop assembly depicted in its operational position in FIG. 12;

FIG. 14 is a front elevational view of a doorstop assembly according to an embodiment of the invention;

FIG. 15 is a top plan view of the doorstop assembly of FIG. 14;

FIG. 16 is a side perspective view of an inward-opening door shown in combination with the doorstop assembly of FIG. 14, the doorstop assembly being shown in a retracted (i.e., stowed) position;

FIG. 17 is a side perspective view of the door and doorstop assembly of FIG. 16 with the doorstop assembly shown in an extended (i.e., semi-operational) position;

FIG. 18 is a side perspective view of the door and doorstop assembly of FIG. 16 with the doorstop assembly shown in a deployed (i.e., operational) position, in which the door's movement has been arrested;

FIG. 19 is a side elevational view of the door and doorstop assembly of FIG. 16, with the doorstop assembly depicted in its stowed position;

FIG. 20 is a top perspective view of an outward-opening door shown in combination with a doorstop assembly according to an embodiment of the invention, the doorstop assembly being shown in a retracted (i.e., stowed) position;

FIG. 21 is a top perspective view of the door and doorstop assembly of FIG. 20 with the doorstop assembly shown in a deployed (i.e., operational) position, in which the door's movement has been arrested;

FIG. 22 is a side elevational view of the door and doorstop assembly of FIG. 20, with the doorstop assembly depicted in its operational position;

FIG. 23 is a top perspective view of an outward-opening door shown in combination with a doorstop assembly according to an embodiment of the invention, the doorstop assembly being shown in a retracted (i.e., stowed) position;

FIG. 24 is a top perspective view of a doorstop assembly according to an embodiment of the invention;

FIG. 25 is a side elevational view of the doorstop assembly of FIG. 24, with the doorstop assembly depicted in a retracted (i.e., stowed) position;

FIG. 26 is a side elevational view of the doorstop assembly of FIG. 24, with the doorstop assembly depicted in a deployed (i.e., operational) position;

FIG. 27 is a top perspective view of the doorstop assembly of FIG. 24, with the doorstop assembly depicted in its operational position;

FIG. 28 is a top perspective cross-sectional view of the doorstop assembly of FIG. 24 with a rod thereof in a first position, the section being taken along the line A-A in FIG. 24;

FIG. 29 is a top perspective cross-sectional view of the doorstop assembly of FIG. 24 with a rod thereof in a second position, the section being taken along the line A-A in FIG. 24;

FIG. 30 is a top plan view of the doorstop assembly of FIG. 24, with a cover of a housing thereof removed to show interior elements;

FIG. 31 is a side perspective view of an inward-opening door shown in combination with the doorstop assembly of FIG. 24, the doorstop assembly being shown in its retracted (i.e., stowed) position;

FIG. 32 is a side elevational view of the door and doorstop assembly of FIG. 31, with the doorstop assembly depicted in its stowed position;

FIG. 33 is a top perspective view of the door and doorstop assembly of FIG. 31 with the doorstop assembly shown in its operational position in which the door's movement has been arrested;

FIG. 34 is a side elevational view of the door and doorstop assembly of FIG. 31, with the doorstop assembly depicted in its operational position;

FIG. 35 is a top left perspective view of a doorstop assembly according to an embodiment of the invention;

FIG. 36 is a top right perspective view of the doorstop assembly of FIG. 35;

FIG. 37 is a side elevational view of the doorstop assembly of FIG. 35, with the doorstop assembly depicted in a retracted (i.e., stowed) position;

FIG. 38 is a side elevational view of the doorstop assembly of FIG. 35, with the doorstop assembly depicted in a deployed (i.e., operational) position;

FIG. 39 is a top perspective view of the doorstop assembly of FIG. 35, with the doorstop assembly depicted in its operational position;

FIG. 40 is a top plan view of the doorstop assembly of FIG. 35, with a cover of a housing thereof removed to show interior elements;

FIG. 41 is a top perspective view of the doorstop assembly of FIG. 35, with a cover of a housing thereof removed to show interior elements;

FIG. 42 is a perspective view of an inward-opening door shown in combination with the doorstop assembly of FIG. 35, the doorstop assembly being shown in its stowed position;

FIG. 43 is a side perspective view of the door and doorstop assembly of FIG. 42, the doorstop assembly being shown in its stowed position;

FIG. 44 is a top perspective view of the door and doorstop assembly of FIG. 42, the doorstop assembly being shown in its operational position;

FIG. 45 is a side perspective view of the door and doorstop assembly of FIG. 42, the doorstop assembly being shown in its operational position;

FIG. 46 is a side elevational view of the door and doorstop assembly of FIG. 42, with the doorstop assembly depicted in its operational position;

FIG. 47 is a side perspective view of the door and doorstop assembly of FIG. 42, the doorstop assembly being shown in a locked position locking the door;

FIG. 48 is a top perspective view of a doorstop assembly according to an embodiment of the invention, with the doorstop assembly being depicted in its stowed position and intact (i.e., with a cover in place on an associated housing);

FIG. 49 is a top perspective view of the doorstop assembly of FIG. 48, with the doorstop assembly being depicted in its operational position;

FIG. 50 is a top perspective view of the doorstop assembly of FIG. 48, with the cover of the housing being removed to show interior elements of the assembly;

FIG. 51 is a side perspective view of the doorstop assembly of FIG. 50 (i.e., with the cover of the housing being removed to show interior elements of the assembly);

FIG. 52 is a top plan view of the doorstop assembly of FIG. 50, (i.e., with the cover of the housing being removed to show interior elements of the assembly);

FIG. 53 is side perspective view of an inward-opening door shown in combination with the doorstop assembly of FIG. 48, the doorstop assembly being shown in its retracted (i.e., stowed) position;

FIG. 54 is side elevational view of the door and doorstop assembly of FIG. 53, with the doorstop assembly depicted in its stowed position;

FIG. 55 is a top perspective view of the door and doorstop assembly of FIG. 53 with the doorstop assembly shown in its operational position in which the door's movement has been arrested;

FIG. 56 is side elevational view of the door and doorstop assembly of FIG. 53, with the doorstop assembly depicted in its operational position;

FIG. 57 is a top perspective view of a doorstop assembly according to an embodiment of the invention, configured for use with left hand opening doors, with the doorstop assembly being depicted in its stowed position and assembled (i.e., with a cover in place on an associated housing);

FIG. 58 is a top perspective view of the doorstop assembly of FIG. 57, with the doorstop assembly depicted in its operational, or passthrough, position and assembled (i.e., with a cover in place on an associated housing);

FIG. 59 is a top perspective view of the doorstop assembly of FIG. 57, with a cover of a housing thereof removed to show interior elements thereof;

FIG. 60 is a side perspective view of the doorstop assembly of FIG. 57, with the housing cover removed and with the doorstop assembly being depicted in its stowed position;

FIG. 61 is a front elevational view of the doorstop assembly of FIG. 57, with the housing cover removed and with the doorstop assembly being depicted in its stowed position;

FIG. 62 is a front elevational view of the doorstop assembly of FIG. 57, with the housing cover removed and with the doorstop assembly being depicted in its deadbolt position;

FIG. 63A is an exploded view of the doorstop assembly of FIG. 57;

FIG. 63B is an exploded view of the stopper arm assembly and gear train bracket assembly of the doorstop assembly of FIG. 57;

FIG. 64 is a top plan view of the doorstop assembly of FIG. 57, with the housing cover removed and with the doorstop assembly being depicted between its passthrough and deadbolt positions;

FIG. 65 is a top perspective view of a gear train bracket, gear drive motors and related components of the motor/gear assembly of the doorstop assembly of FIG. 57;

FIG. 66 is an exploded view of the components of the motor/gear assembly of FIG. 65;

FIG. 67 is a cross-sectional view of the doorstop assembly of FIG. 57, with the housing cover removed and with the doorstop assembly being depicted in its stowed position, as taken through lines 67-67 in FIG. 59;

FIG. 68 is a top perspective view of the doorstop assembly of FIG. 57 with the doorstop assembly being depicted in its stowed position, showing the printed circuit board assembly of the doorstop assembly in detail;

FIG. 69 is a side perspective view of an inward-opening/left hand opening door shown in combination with the doorstop assembly of FIG. 57, the doorstop assembly being shown in its stowed position;

FIG. 70 is a side elevational view of the door and doorstop assembly of FIG. 69, with the doorstop assembly depicted in its stowed position;

FIG. 71 is a top perspective view of the door and doorstop assembly of FIG. 69 with the doorstop assembly shown in its passthrough (i.e., operational) position in which the door's movement has been arrested;

FIG. 72 is a side elevational view of the door and doorstop assembly of FIG. 69, with the doorstop assembly depicted in its passthrough position;

FIG. 73 is a top perspective view of a doorstop assembly according to an embodiment of the invention, configured for use with right hand opening doors, with the doorstop assembly being depicted in its stowed position and assembled (i.e., with a cover in place on an associated housing);

FIG. 74 is a top perspective view of the doorstop assembly of FIG. 73, with the doorstop assembly depicted in its operational, or passthrough, position and assembled (i.e., with a cover in place on an associated housing);

FIG. 75 is a top perspective view of the doorstop assembly of FIG. 73, with a cover of a housing thereof removed to show interior elements thereof;

FIG. 76 is a side perspective view of the doorstop assembly of FIG. 73, with the housing cover removed and with the doorstop assembly being depicted in its stowed position;

FIG. 77 is a front elevational view of the doorstop assembly of FIG. 73, with the housing cover removed and with the doorstop assembly being depicted in its stowed position;

FIG. 78 is a front elevational view of the doorstop assembly of FIG. 73, with the housing cover removed and with the doorstop assembly being depicted in its deadbolt position;

FIG. 79A is an exploded view of the doorstop assembly of FIG. 73;

FIG. 79B is an exploded view of the stopper arm assembly and gear train bracket assembly of the doorstop assembly of FIG. 73;

FIG. 80 is a top plan view of the doorstop assembly of FIG. 73, with the housing cover removed and with the doorstop assembly being depicted between its passthrough and deadbolt positions;

FIG. 81 is a top perspective view of a gear train bracket, gear drive motors and related components of the motor/gear assembly of the doorstop assembly of FIG. 73;

FIG. 82 is an exploded view of the components of the motor/gear assembly of FIG. 81;

FIG. 83 is a cross-sectional view of the doorstop assembly of FIG. 73, with the housing cover removed and with the doorstop assembly being depicted in its stowed position, as taken through lines 83-83 in FIG. 75;

FIG. 84 is a top perspective view of the doorstop assembly of FIG. 73, with the doorstop assembly being depicted in its stowed position, showing the printed circuit board assembly of the doorstop assembly in detail;

FIG. 85 is a side perspective view of an inward-opening/right hand opening door shown in combination with the doorstop assembly of FIG. 73, the doorstop assembly being shown in its stowed position;

FIG. 86 is a side elevational view of the door and doorstop assembly of FIG. 85, with the doorstop assembly depicted in its stowed position;

FIG. 87 is a top perspective view of the door and doorstop assembly of FIG. 85 with the doorstop assembly shown in its passthrough (i.e., operational) position in which the door's movement has been arrested;

FIG. 88 is a side elevational view of the door and doorstop assembly of FIG. 85, with the doorstop assembly depicted in its passthrough position;

FIG. 89 is a top perspective view of a doorstop assembly according to an embodiment of the invention, configured for use with left hand opening doors,

FIG. 90 is a bottom perspective view of the doorstop assembly of FIG. 89;

FIG. 91 is a front elevational view of the doorstop assembly of FIG. 89;

FIG. 92 is a rear elevational view of the doorstop assembly of FIG. 89;

FIG. 93 is a left side elevational view of the doorstop assembly of FIG. 89;

FIG. 94 is a right elevational view of the doorstop assembly of FIG. 89;

FIG. 95 is a top plan view of the doorstop assembly of FIG. 89;

FIG. 96 is a bottom plan view of the doorstop assembly of FIG. 89;

FIG. 97 is a top perspective view of a doorstop assembly according to an embodiment of the invention, configured for use with right hand opening doors,

FIG. 98 is a bottom perspective view of the doorstop assembly of FIG. 97;

FIG. 99 is a front elevational view of the doorstop assembly of FIG. 97;

FIG. 100 is a rear elevational view of the doorstop assembly of FIG. 97;

FIG. 101 is a left side elevational view of the doorstop assembly of FIG. 97;

FIG. 102 is a right elevational view of the doorstop assembly of FIG. 97;

FIG. 103 is a top plan view of the doorstop assembly of FIG. 97; and

FIG. 104 is a bottom plan view of the doorstop assembly of FIG. 97.

### DETAILED DESCRIPTION OF THE EXEMPLARY EMBODIMENTS

The following disclosure is presented to provide an illustration of the general principles of the present invention and is not meant to limit, in any way, the inventive concepts contained herein. Moreover, the particular embodiments described in this section can be used individually or in combination with some or all of the other described embodiments in each of the multitude of possible permutations and combinations obvious to a person skilled in the art.

All terms defined herein should be afforded their broadest possible interpretation, including any implied meanings as dictated by a reading of the specification, as well as any words that a person having skill in the art and/or a dictionary, treatise, or similar authority would assign thereto. Thus, and by way of example, terms such as “element,” “member” and “segment” are used interchangeably herein, it being understood that any one of these terms can be substituted for another one of the terms when describing the following exemplary embodiments of the present invention.

Further, it should be noted that, as recited herein, the singular forms “a”, “an”, “the”, and “one” include the plural referents, unless otherwise stated. Additionally, the terms “comprises” and “comprising”, when used herein, specify that certain features are present in that embodiment, however, this phrase should not be interpreted to preclude the presence or addition of additional steps, operations, features, components, and/or groups thereof.

All examples and conditional language recited herein are intended for pedagogical purposes to aid the reader in understanding the principles of the invention and the concepts contributed thereby to furthering the relevant art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future.

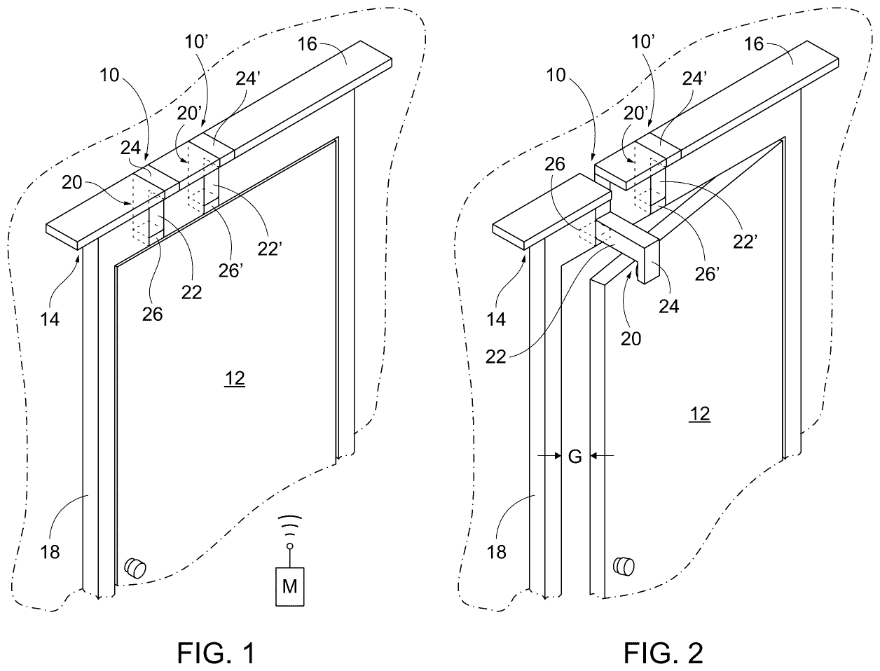

With the foregoing prefatory comments in mind, initial reference is made to FIG. 1, which shows a pair of doorstop assemblies 10, 10′ in combination with a door 12 and associated frame 14, including a header 16 and jamb 18. The doorstop assemblies 10, 10′ employ pivotable arm elements 20, 20′, respectfully, each of which is retracted into and camouflaged within header 16. The arm elements 20, 20′ can be the same length, or different lengths, depending on the specific embodiment of the present invention. Each of the arm elements 20, 20′ includes a long segment (i.e., leg) 22, 22′, respectively, and a short segment (i.e., foot) 24, 24′, respectively. Stops 26, 26′ can be integrated with header 16 and positioned to contact the arm segments 22, 22′, respectively, in order to prevent arm elements 20, 20′ from pivoting past a specific orientation (e.g., ninety degrees from their stowed positions to their operational positions). In one embodiment, the arm elements 20, 20′ have different lengths, which are specifically selected so as to ensure that both arm elements 20, 20′ contact the door 12 simultaneously, thereby creating two points of contact to reinforce the door 12 against forced entry. In the embodiment depicted in FIG. 1, arm elements 20, 20′ have the same length. Given their differing longitudinal positions on the header 16, if both of the arm elements 20, 20′ are deployed (not shown), only the foot segment 24 of arm element 20 would contact door 12, the foot segment 24 thereby functioning as a detent member.

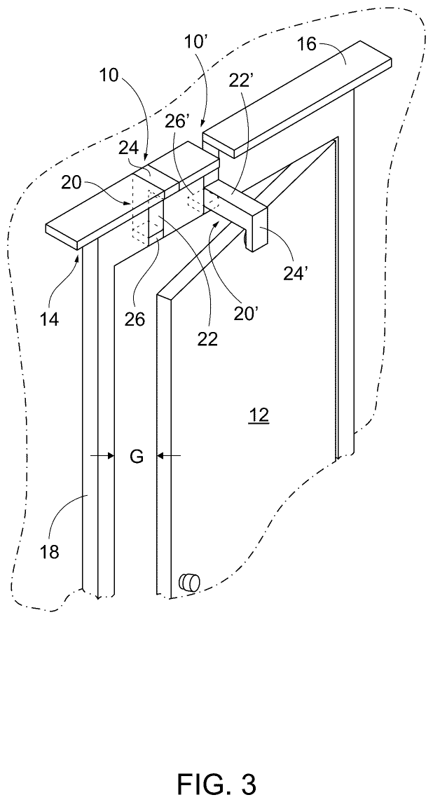

As shown in FIGS. 2 and 3, arm elements 20, 20′ can be used independently of each other. With reference to FIG. 2, only arm element 20 is deployed, thereby arresting movement of door 12 after it has been partially opened to the position illustrated in FIG. 2, creating a gap (G) between the door 12 and jamb 18. As can be seen, arm element 20′ is positioned closer to the hinged edge of door 12, than arm element 20. Hence, when only arm element 20′ is deployed, as in FIG. 3, the door 12 will be allowed to open more than when only arm element 20 is deployed, thereby creating a gap (G′) which is greater than gap (G).

The pivotal movement of the doorstop assemblies 10, 10′ can be accomplished by any suitable electro-mechanical means known in the art. Actuation of any such means can be accomplished by, for instance, a manual, wall-mounted switch or button (not shown). Alternatively, the doorstop assemblies 10,10′ can be actuated remotely via software provided on a mobile phone (M) or similar device.

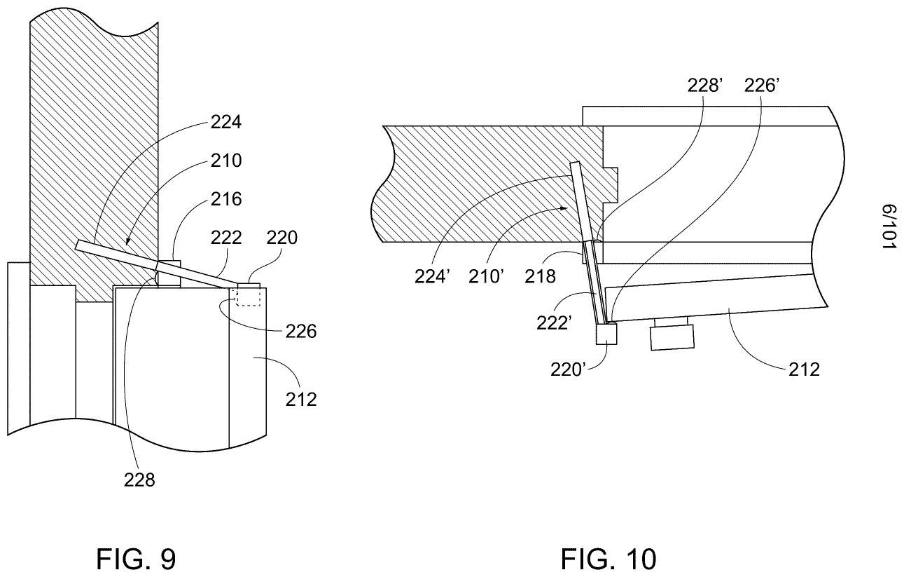

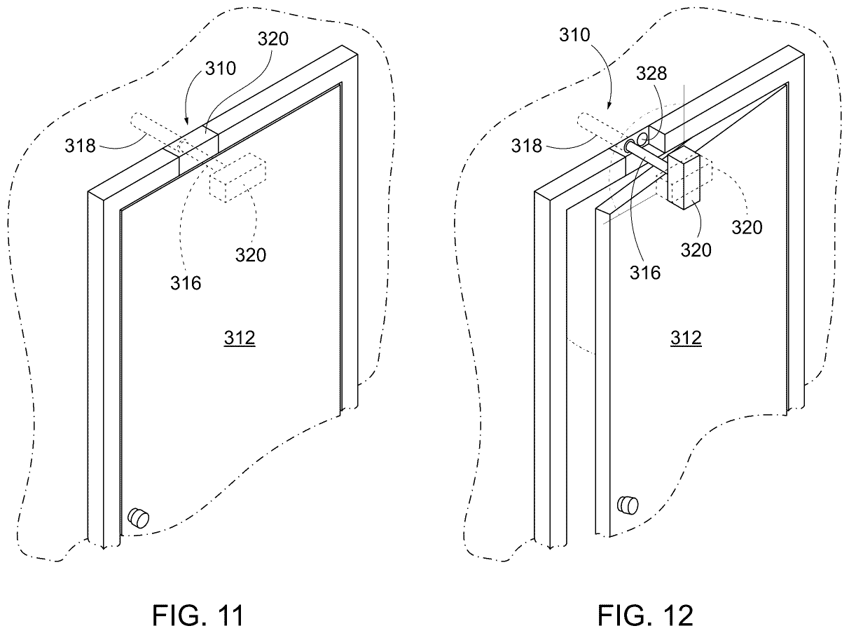

As an additional security feature, each foot segment 24, 24′ can be provided with a pressure switch (not shown) similar in construction and operation to the pressure switches disclosed in some of the following exemplary embodiments of the present invention (see, for instance, the embodiment depicted in FIGS. 9 and 10, as well as the embodiment depicted in FIGS. 11-13). In operation, upon actuation of such a switch, a local alarm could be sounded as a deterrent to the potential intruder and/or a remote signal could be sent to the local police department or other security provider, thereby eliciting their intervention.

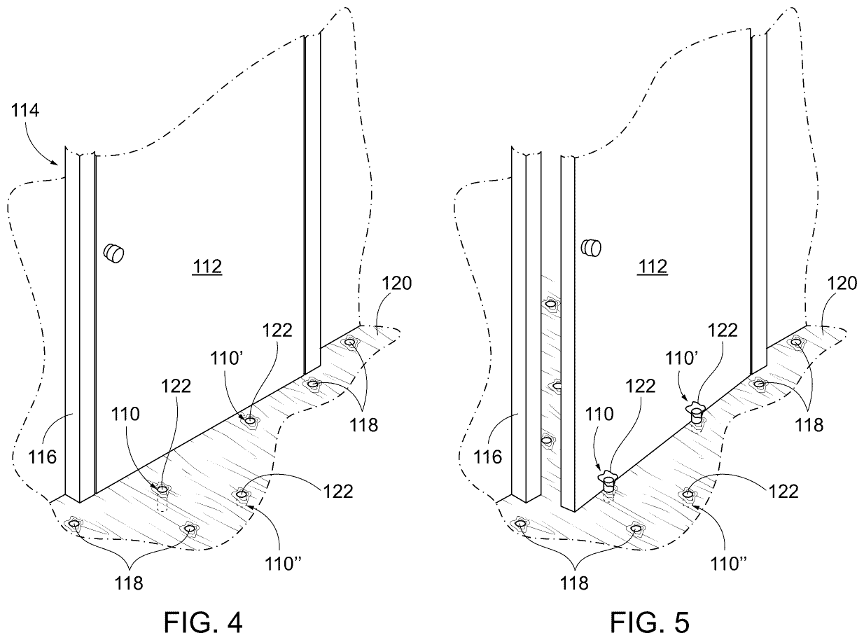

Referring now to FIGS. 4 and 5, floor-mounted doorstop assemblies 110, 110′, 110″ are shown in combination with a door 112 and associated frame 114, including a header (not shown) and jamb 116. In FIG. 4, the doorstop assemblies 110, 110′, 110″, which are piston-like in construction and function, have been retracted, allowing the closed door 112 to open without obstruction. For aesthetic and/or security reasons, doorstop assemblies 110, 110′, 110″ can be stylized to resemble surrounding knots 118 in plank-like flooring 120 situated beneath the door 112, thereby creating the illusion of fake knots 122 when the doorstop assemblies are in their retracted (i.e., stowed) positions shown in FIG. 4.

Turning now to FIG. 5, door 112 is depicted in an arrested position determined by doorstop assemblies 110, 110′, which have been remotely or manually actuated and now extend above the flooring 118 to create two points of contact that arrest the door 112 in a partially open position. Although doorstop assembly 110″ remains in its retracted (i.e., stowed) position in FIG. 5, upon its extension and the retraction of doorstop assemblies 110, 110′, the door 112 would be allowed to open more than what is depicted in FIG. 5.

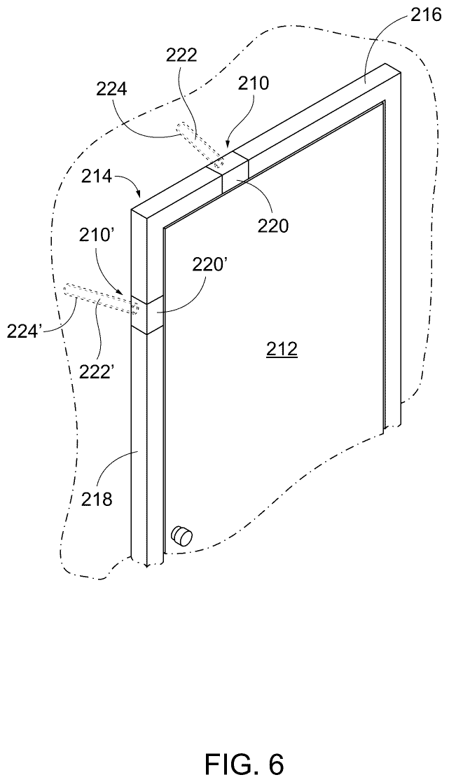

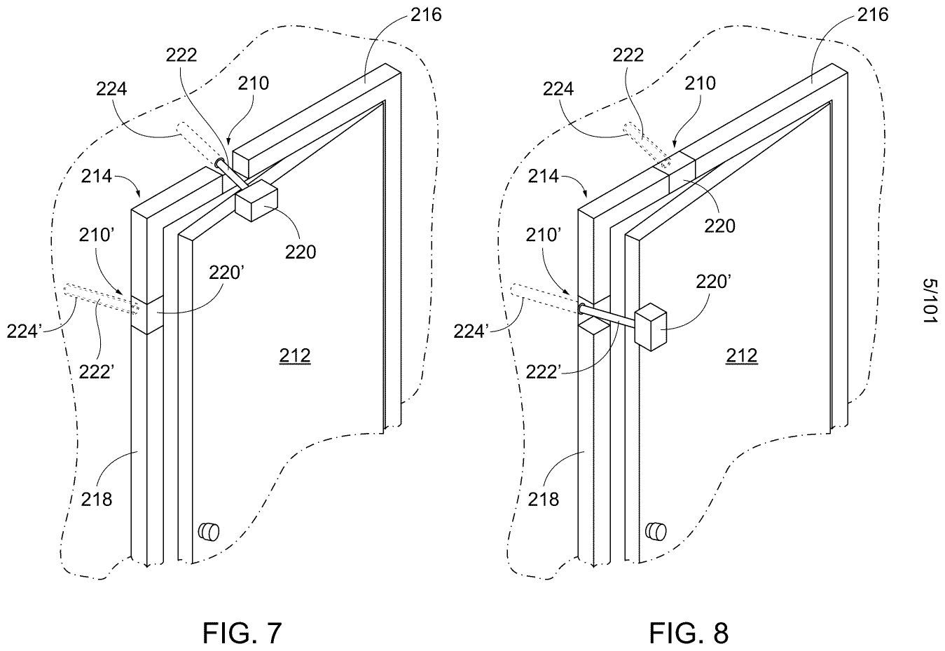

FIGS. 6-8 illustrate a pair of doorstop assemblies 210, 210′ in combination with a door 212 and associated frame 214, including a header 216 and jamb 218. As shown in FIG. 6, the door 212 is closed and the doorstop assemblies 210, 210′ are in their retracted (i.e., stowed) positions within header 216 and jamb 218, respectively, where they are camouflaged or otherwise concealed from view. The doorstop assemblies in 210, 210′ are piston-like in both construction and function. More particularly, the doorstop assembly 210 includes a detent member 220 (shown via solid lines in FIG. 6), as well as a piston 222 and an angled cylinder 224 (shown via broken lines in FIG. 6). Similarly, the doorstop assembly 210′ includes a detent member 220′ (shown via solid lines in FIG. 6), as well as a piston 222′ and an angled cylinder 224′ (shown via broken lines in FIG. 6). The detent members 220, 220′ are attached to pistons 222, 222′, respectively, for reciprocating movement relative thereto. Upon actuation of the doorstop assemblies 210, 210′, the pistons 222, 222′ move the detent members 220, 220′, respectively, from their retracted (i.e., stowed) positions (see FIG. 6) to their extended (i.e., operational) positions (see FIGS. 7 and 8). It should be understood that the angles of the cylinders 224, 224′ can be selected to modify and/or adjust the amount of contact between the door 212 and the detent members 220, 220′, respectively.

FIG. 7 shows the detent member 220 extended to its operational position by piston 222. In such a position, the door 212 is obstructed by the detent member 220, creating a relatively small gap between the door 212 and jamb 218.

FIG. 8 shows the detent member 220′ extended to its operational position by piston 222′. In such a position, the door 212 is obstructed by the detent member 220′, creating a gap which can be smaller or larger than the gap illustrated in FIG. 7 between the door 212 and jamb 218.

FIG. 9 shows detent member 220 of FIG. 7 equipped with a pressure switch 226, which operates to provide security functionality. For instance, if there were an attempt to force door 212 open while the detent member 220 is in its deployed (i.e., extended or operational) position, pressure switch 226 would be depressed as a consequence, triggering (i) a local alarm sound audible to the potential intruder and/or (ii) a remote alarm signal, such as to the local police department or other security provider. When the detent member 220 is in its stowed (i.e., non-operational) position, the pressure switch 226 is nested in a pocket 228 or similar receptacle provided in an adjacent wall (see FIG. 9), thereby preventing inadvertent actuation of the pressure switch 226.

FIG. 10 shows detent member 220′ of FIG. 8 equipped with a pressure switch 226′, which operates to provide security functionality. For instance, if there were an attempt to force door 212 open beyond the amount depicted in FIG. 10, pressure switch 226′ would be depressed as a consequence, triggering (i) a local alarm sound audible to the potential intruder and/or (ii) a remote alarm signal, such as to the local police department or other security provider. When the detent member is in its stowed (i.e., non-operational) position, the pressure switch 226′ is nested in a pocket 228′ or similar receptacle in an adjacent wall (see FIG. 10), thereby preventing inadvertent actuation of the pressure switch 226′.

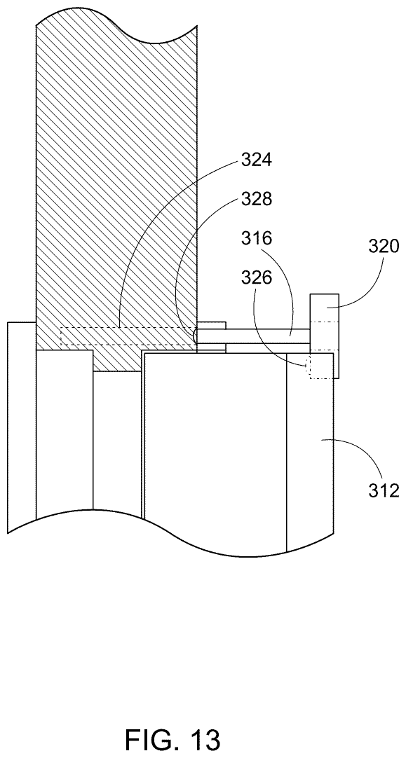

FIGS. 11-13 show a doorstop assembly 310 that is similar, in construction and function, to the doorstop assembly 210 of FIGS. 6-10, except for the following modifications. Whereas the doorstop assembly 210 utilizes a jamb, or cylinder, 218 that is angled relative to the horizontal, the doorstop assembly 310 utilizes a jamb/cylinder 318 that is not angled (i.e., the cylinder 318 is oriented horizontally). Due to the horizontal orientation of the cylinder 318 and hence its associated piston 316, a detent member 320, which reciprocates between a retracted (i.e., stowed) position (shown via solid lines in FIG. 11) and an extended (i.e., semi-operational) position (shown via broken lines in FIGS. 11 and 12) conjointly with the piston 316, must be rotated from its semi-operational position shown via broken lines in FIG. 12 to its fully operational position shown via solid lines in FIG. 12, whereby detent member 320 obstructs door 312 and arrests its movement beyond what is depicted in FIGS. 12 and 13. As best seen in FIG. 13, the detent member 320 includes a pressure switch 326, which operates in the same manner as the pressure switch 226 of the embodiment depicted in FIGS. 6-10 to thereby provide the same security functionality. When the detent member 320 is in its retracted (i.e., stowed) position, the pressure switch 326 is nested in a pocket 328 (see FIGS. 12 and 13) or a similar receptable provided in an adjacent wall, thereby preventing inadvertent actuation of the pressure switch 326.

Needless to say, the embodiment of FIGS. 11-13 can employ multiple doorstop assemblies similar in fashion to the embodiments of FIGS. 1-3 and FIGS. 6-10, thereby creating multiple points of contact or allowing different degrees of opening for door 310. To the latter end, the piston length(s) and/or travel distance could be varied to provide different detent points for the door 310.

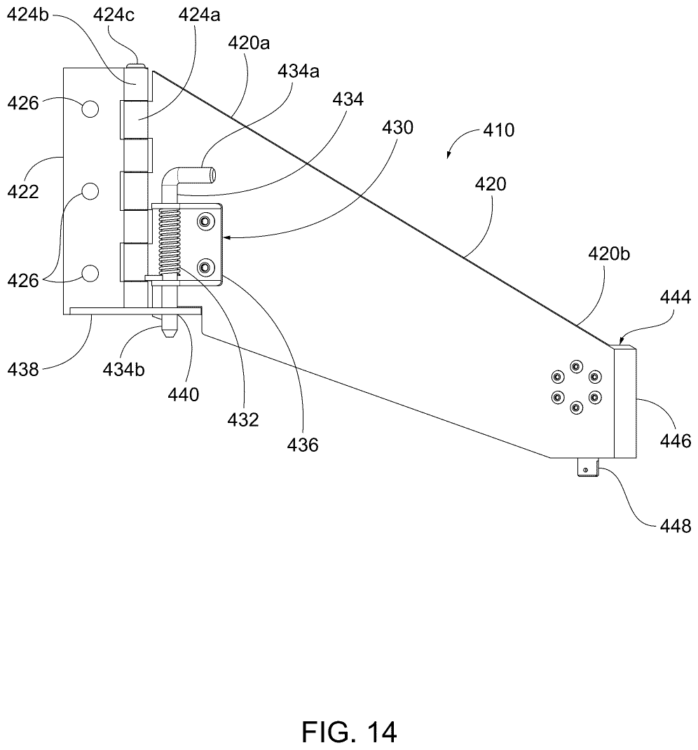

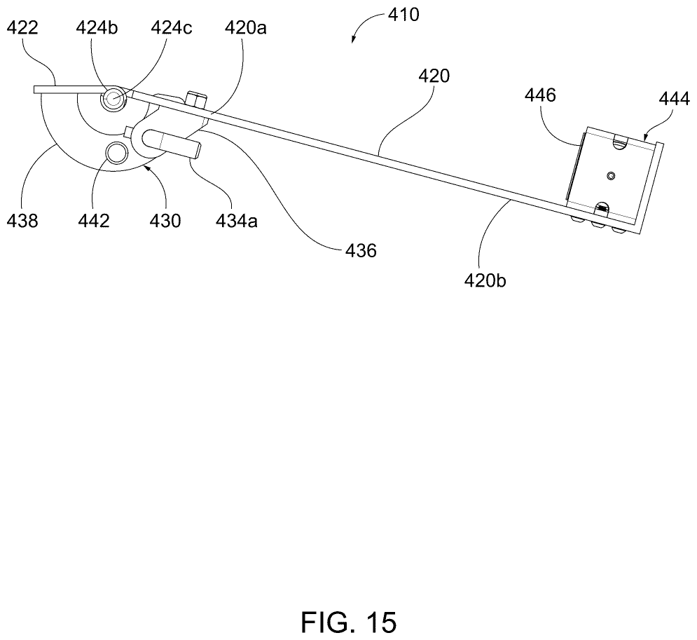

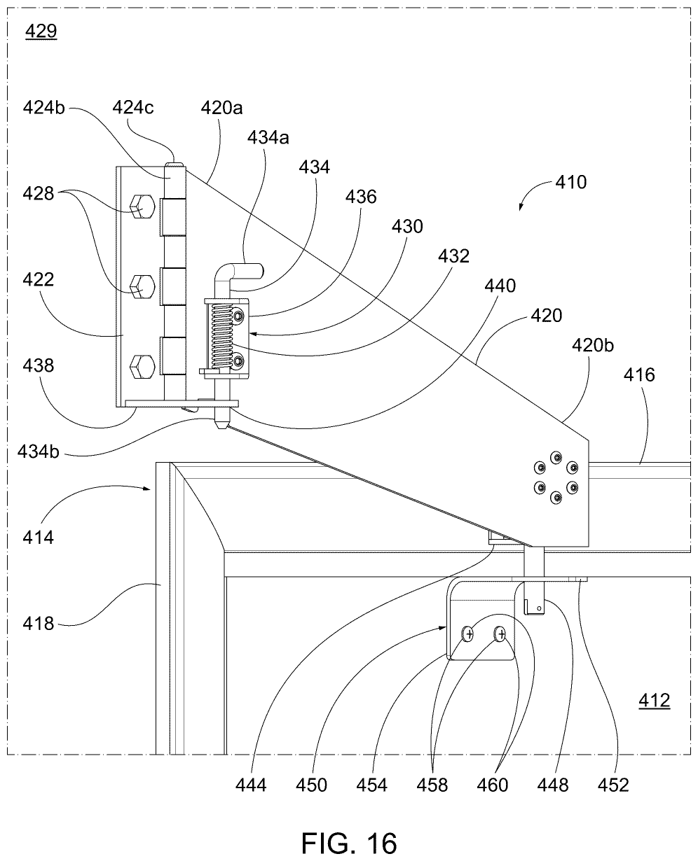

FIGS. 14 and 15 illustrate a doorstop assembly 410 and FIGS. 16-19 illustrate the doorstop assembly 410 in combination with an inward-opening door 412 and associated frame 414, including a header 416 and jamb 418. As shown in FIGS. 14 and 15, the doorstop assembly 410 includes an arm assembly, or elongated arm member, 420 having opposed first and second ends 420a and 420b, and an anchor, base, or base member, 422. The first end 420a of the arm member 420 includes one component of a hinge 424a, and the base member 422 includes the other, cooperating component of a hinge 424b, both components 424a, 424b interdigitating to define a cylindrical space configured to receive a pin 424c therethrough, whereby the arm member 420 is rotatable relative to the base member 422. The base member 422 further defines a plurality of openings 426 for receiving fastening members 428 (see FIGS. 16-19) therethrough to secure the base member 422 (and, thereby, the entire doorstop assembly 410) to a wall 429 at a location above and proximate the header 416 of the doorframe 414. While three openings 426 and three fastening members 428 are illustrated in the embodiment of FIGS. 14-19, it will be understood that other numbers of openings and fastening members (e.g., one, two or four) are also envisioned in alternate embodiments. Further, it will be understood that the fastening members 428 may include bolts, screws, nails, anchors, pins and any combination thereof.

With continued reference to FIGS. 14-19, the doorstop assembly 410 further includes an actuator subassembly 430. The actuator subassembly 430 includes an electromechanical solenoid having an inductive coil 432 and an armature 434 partially housed within the coil 432, wherein the armature 434 has an upper end 434a and a lower end 434b. The actuator subassembly 430 further includes a bracket 436 that is configured to secure the electromechanical solenoid to the first end 420a of the arm member 420, and a substantially semicircular flange 438 extending between the base member 422 and the first end 420a of the arm member 420. The flange 438 includes first and second apertures 440, 442 that are formed therein and configured to receive the lower end 434b of the armature 434. As further discussed below, the first and second apertures 440, 442 receive the lower end 434b of the armature 434 in the stowed position and operational position of the doorstop assembly 410, respectively.

In alternate embodiments, other types of actuator assemblies/mechanisms may be utilized instead of an electromechanical solenoid.

The doorstop assembly 410 further includes a piston subassembly 444 positioned on the second end 420b of the arm member 420. The piston subassembly 444 includes a housing 446 and a piston 448 that extends from within the housing 446 (i.e., downwardly through an opening formed in a bottom surface 446a of the housing 446).

As illustrated in FIGS. 16-19, the doorstop assembly 410 also includes an L-shaped door dock 450 having a horizontal component 452 and a vertical component 454. The horizontal component 452 includes an aperture 456 that is formed therein and configured to receive a portion (i.e., a lower end) of the piston 448 therethrough when the doorstop assembly 410 is in its stowed position, as further discussed below. The vertical component 454 is configured to be secured to the door 412, and defines a plurality of openings 458 for receiving fastening members 460 therethrough to secure the door dock 450 to a top (i.e., upper) portion of the door 412. While two openings 458 and two fastening members 460 are illustrated in the embodiment of FIGS. 16-19, it will be understood that other numbers of openings and fastening members (e.g., one, three or four) are also envisioned in alternate embodiments. Further, it will be understood that the fastening members 460 may include bolts, screws, nails, anchors, pins and any combination thereof.

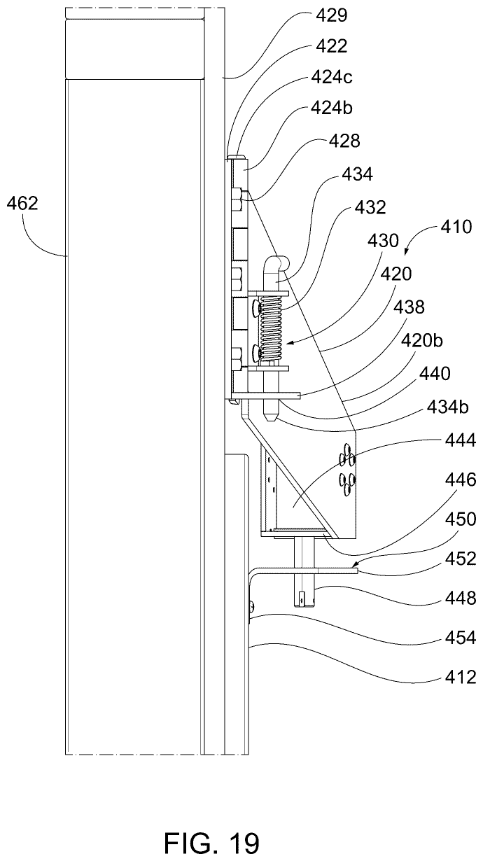

FIG. 19 is a side view of the doorstop assembly 410 as installed and in its stowed position. In the illustrated embodiment, a reinforcement member 462 is provided behind the wall 429 (i.e., on the side of the wall 429 opposite to the side on which the doorstop assembly 410 is installed). The reinforcement member 462 is dimensioned and positioned proximate the wall 429 to receive the base fastening members 428 therein (i.e., after the base fastening members 428 are inserted through the openings 426 in the base 422 and the wall 429 itself) to more securely attach the base 422 (and thereby the entire doorstop assembly 410) to the wall 429. In some embodiments, the reinforcement member 462 is a 2×4 (two by four) or other piece of lumber.

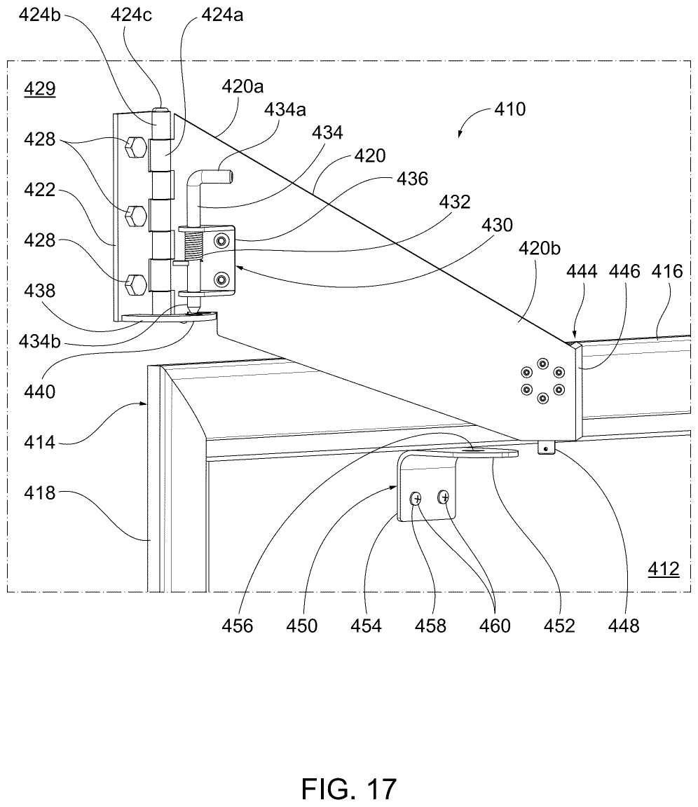

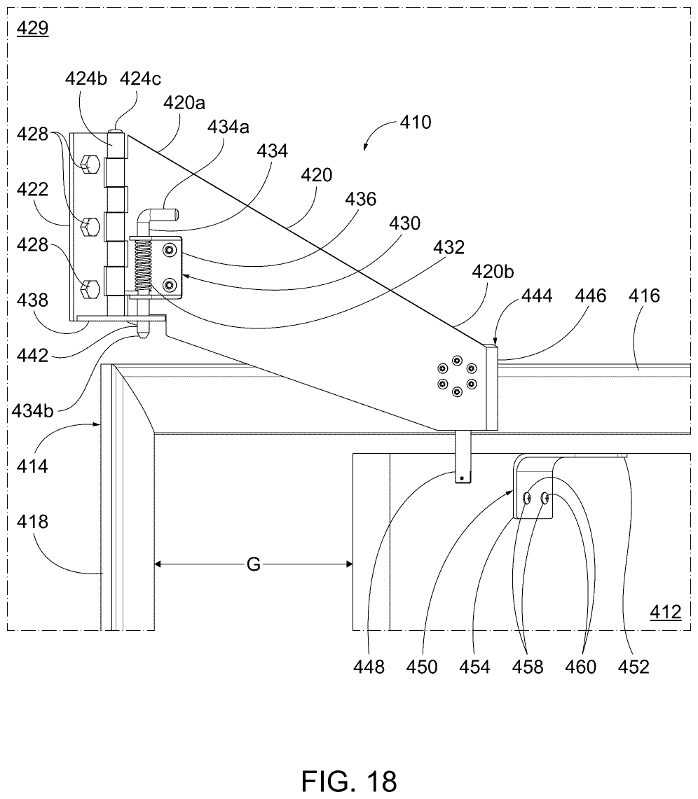

The operation of the doorstop assembly 410 will now be described. As shown in FIG. 16, the doorstop assembly 410 is in its stowed position when the door 412 is closed. The lower end of the piston 448 is inserted through the aperture 456 of the horizontal component 452 of the L-shaped door dock 450, which secures the door 412 in its closed position, thereby enabling the doorstop assembly 410 to function as a deadbolt lock. When a user wishes to open the door 412, he or she activates the actuator subassembly 430, which causes the elongated arm member 420 to rotate away from the wall 429 and move from its stowed position to an extended (i.e., semi-operational) position (as shown in FIG. 17) and ultimately to its operational position (as shown in FIG. 18). More particularly, activation of the actuator subassembly 430 causes the armature 434 of the electromechanical solenoid to move in an upward direction relative to and within the inductive coil 432, whereby the lower end 434b of the armature 434 is lifted out of the first aperture 440 in the flange 438 (where the lower end 434b is located when the doorstop assembly 410 is in its stowed position) and the armature 434 is free to rotate. At or about the same time, the piston 448 is retracted into the housing 446 of the piston subassembly 444, whereby the lower end of the piston 448 moves upwardly and out of the aperture 456. These movements cause the elongated arm member 420 to disengage from the L-shaped door dock 450 and freely rotate away from the wall 429, as shown in FIG. 17. As the elongated arm member 420 rotates away from the wall 429, the armature 434 travels along the curve of the flange 438 until the armature's lower end 434b aligns with, and insertably engages, the second aperture 442 in the flange 438 (as shown in FIG. 18). The engagement of the lower end 434b with the second aperture 442 restricts further movement of the elongated arm member 420. At this point, the piston 448 is ejected from the housing 446 of the piston subassembly 444, moving the lower end of the piston 448 downwardly such that it contacts an inner (i.e., inward-facing) surface of the top (i.e., upper) portion of the door 412 and thereby arrests movement of the door 412 after it has been partially opened to the position illustrated in FIG. 18, creating a gap (G) between the door 412 and jamb 418. When the user wishes to close the door 412, the foregoing steps are performed in reverse order, to move doorstop assembly 410 from its operational position (as shown in FIG. 18) to its stowed position (as shown in FIG. 16).

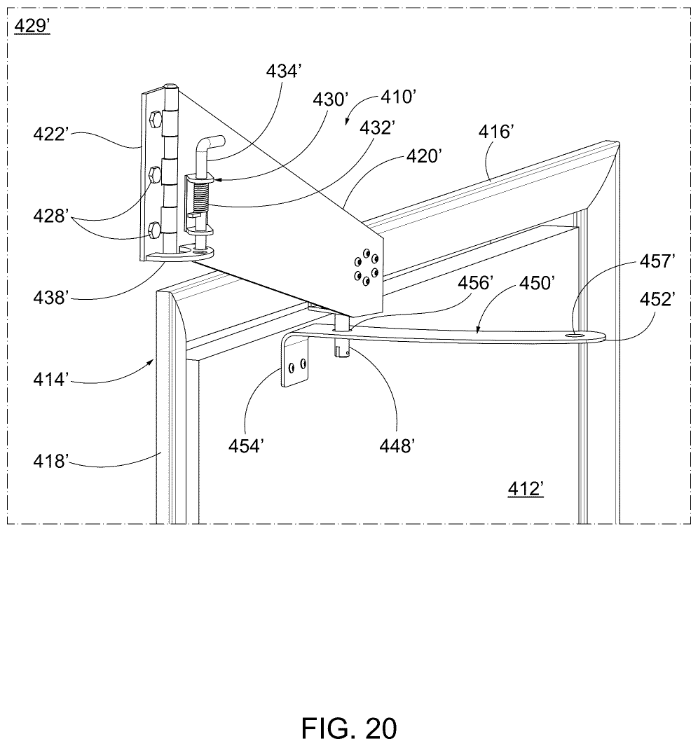

While the embodiment of the doorstop assembly 410 shown in FIGS. 14-19 is configured for inward-opening doors, variations of this doorstop assembly for use with outward-opening doors are also contemplated. Such embodiments are shown in FIGS. 20-23 and described below.

A doorstop assembly 410′ according to one such alternate embodiment is shown in FIGS. 20-22. Unless otherwise described below, the doorstop assembly 410′ includes the same or similar elements as the doorstop assembly 410 (as denoted with the same reference numeral and ′), and operates in the same or similar fashion. Given that the door 412′ opens outward, the L-shaped door dock 450′ of this embodiment has a horizontal component 452′ that is significantly longer than the vertical component 454′ and longer than the horizontal component 452 of the doorstop assembly 410. In one embodiment, the horizontal component 452′ is 8 inches long, and the vertical component is 454′ is 2 inches long (i.e., high). In another embodiment, the horizontal component 452′ is 8 inches long, and the vertical component is 454′ is 3 inches long (i.e., high). Further, the horizontal component 452′ includes both a first aperture 456′ proximate the vertical component 454′ and a second aperture 457′ distal the vertical component 454′. The first and second apertures 456′ and 457′ are configured to receive a portion (i.e., a lower end) of the piston 448′ therethrough when the doorstop assembly 410′ is in its stowed position and operational position, respectively, as further discussed below.

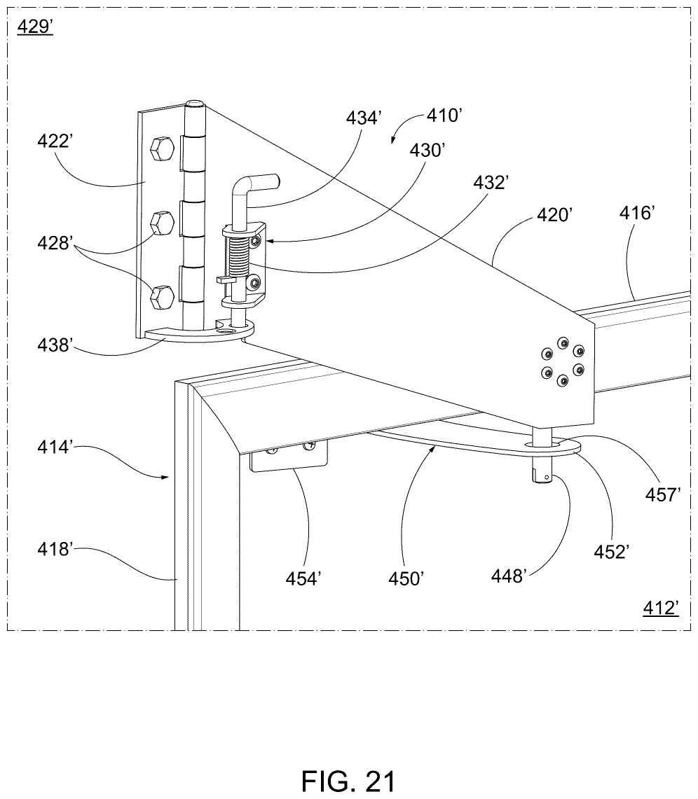

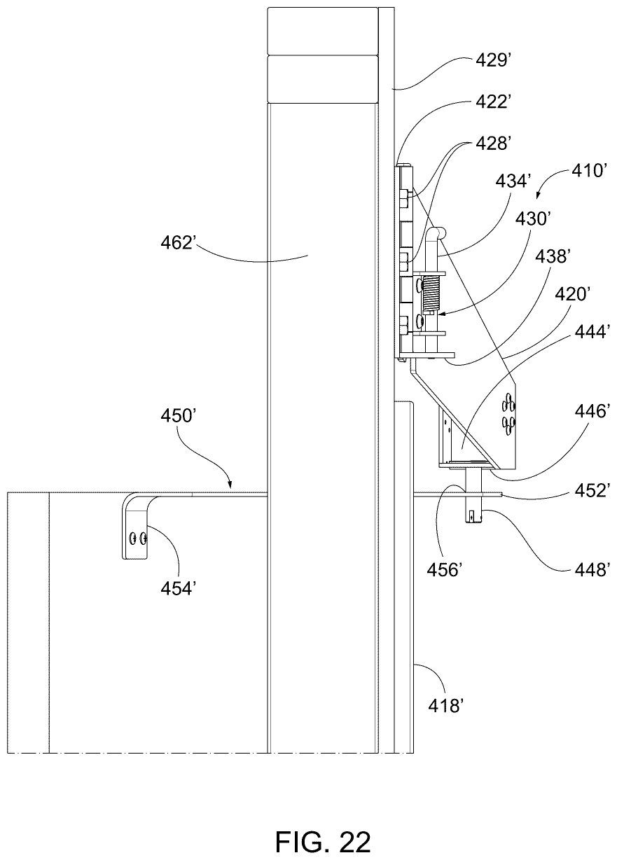

As shown in FIG. 20, the doorstop assembly 410′ is in its stowed position when the door 412′ is closed. The lower end of the piston 448′ is inserted through the first aperture 456′ of the horizontal component 452′ of the L-shaped door dock 450′, which secures the door 412′ in its closed position, thereby enabling the doorstop assembly 410′ to function as a deadbolt lock. When a user wishes to open the door 412′, he or she activates the actuator subassembly 430′, which causes the elongated arm member 420′ of the arm assembly to rotate away from the wall 429′ and move from its stowed position to an extended (i.e., semi-operational) position (not shown) and ultimately to its operational position (as shown in FIG. 21). More particularly, activation of the actuator subassembly 430′ causes the armature 434′ of the electromechanical solenoid to move in an upward direction relative to and within the inductive coil 432′, whereby the lower end of the armature 434′ is lifted out of the first aperture in the flange 438′ (where the lower end is located when the doorstop assembly 410′ is in its stowed position) and the armature 434′ is free to rotate. At or about the same time, the piston 448′ is retracted into the housing 446′ of the piston subassembly 444′, whereby the lower end of the piston 448′ moves upwardly and out of the first aperture 456′. These movements cause the elongated arm member 420′ to disengage from the L-shaped door dock 450′ and freely rotate away from the wall 429′. As the elongated arm member 420′ rotates away from the wall 429′, the armature 434′ travels along the curve of the flange 438′ until the armature's lower end aligns with, and insertably engages, the second aperture in the flange 438′. The engagement of the lower end with the second aperture restricts further movement of the elongated arm member 420′. After the door 412′ is opened outward a desired distance, the piston 448′ is ejected from the housing 446′ of the piston subassembly 444′, moving the lower end of the piston 448′ downwardly such that it insertably engages the second aperture 457′ in the L-shaped door dock 450′ and thereby prevents further outward movement of the door 412′. When the user wishes to close the door 412′, the foregoing steps are performed in reverse order, to move doorstop assembly 410′ from its operational position (as shown in FIGS. 21 and 22) to its stowed position (as shown in FIG. 20).

FIG. 22 is a side view of the doorstop assembly 410′ as installed and in its operational position (with the door 412′ opened outward a desired distance). In the illustrated embodiment, a reinforcement member 462′ is provided behind the wall 429′ (i.e., on the side of the wall 429′ opposite to the side on which the doorstop assembly 410′ is installed). The reinforcement member 462′ is dimensioned and positioned proximate the wall 429′ to receive the base fastening members 428′ therein (i.e., after the base fastening members 428′ are inserted through openings in the base 422′ and the wall 429′ itself) to more securely attach the base 422′ (and thereby the entire doorstop assembly 410′) to the wall 429′. In some embodiments, the reinforcement member 462′ is a 2×4 (two by four) or other piece of lumber.

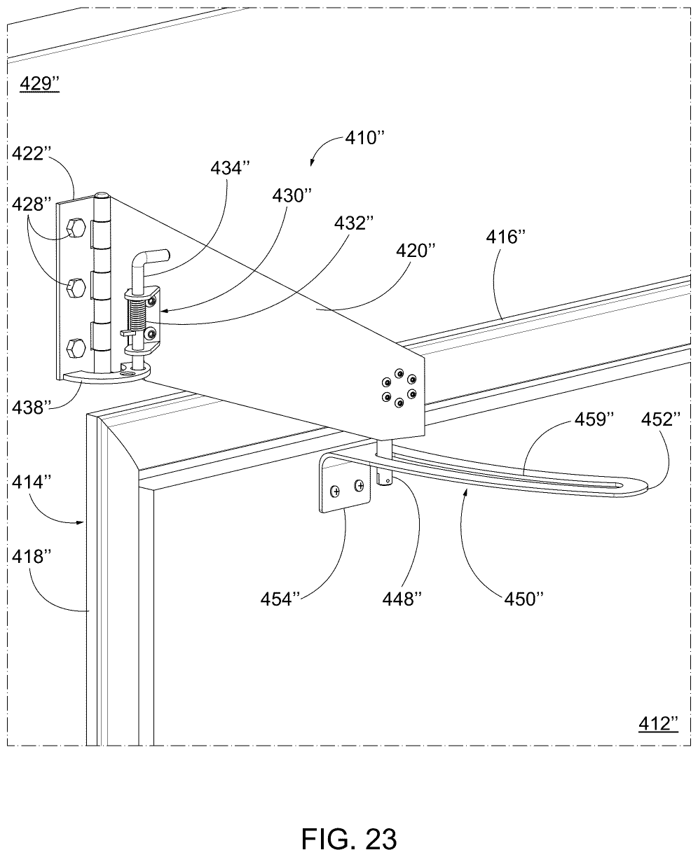

A doorstop assembly 410″ according to another alternate embodiment is shown in FIG. 23. Unless otherwise described below, the doorstop assembly 410″ includes the same or similar elements as the doorstop assembly 410 and 410′ (as denoted with the same reference numeral and”), and operates in the same or similar fashion. The L-shaped door dock 450″ of this embodiment has a horizontal component 452″ that is significantly longer than the vertical component 454″ and the horizontal component 452 of the doorstop assembly 410, but of the same or similar length as the horizontal component 452′ of the doorstop assembly 410′ discussed above. Further, the horizontal component 452″ includes a longitudinal slot 459″ that is configured to receive a portion (i.e., a lower end) of the piston 448″ therethrough when the doorstop assembly 410″ is in its stowed position, operational position and intermediate positions, as further discussed below.

The operation of the doorstop assembly 410″ is similar to that of the doorstop assembly 410′, but instead of the piston 448″ moving between first and second apertures in the horizontal component 452″, the piston 448″ moves within the longitudinal slot 459″. More particularly, the piston 448″ occupies a first position proximate the vertical component 454″ when the door 412″ is closed and the doorstop assembly 410″ is in its stowed position (as shown in FIG. 23), and occupies a second position distal the vertical component 454″ when the door 412″ is opened outward a desired distance and the doorstop assembly 410″ is in its operational position (not shown).

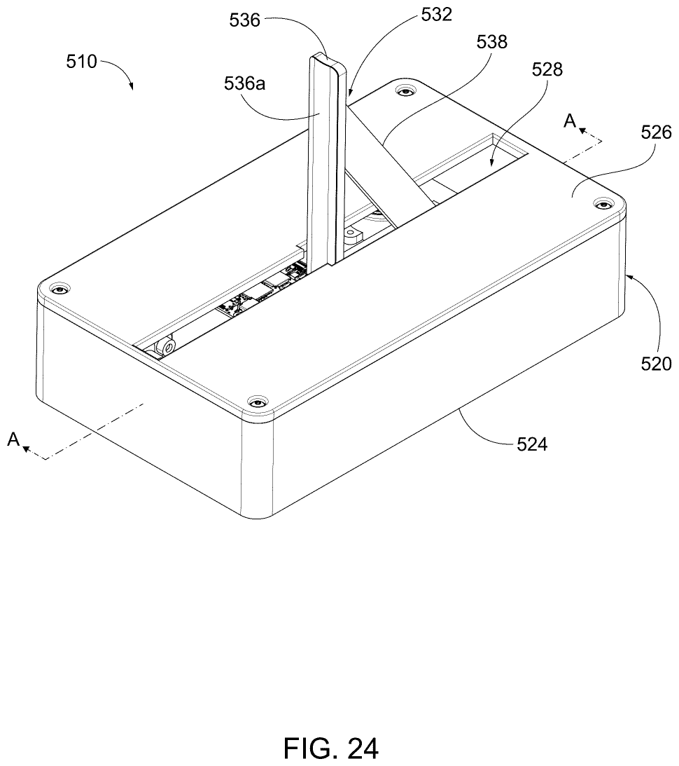

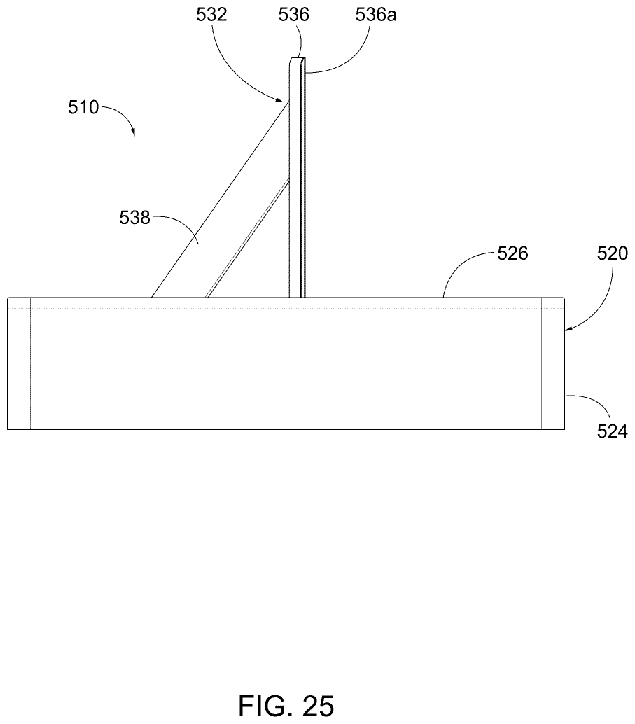

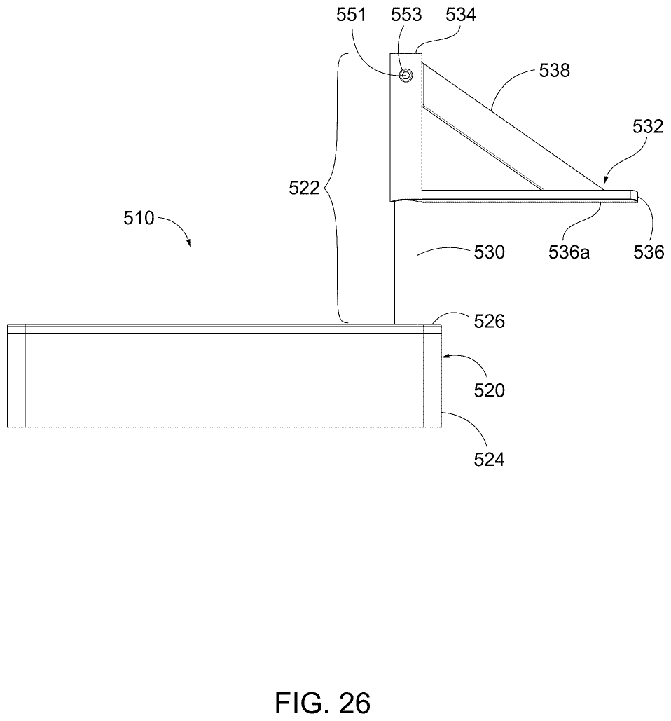

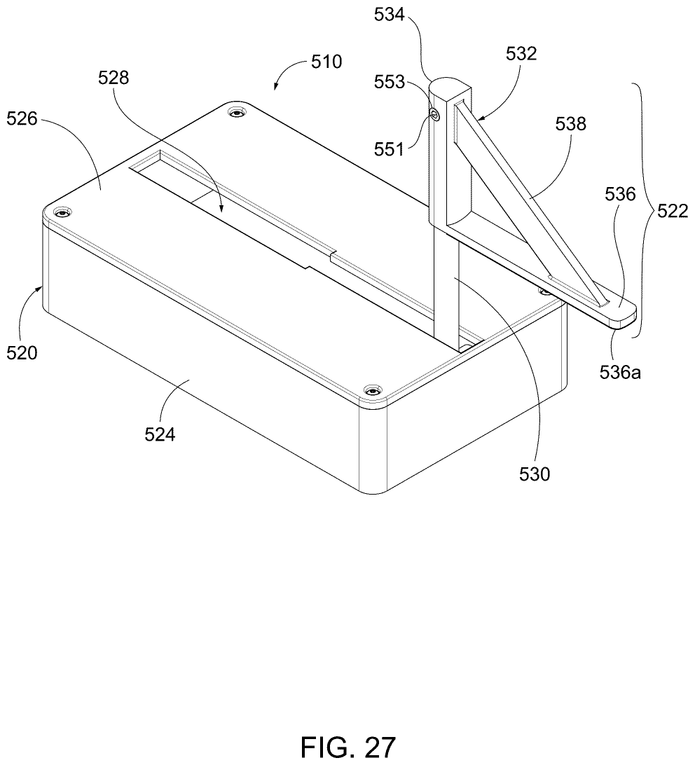

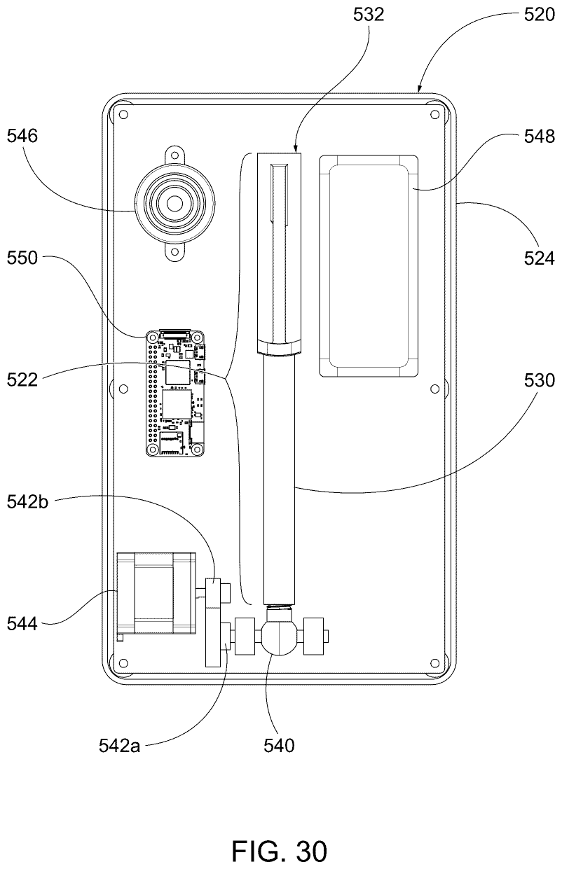

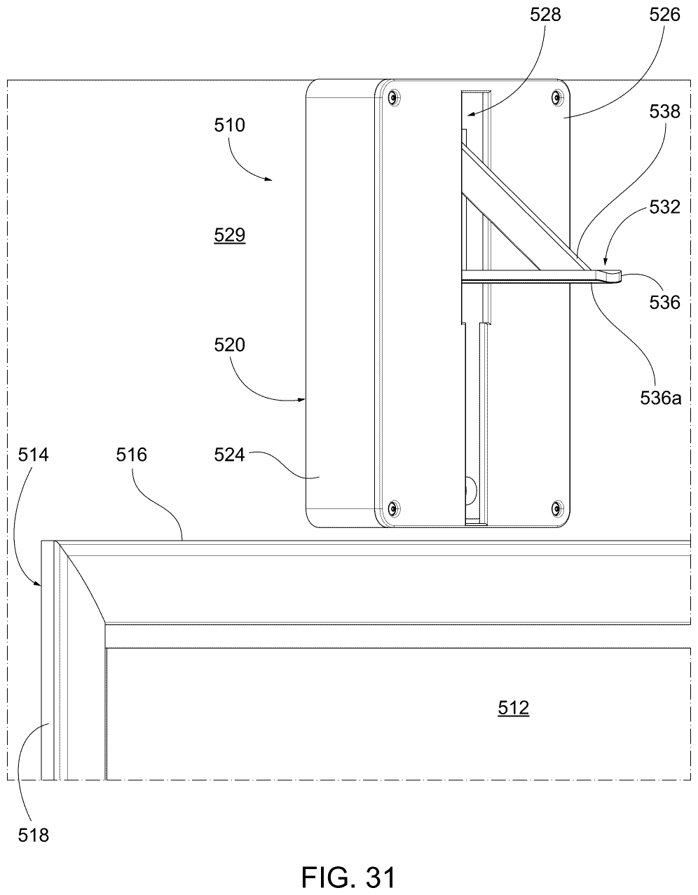

FIGS. 24-30 illustrate a doorstop assembly 510 and FIGS. 31-34 illustrate the doorstop assembly 510 in combination with an inward-opening door 512 and associated frame 514, including a header 516 and jamb 518. As shown in FIGS. 24-30, the doorstop assembly 510 includes a housing 520 and a stopper arm assembly 522. The housing 520 includes a substantially rectangular prism (i.e., cuboid) base 524 configured to contain the stopper arm assembly 522 and internal elements of the doorstop assembly 510 (as discussed below) and a removable cover 526 configured to be secured to an open face (see FIG. 30) of the base 524. The cover 526 defines an elongated opening, or slot, 528 that is configured to allow passage of the stopper arm assembly 522 (or portions thereof) from the base 524 through the cover 526, as further discussed below.

The stopper arm assembly 522 includes a rotating rod 530 having opposed first and second ends 530a, 530b, as further discussed below. The stopper arm assembly 522 further includes an adjoining right triangle-shaped member 532 having a first leg 534 that is connected to the first end 530a of the rod 530 and colinear with the rod 530, a second leg 536 perpendicular to the rod 530 and first leg 534, and a hypotenuse member 538 extending diagonally between the first and second legs 534, 536. The second leg 536 is configured to contact the door 512, as further discussed below, and includes a protective pad or otherwise modified surface 536a in the illustrated embodiment. In alternate embodiments, the second leg 536 may be provided without a protective pad/modified surface 536a.

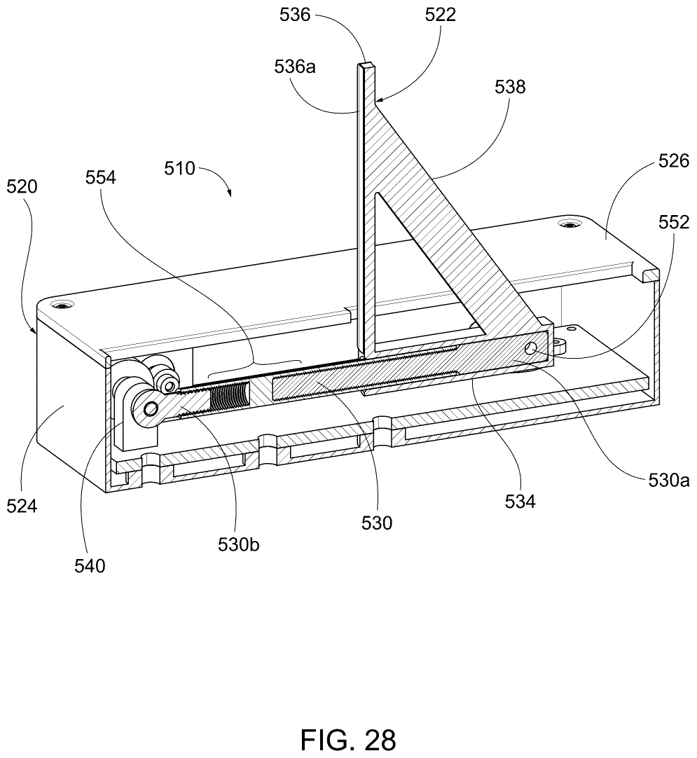

With continued reference to FIGS. 28-30, the rod 530 of the stopper arm assembly 522 is housed within the base 524 of the housing 520, along with a portion of the right triangle-shaped member 532. The base 524 also contains other elements for operation of the doorstop assembly 510, including a pivot 540 rotatably connected to the second end 530b of the rod 530; a first gear 542a operably connected to the pivot 540; a second gear 542b operably connected to the first gear 542a; and a stepper motor 544 operably connected to the second gear 542b. These elements are further discussed below in connection with the operation of the doorstop assembly 510. In order to provide further security to supplement the doorstop assembly's door stopping mechanism, the base 524 further contains a siren/speaker 546 and an associated battery 548 and circuit board 550.

In some embodiments, the base 524 of the doorstop assembly 510 also includes a shock sensor (not shown) that is operably attached to the circuit board 550. When a certain level of shockwave travels through the doorstop assembly 510 (i.e., from a potential intruder's attempted breach of the door 512/doorstop assembly 510), the shock sensor triggers the siren/speaker 546.

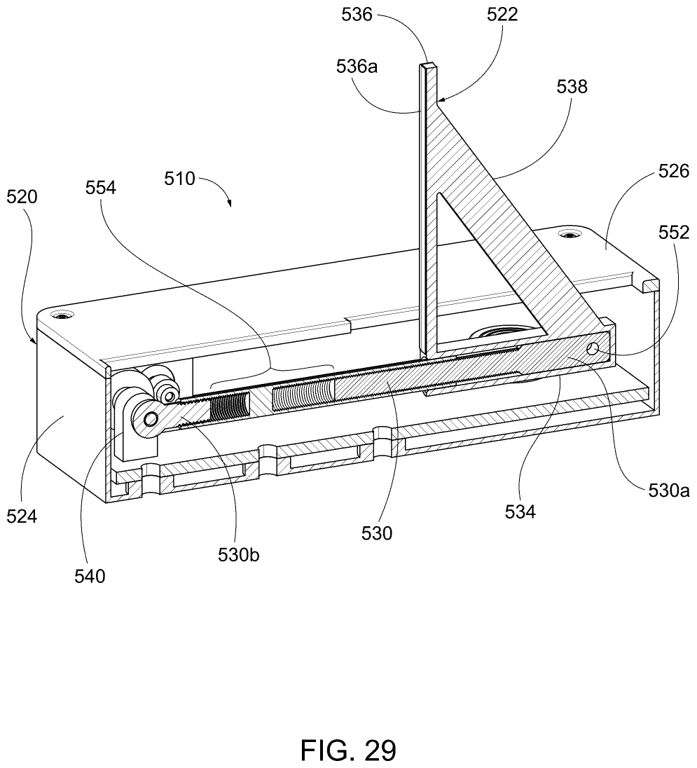

Referring now to FIGS. 28 and 29, the first leg 534 is hollow and configured to receive a portion of the rod 530 therein, including the first end 530a. The first end 530a of the rod 530 is secured within the first leg 534, i.e., by a bolt 551 (or other connection means), via an aperture 552 formed therein and an aligned aperture 553 in the first leg 534. The rod 530 contains an internal threading mechanism 554 which enables a user to modify the length of the rod 530 to accommodate doors of different dimensions and/or adjust the distance which the door 512 may be opened when the doorstop assembly 510 is in its operational position. To modify the length of the rod 530, a user first accesses the first leg 534 within the housing 520/base 524 when the doorstop assembly 510 is in its stowed position. The user loosens and removes the bolt 551 (or other connection means) from the aperture 552 in the first end 530a of the rod 530 and aperture 553 in the first leg 534, which enables the user to separate the rod 530 and first leg 534 (see FIG. 28). The user then uses the internal threading mechanism 554 to lengthen or shorten the rod 530, while it is not connected to the first leg 534 (see FIG. 29, showing a rod 530 whose length is increased by the user). Once the desired length is obtained for the rod 530, the user reattaches the first end 530a of the rod 530 to the first leg 534 by securing the bolt 551 (or other connection means) through the aperture 552 in the first end 530a of the rod 530 and the aligned aperture 553 in the first leg 534.

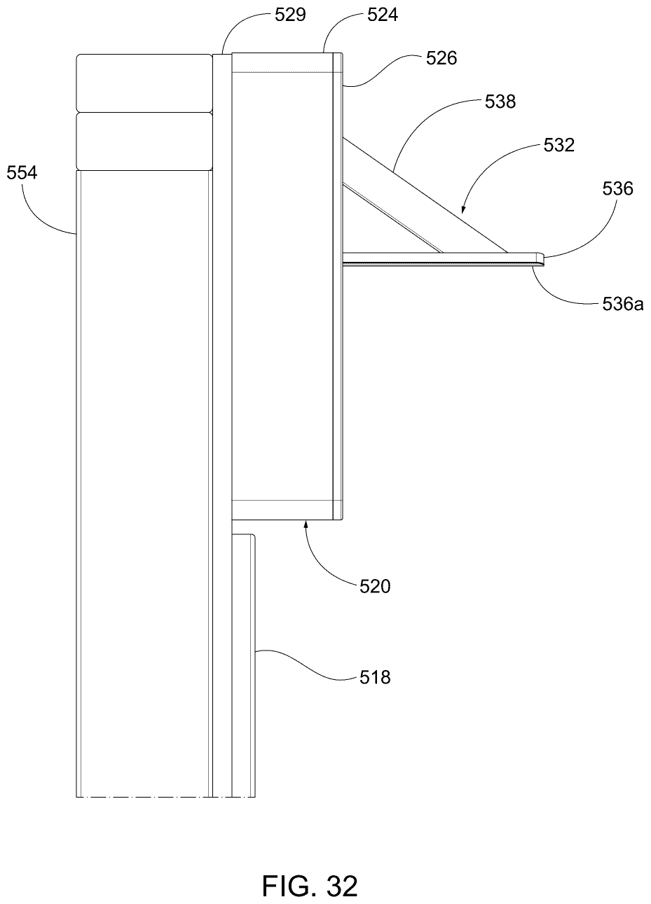

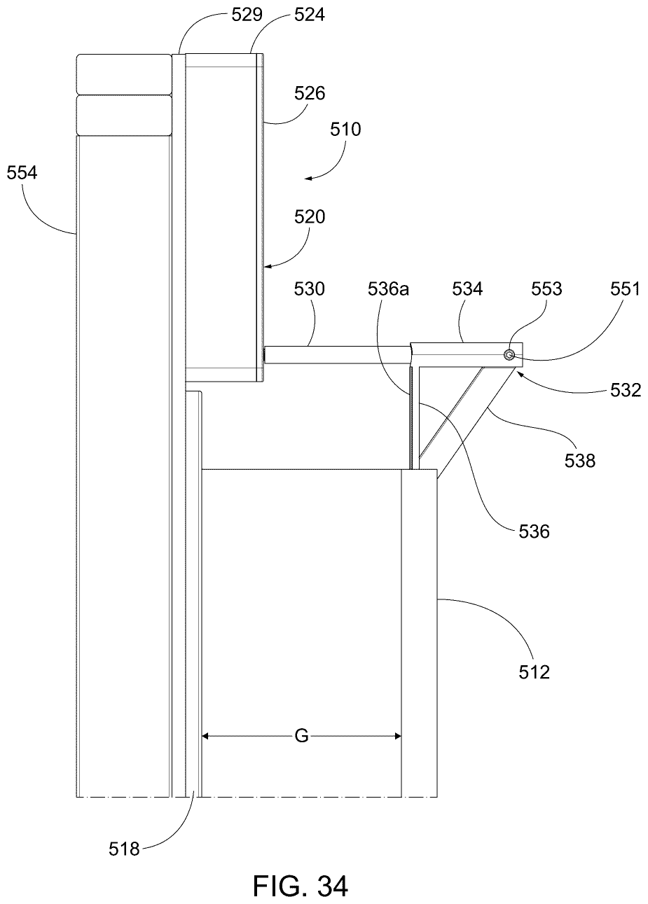

FIGS. 32 and 34 are side views of the doorstop assembly 510 as installed and in its stowed position and operational position, respectively. In the illustrated embodiment, a reinforcement member 554 is provided behind the wall 529 (i.e., on the side of the wall 529 opposite to the side on which the doorstop assembly 510 is installed). The reinforcement member 554 is dimensioned and positioned proximate the wall 529 to receive fastening members from within the base 524 of the housing 522 (i.e., after the fastening members are inserted through a wall-facing surface of the base 524 and the wall 529 itself) to more securely attach the base 524 (and thereby the entire doorstop assembly 510) to the wall 529. In some embodiments, the reinforcement member 554 is a 2×4 (two by four) or other piece of lumber.

The operation of the doorstop assembly 510 will now be described, with reference to FIGS. 31-34. The doorstop assembly 510 is installed by attaching the housing 520 to the wall 529 at a location above and proximate the doorframe header 516. As shown in FIGS. 31 and 32, the doorstop assembly 510 is in its stowed position when the door 512 is closed.

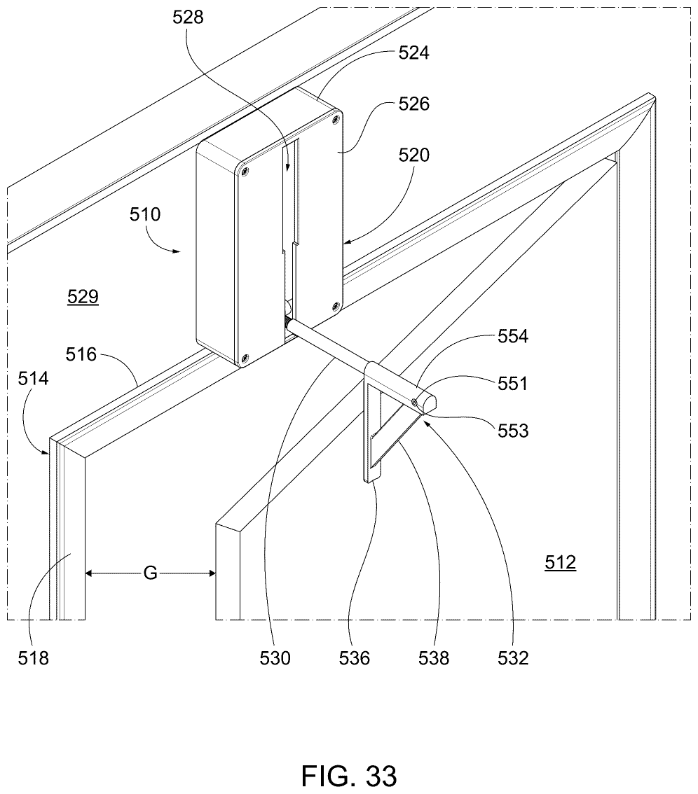

When a user wishes to open the door 512, he or she deploys activation means (not shown), which drives the motor 544 and gears 542a, 542b to cause the pivot 540 to rotate the rod 530, and thereby the stopper arm assembly 522 (including the right triangle-shaped member 532), away from the wall 529 and base 526, through the slot 528 in the cover 526 and downward approximately 90 degrees. This rotation moves the doorstop assembly 510 from its stowed position (shown in FIGS. 31 and 32) to its operational position (shown in FIGS. 33 and 34). At this point, the door-contacting pad 536a and second leg 536 are brought into contact with an inner (i.e., inward-facing) surface of the top (i.e., upper) portion of the door 512 and thereby arrest movement of the door 512 after it has been partially opened to the position illustrated in FIGS. 33 and 34, creating a gap (G) between the door 512 and jamb 518. When the user wishes to close the door 512, the foregoing steps are performed in reverse order, to move doorstop assembly 510 from its operational position (as shown in FIGS. 33 and 34) to its stowed position (as shown in FIGS. 31 and 32).

The activation means that is used to cause the pivotal movement of the rod 530 of the doorstop assembly 510 can include any suitable electro-mechanical means known in the art. Actuation of any such means can be accomplished by, for instance, a manual, wall-mounted switch or button (not shown). Alternatively, the activation means of the doorstop assembly 510 can be actuated remotely via software provided on a mobile phone or similar device (not shown).

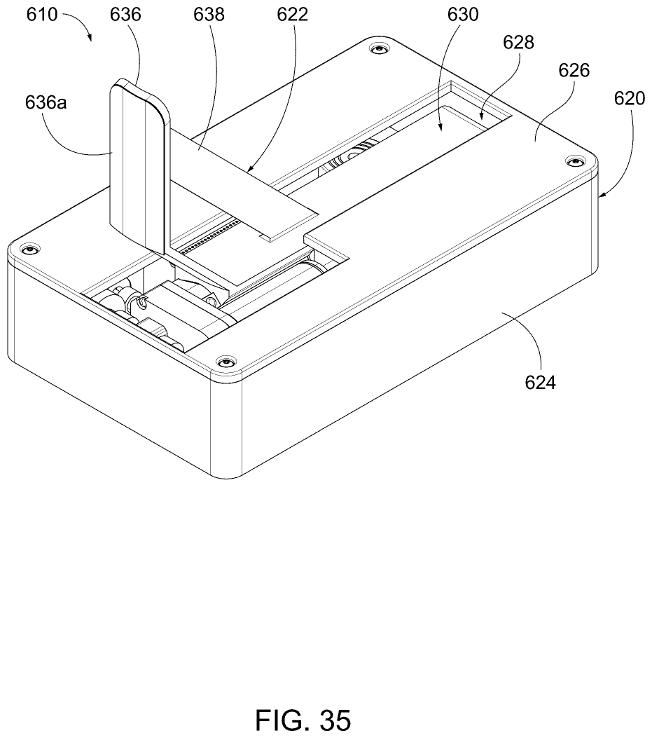

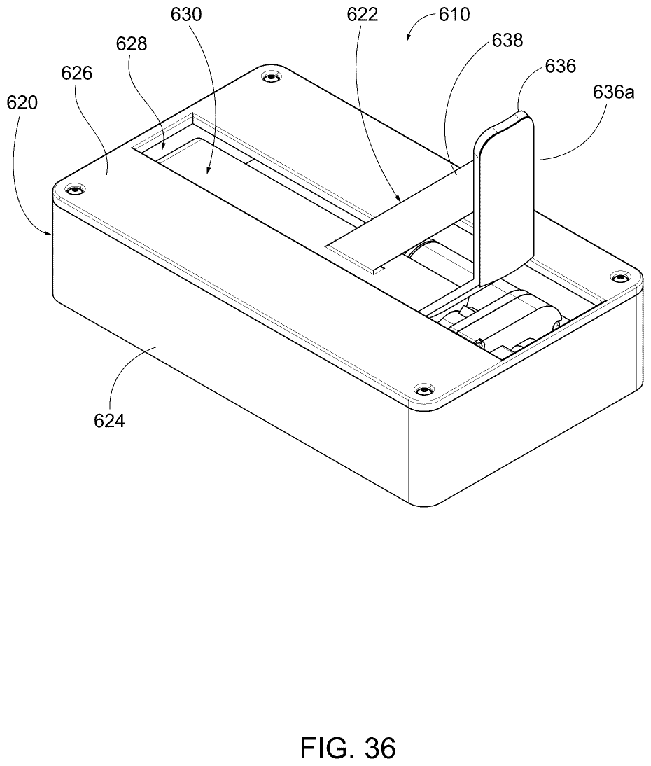

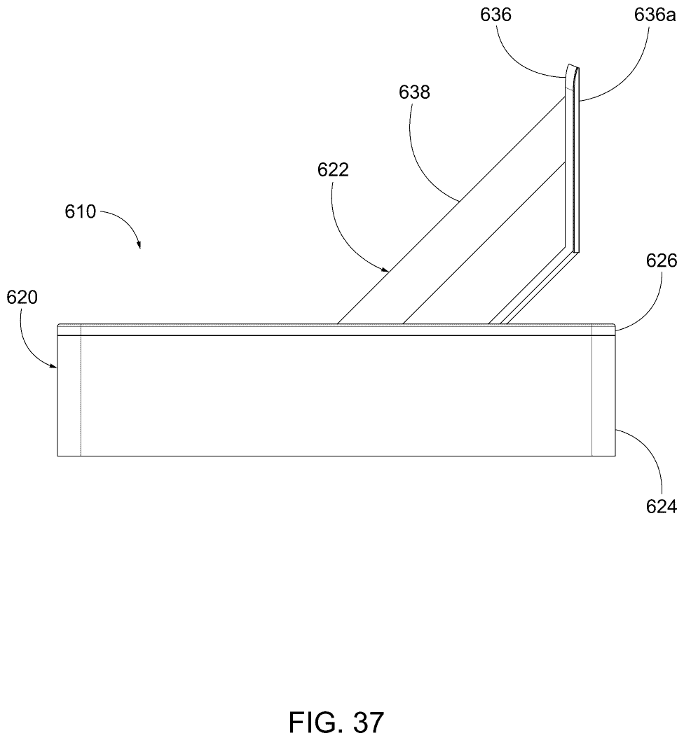

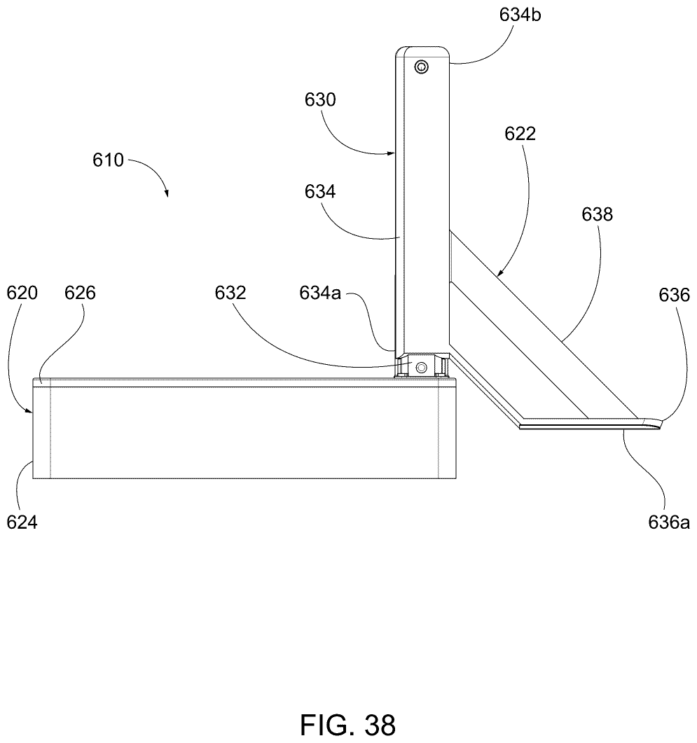

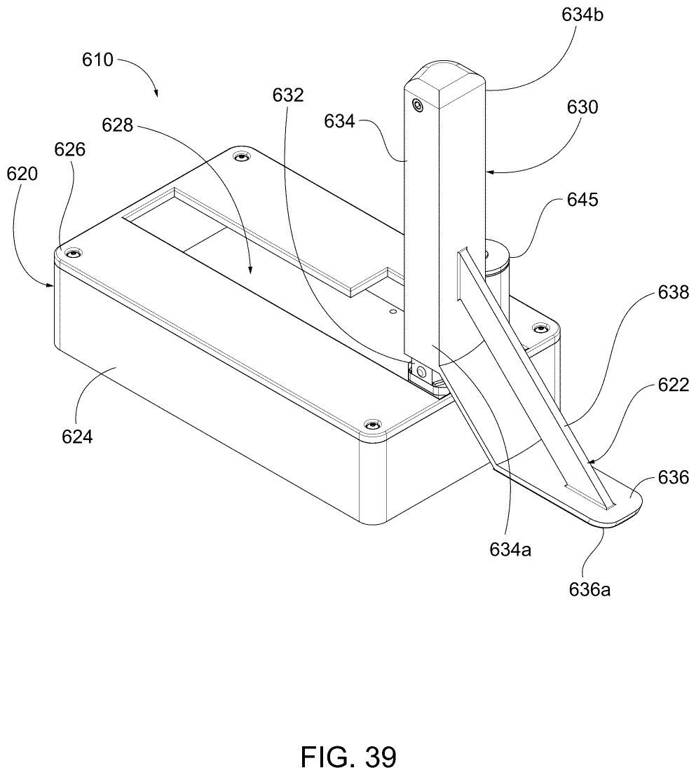

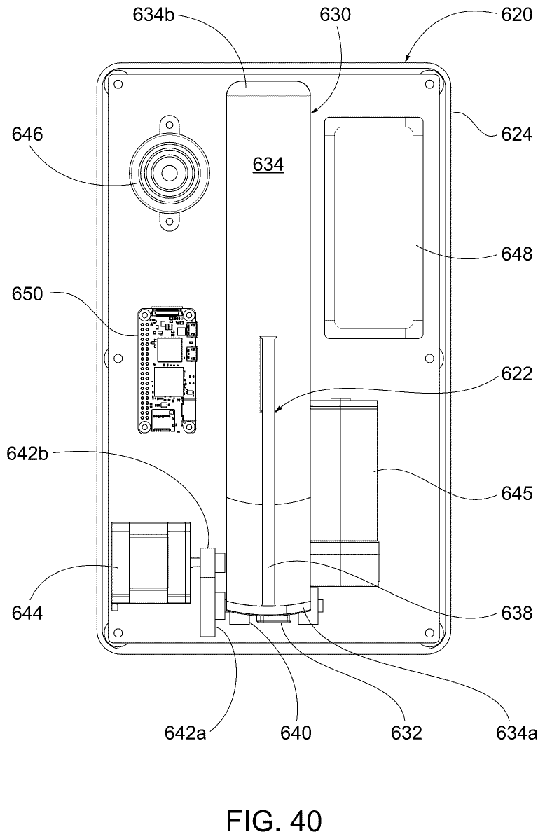

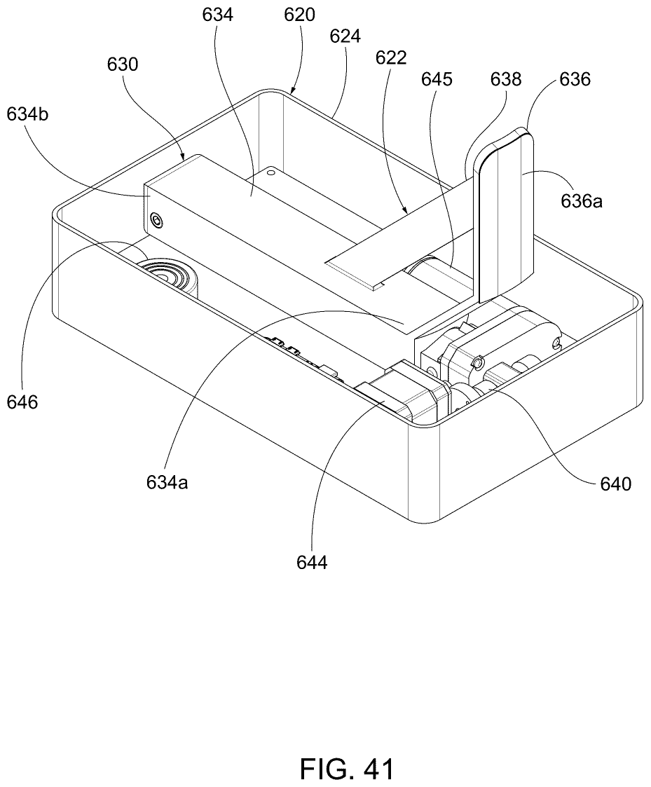

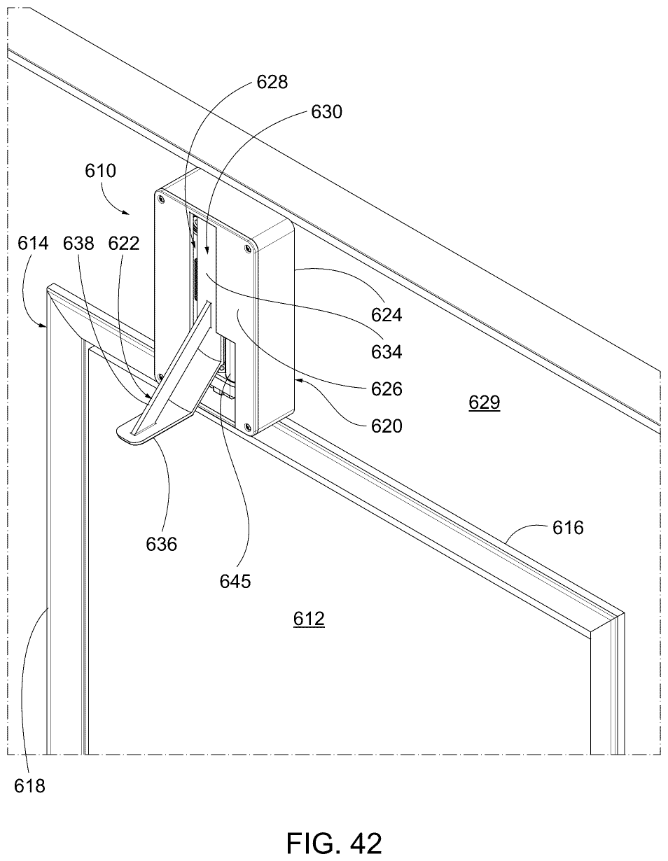

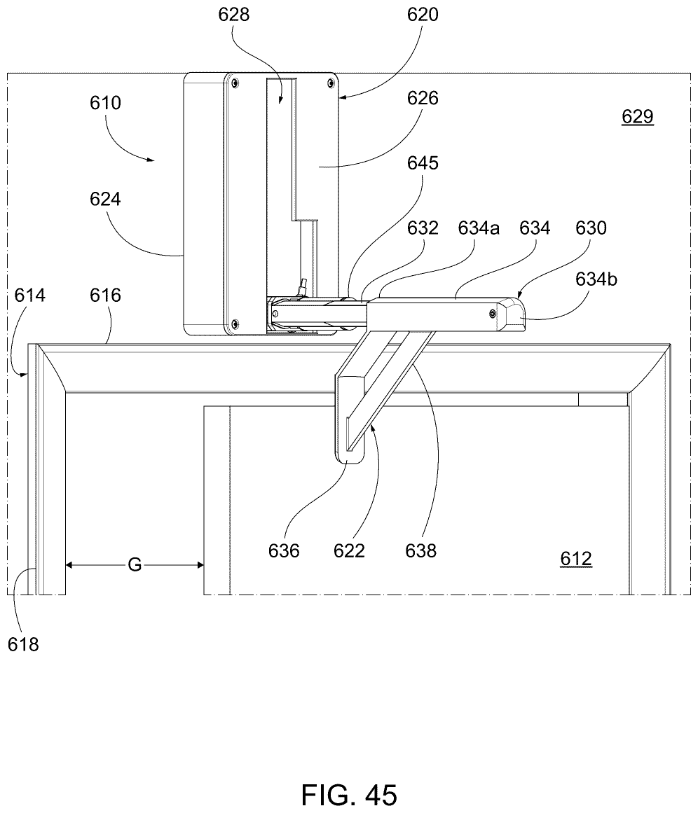

FIGS. 35-41 illustrate a doorstop assembly 610 and FIGS. 42-47 illustrate the doorstop assembly 610 in combination with an inward-opening door 612 and associated frame 614, including a header 616 and jamb 618. Unless otherwise described below, the doorstop assembly 610 includes the same or similar elements as the doorstop assembly 510, and operates in the same or similar fashion. As shown in FIGS. 35-41, the doorstop assembly 610 includes a housing 620 and a stopper arm assembly 622. The housing 620 includes a substantially rectangular prism (i.e., cuboid) base 624 configured to contain the stopper arm assembly 622 and internal elements of the doorstop assembly 610 (as discussed below) and a removable cover 626 configured to be secured to an open face (see FIGS. 40 and 41) of the base 624. The cover 626 defines an elongated opening, or slot, 628 that is configured to allow passage of the stopper arm assembly 622 (or portions thereof) from the base 624 through the cover 626, as further discussed below.

Unlike the rod of the stopper arm assembly 522 in the doorstop assembly 510, the stopper arm assembly 622 of the doorstop assembly 610 includes a rotating linear actuator 630 having an inner member 632 and an outer member 634 that telescopically engages the inner member 632, as further discussed below. The outer member 634 of the linear actuator 630 has opposed first and second ends 634a, 634b.

The stopper arm assembly 622 further includes a first leg 636 that extends from the first end 634a of the outer member 634 of the linear actuator 630, and a second leg 638 extending diagonally between the first leg 636 and the linear actuator 630. At least part of the first leg 636 is configured to contact the door 612, as further discussed below, and includes a protective pad or otherwise modified surface 636a in the illustrated embodiment. In alternate embodiments, the first leg 636 may be provided without a protective pad/modified surface 636a.

With continued reference to FIGS. 35-41, the linear actuator 630 is housed within the base 624 of the housing 620. As shown in FIGS. 40 and 41, the base 624 also contains other elements for operation of the doorstop assembly 610, including a pivot 640 rotatably connected to the first end 634a of the outer member 634 of the linear actuator 630; a first gear 642a operably connected to the pivot 640; a second gear 642b operably connected to the first gear 642a; a stepper motor 644 operably connected to the second gear 642b; and an actuator motor 645 operably connected to the linear actuator 630. These elements are further discussed below in connection with the operation of the doorstop assembly 610. In order to provide further security to supplement the doorstop assembly's door stopping mechanism, the base further contains a siren/speaker 646 and an associated battery 648 and circuit board 650.

In some embodiments, the base 624 of the doorstop assembly 610 also includes a shock sensor (not shown) that is operably attached to the circuit board 650. When a certain level of shockwave travels through the doorstop assembly 610 (i.e., from a potential intruder's attempted breach of the door 612/doorstop assembly 610), the shock sensor triggers the siren/speaker 646.

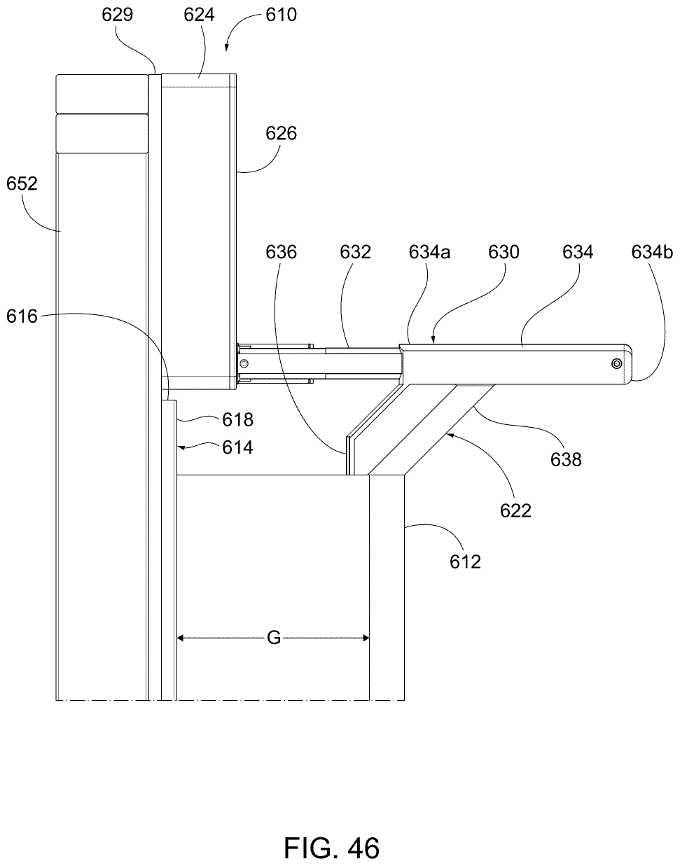

FIG. 46 is a side view of the doorstop assembly 610 as installed and in its operational position. In the illustrated embodiment, a reinforcement member 652 is provided behind the wall 629 (i.e., on the side of the wall 629 opposite to the side on which the doorstop assembly 610 is installed). The reinforcement member 652 is dimensioned and positioned proximate the wall 629 to receive fastening members from within the base 624 of the housing 622 (i.e., after the fastening members are inserted through a wall-facing surface of the base 624 and the wall 629 itself) to more securely attach the base 624 (and thereby the entire doorstop assembly 610) to the wall 629. In some embodiments, the reinforcement member 652 is a 2×4 (two by four) or other piece of lumber.

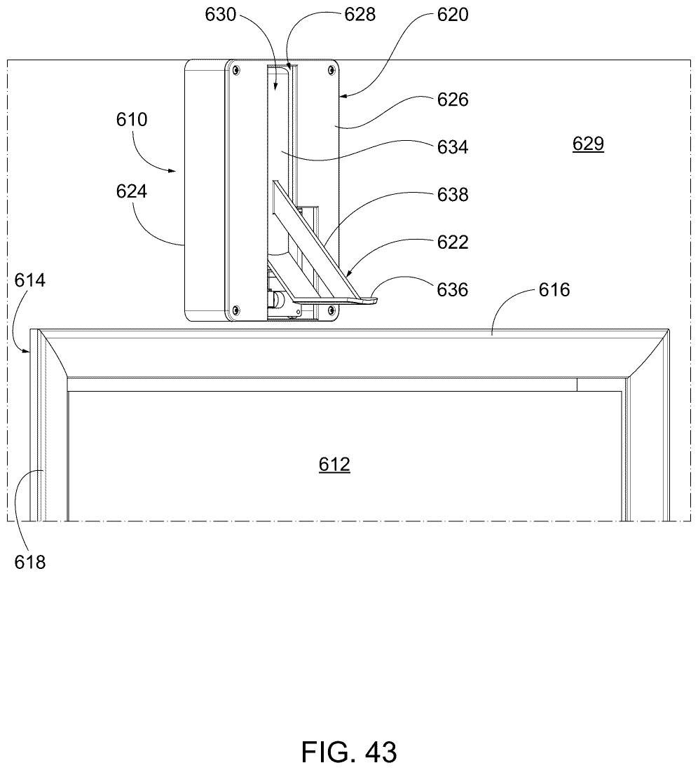

The operation of the doorstop assembly 610 will now be described, with reference to FIGS. 42-47. The doorstop assembly 610 is installed by attaching the housing 620 to the wall 629 at a location above and proximate the doorframe header 616. FIGS. 42 and 43 show the doorstop assembly 610 in its stowed position with the door 612 closed.

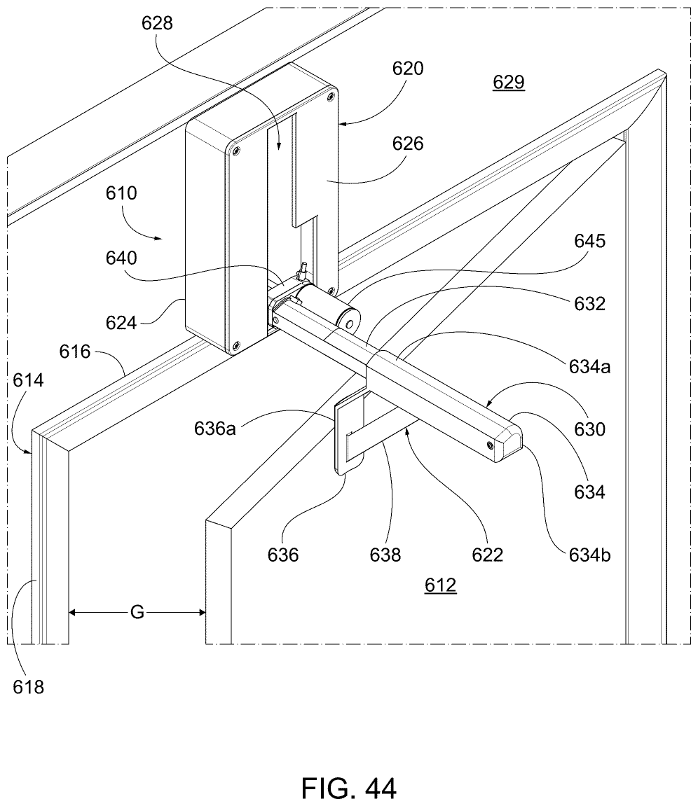

When a user wishes to open the door 612, he or she deploys activation means (not shown), which drives the stepper motor 644 and gears 642a, 642b to cause the pivot 640 to rotate the linear actuator 630, and thereby the stopper arm assembly 622, away from the wall 629 and base 626, through the slot 628 in the cover 626 and downward approximately 90 degrees. As the linear actuator 630 rotates downward, its outer member 634 extends away from its inner member 632, as shown in FIGS. 44-46. This rotation moves the doorstop assembly 610 from its stowed position (shown in FIGS. 42 and 43) to its operational position (shown in FIGS. 44-46). At this point, the door-contacting pad 636a and first leg 636 are brought into contact with an inner (i.e., inward-facing) surface of the top (i.e., upper) portion of the door 612 and thereby arrest movement of the door 612 after it has been partially opened to the position illustrated in FIGS. 44-46, creating a gap (G) between the door 612 and jamb 618.

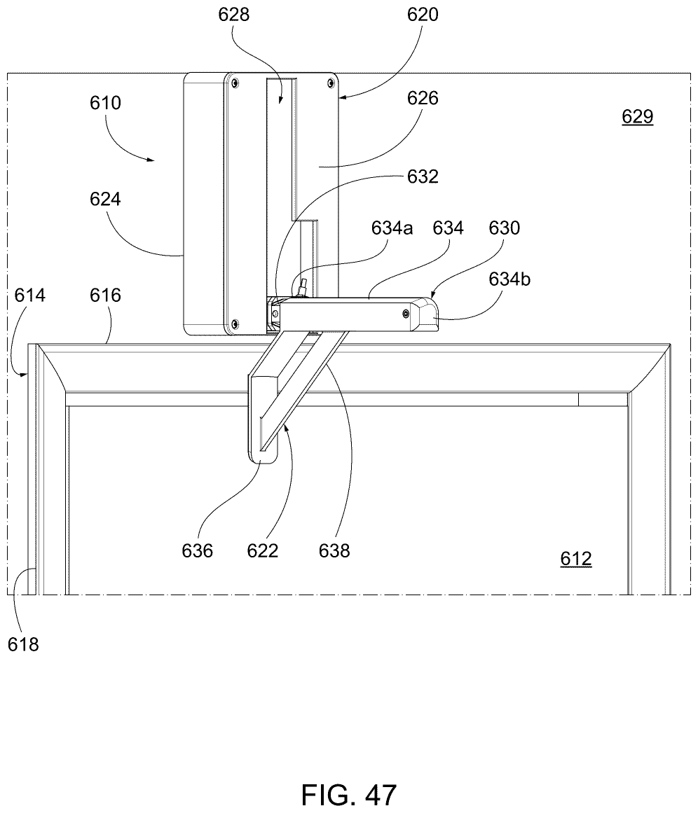

When the user wishes to close the door 612, he or she may perform the foregoing steps in reverse order, to move doorstop assembly 610 from its operational position (as shown in FIGS. 44-46) to its stowed position (as shown in FIGS. 42 and 43). Alternatively, the user may close and further secure the door 612 by deploying activation means (not shown) to drive the actuator motor 645 and causes the outer member 634 of the linear actuator 630 to retract and move towards the wall 629 and housing 620, whereby the outer member 634 moves over the inner member 632 (i.e., in a telescoping fashion), as shown in FIG. 47. In moving this way, the outer member 634 of the linear actuator 630 pushes the door 612 closed with the door-contacting pad 636a and first leg 636 still in contact with the door 612, and can thereby act as a deadbolt lock to further secure the door 612 in its closed position.

The activation means that is used to cause the pivotal and linear/telescoping movements of the linear actuator 630 of the doorstop assembly 610 can include any suitable electro-mechanical means known in the art. Actuation of any such means can be accomplished by, for instance, a manual, wall-mounted switch or button (not shown). Alternatively, the doorstop assembly 610 can be actuated remotely via software provided on a mobile phone or similar device (not shown).

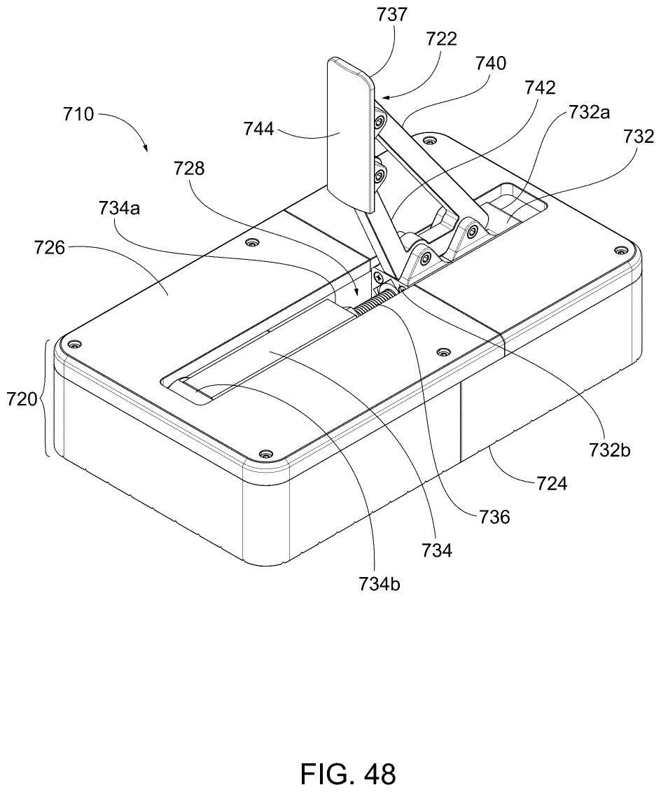

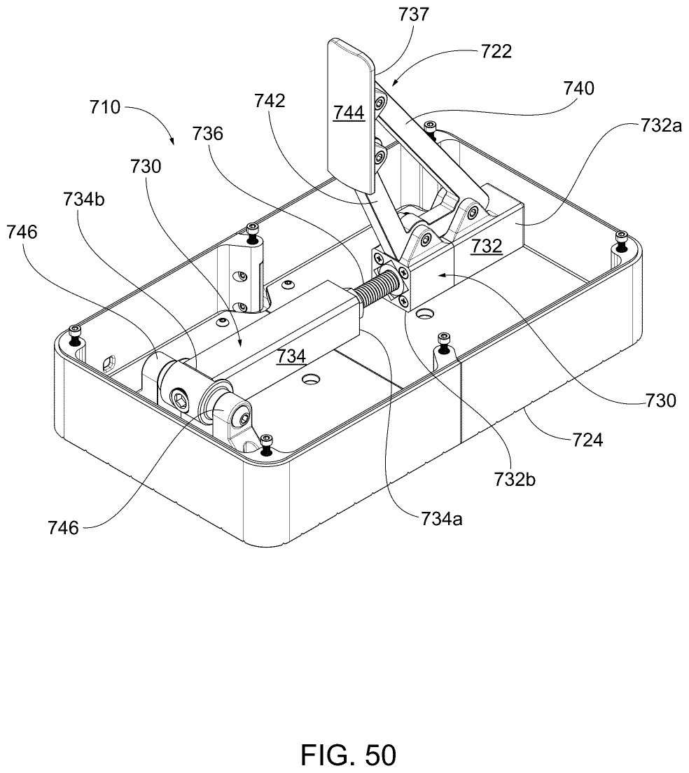

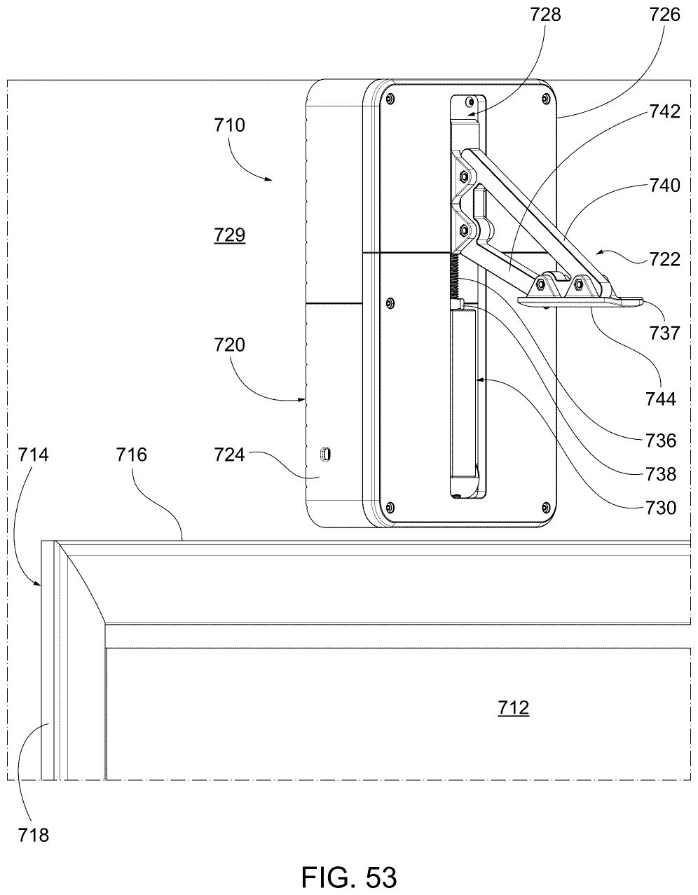

FIGS. 48-52 illustrate a doorstop assembly 710 and FIGS. 53-56 illustrate the doorstop assembly 710 in combination with an inward-opening door 712 and associated frame 714, including a header 716 and jamb 718. Unless otherwise described below, the doorstop assembly 710 includes the same or similar elements as the doorstop assembly 510, and operates in the same or similar fashion. As shown in FIGS. 48-52, the doorstop assembly 710 includes a housing 720 and a stopper arm assembly 722. The housing 720 includes a substantially rectangular prism (i.e., cuboid) base 724 configured to contain the stopper arm assembly 722 and internal elements of the doorstop assembly 710 (as discussed below) and a removable cover 726 configured to be secured to an open face (see FIGS. 50-52) of the base 724. The cover 726 defines an elongated opening, or slot, 728 that is configured to allow passage of the stopper arm assembly 722 (or portions thereof) from the base 724 through the cover 726, as further discussed below.

As further discussed below, one difference between the doorstop assembly 710 disclosed herein and the doorstop assembly 510 is that the doorstop assembly 710 is configured so that disassembly is not required to make adjustments necessary to accommodate doors of different dimensions and/or to vary the distance that an associated door may be opened when the doorstop assembly 710 is in its operational position.

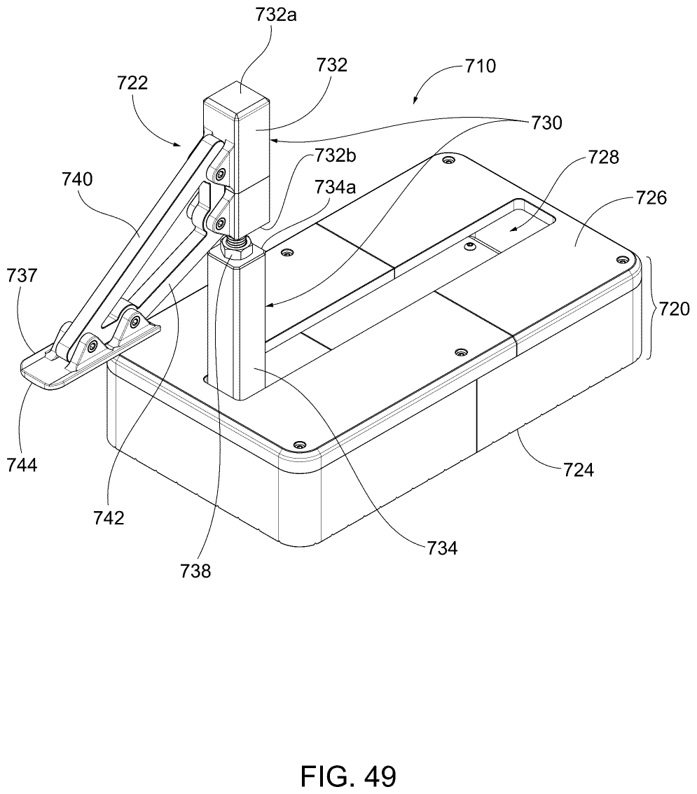

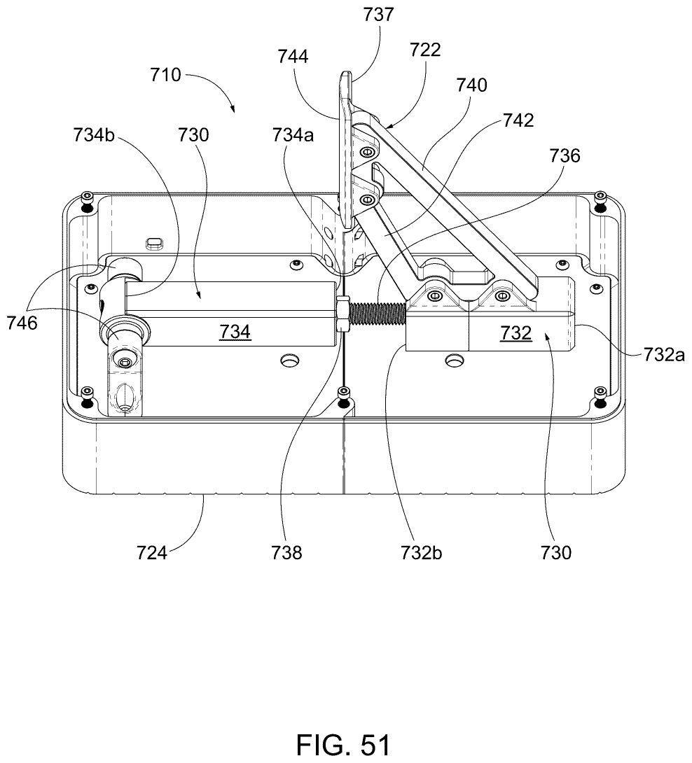

The stopper arm assembly 722 includes a pivotable rod, or arm, 730 (see FIG. 49) having (i) a first rod portion 732 with opposed first and second ends 732a, 732b (see FIGS. 48-51); (ii) a second rod portion 734 with opposed first and second ends 734a, 734b (see FIGS. 48, 49 and 51); and (iii) a threaded bolt 736 (see FIGS. 48, 49 and 51) that extends between the first and second rod portions 732, 734 to connect them in a manner, and for a purpose, to be described hereinbelow. The first rod portion 732 is configured to act as a carriage for a door-contacting member 737 of the stopper arm assembly 722, as further discussed below. The threaded bolt 736 is threadably engaged by a nut 738 (see FIGS. 49 and 51), and as further discussed below, the threaded bolt 736 and nut 738 enable a user to modify the length of the rod 730 to accommodate doors of different dimensions and/or adjust the distance an associated door may be opened when the doorstop assembly 710 is in its operational position.

With continued reference to FIGS. 48-51, the stopper arm assembly 722 further includes a first leg 740 having a first end that is connected proximate the first end 732a of the first rod portion 732 and extends therefrom, and a second leg 742 having a first end that is connected proximate the second end 732b of the first rod portion 732 and extends therefrom. The first and second legs 740, 742 also have respective second ends that engage the door-contacting member 737, which is configured to contact the door as it is being opened and with the door-stopping member 737 having been pivoted from a generally horizontal orientation it assumes in its stowed position to a generally vertical orientation it assumes in its operational (i.e., door-arresting) position. The door-contacting member 737 includes a protective pad or otherwise modified surface 744 in the illustrated embodiment. In alternate embodiments, the door-contacting member 737 may be provided without the protective pad/modified surface 744. In alternate embodiments, the stopper arm assembly 722 includes one leg rather than two legs, with the one leg extending between the pivotable rod 730 and the door-contacting member 737.

The pivotable rod 730 of the stopper arm assembly 722 is housed within the base 724 of the housing 720 when the doorstop assembly 710 is in its stowed position (i.e., when not in its operational position), as shown in FIGS. 48, 49, 51 and 52. The base 724 also contains elements for operation of the doorstop assembly 710, including a pivot 746 (see, especially, FIGS. 50-52) rotatably connected to the second end 734b of the second rod portion 734, and other elements disclosed in connection with the doorstop assembly 510 (as shown in in FIG. 30 illustrating same), including, but not limited to, a first gear 748a operably connected to the pivot 746; a second gear 748b operably connected to the first gear 748a; and a stepper motor 750 operably connected to the second gear 748b. These elements are further discussed below in connection with the operation of the doorstop assembly 710. In order to provide further security to supplement the doorstop assembly's door stopping mechanism, the base 724 further contains a siren/speaker 752 and an associated battery 754 and circuit board 756 in some embodiments of the doorstop assembly.

The first end 734a of the second rod portion 734 includes an opening (not shown) that threadably and rotatably receives a proximal (i.e., closer to the pivot 746) end of the threaded bolt 736 such that the distance the threaded bolt 736 extends from the second rod portion 734 can be varied to thereby adjust the length of the rod 730 in a manner to be described in greater detail below. As best shown in FIGS. 49 and 51, the nut 738 surrounding the proximal end of the threaded bolt 736 is positioned in contact with the first end 734a of the second rod portion 734, in which position (i.e., a locked position) the nut 738 prevents the threaded bolt 736 from being rotated relative to the second rod portion 734, thereby fixing the distance between the second end 732b of the first rod portion 732 and the first end 734a of the second rod portion 734 and hence the length of the rod 730. However, as discussed in greater detail below, the nut 738 can be manually rotated in one direction (e.g., a counterclockwise direction) by a user to free the threaded bolt 736 and allow the length of the rod 730 to be adjusted. Once the desired length of the rod 730 is obtained, opposite rotation of the nut 738 (e.g., in a clockwise direction) can move it back into contact with the first end 734a of the second rod portion 734 to thereby lock the proximal end of the threaded bolt 736 in place.

In contrast, a distal (i.e., farther from the pivot 746) end of the threaded bolt 736 is fixedly secured within the second end 732b of the first rod portion 732 such that the threaded bolt 736 does not rotate relative to the first rod portion 732. As a result, the first rod portion 732 can be used to conjointly rotate the threaded bolt 736 and thereby adjust the length of the rod 730, via the method discussed below.

To adjust the length of the rod 730, a user first positions the doorstop assembly 710 in its operational position (see FIG. 49) so that the stopper arm assembly 722 and the rod 730 thereof are pivoted to be almost entirely outside the housing 720 with the door-contacting member 737 in a vertical or substantially vertical orientation. The next step involves the user rotating the nut 738 in a counterclockwise direction to unlock the threaded bolt 736 from its fixed position in relation to the second rod portion 734. In order to adjust the overall length of the rod 730 (i.e., to either increase or decrease the distance between the second end 732b of the first rod portion 732 and the first end of 734a of the second rod portion 734), the user can then rotate, in either a clockwise or counterclockwise direction, the first rod portion 732 to thereby conjointly rotate the threaded bolt 736 that is securely and immovably (i.e., non-rotatably) connected to the first rod portion 732. Once the desired length of the rod 730 is obtained by rotatably adjusting the threaded bolt 736, the user turns the nut 738 in a clockwise direction until it contacts the first end 734a of the second rod portion 734, thereby locking the threaded bolt 736 in place relative to the second rod portion 734 such that the threaded bolt 736 is no longer rotatable relative to the second rod portion 734.

Having the threaded bolt 736 and nut 738 of the rod 730 configured to operate as discussed above enables the user to adjust the length of the rod 730 without having to disassemble the doorstop assembly 710, unlike the doorstop assembly 510 discussed above. However, the operation of the doorstop assembly 710 is otherwise generally the same as that of the doorstop assembly 510, as further discussed below.

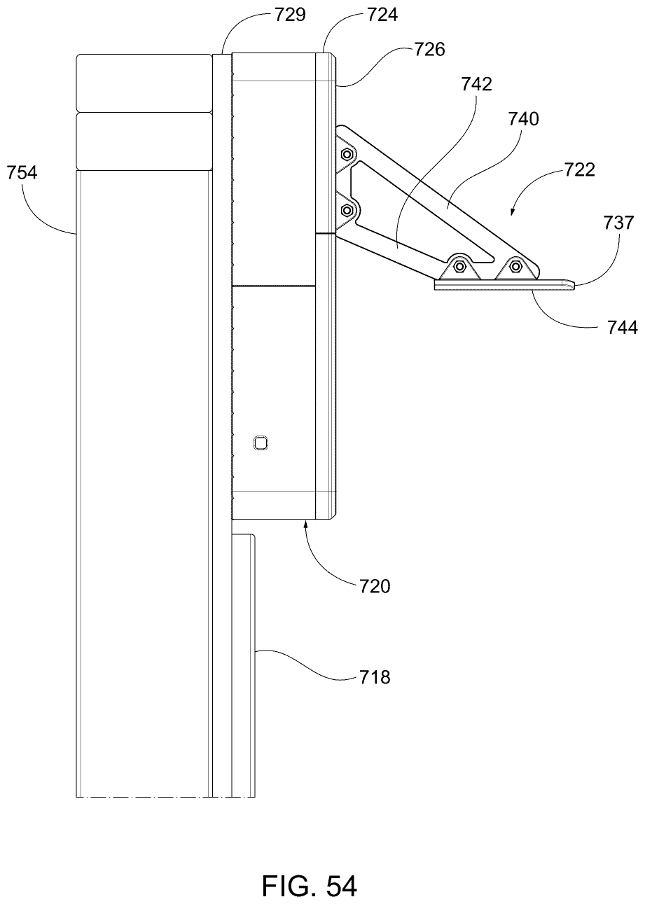

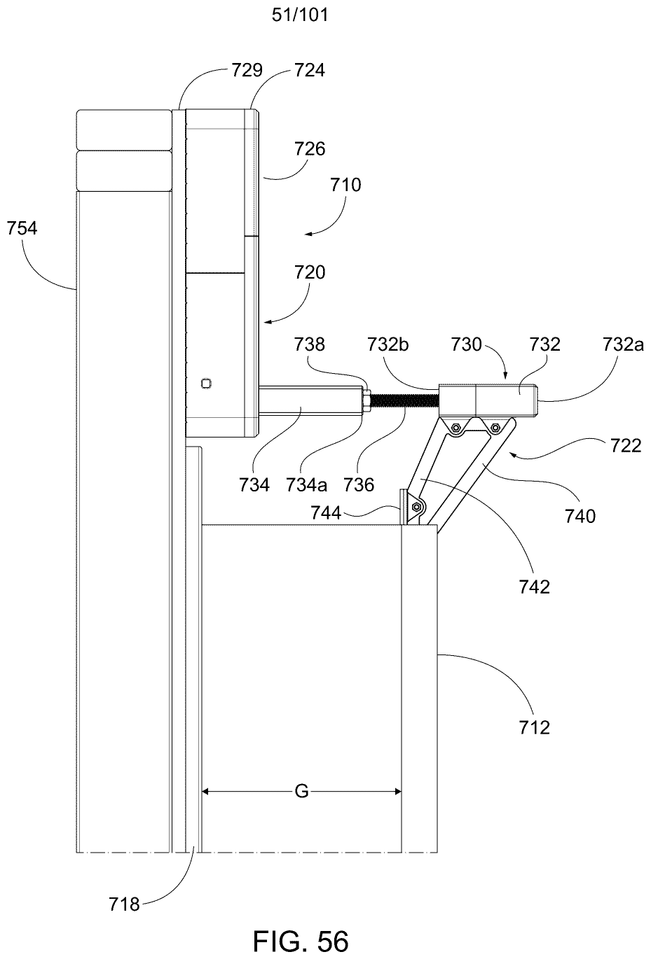

FIGS. 54 and 56 are side views of the doorstop assembly 710 as installed in a wall 729 above the doorframe 714 and door 712 in its stowed position and operational position, respectively. In the illustrated embodiment, a reinforcement member 754 is provided behind the wall 729 (i.e., on the side of the wall 729 opposite to the side on which the doorstop assembly 710 is installed). The reinforcement member 754 is dimensioned and positioned proximate the wall 729 to receive fastening members from within the base 724 of the housing 722 (i.e., after the fastening members are inserted through a wall-facing surface of the base 724 and the wall 729 itself) to more securely attach the base 724 (and thereby the entire doorstop assembly 710) to the wall 729. In some embodiments, the reinforcement member 754 is a 2×4 (two by four) or other piece of lumber.

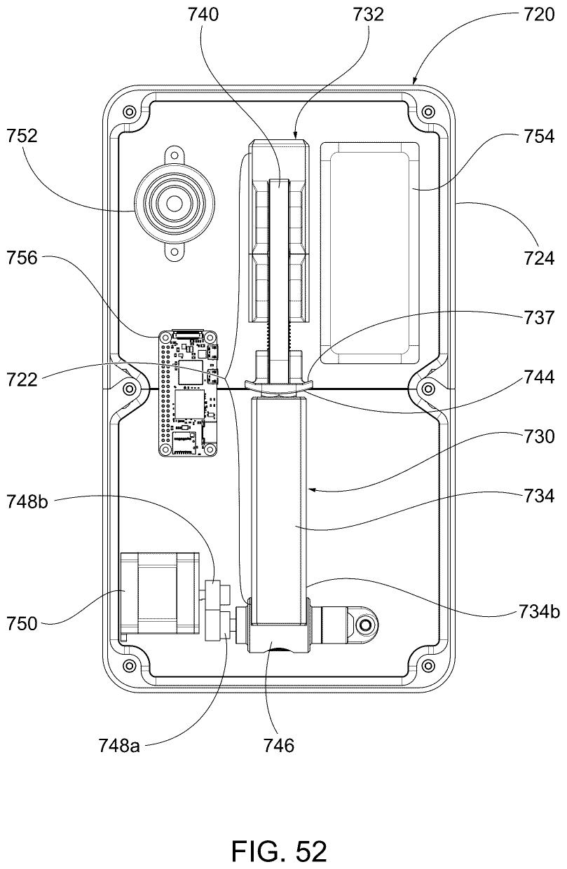

The operation of the doorstop assembly 710 will now be described, with reference to FIGS. 52-55. The doorstop assembly 710 is installed by attaching the housing 720 to the wall 729 at a location above and proximate the doorframe header 716. As shown in FIGS. 52 and 53, the doorstop assembly 710 is in its stowed position when the door 712 is closed. After installation, a user may adjust the length of the rod 730 to accommodate dimensions of the door 712 and/or to vary the distance that the door 712 may be opened when the doorstop assembly 710 is in its operational position, as described above. The use may alternatively adjust the length of the rod 730 before installation of the doorstop assembly 710, if applicable.

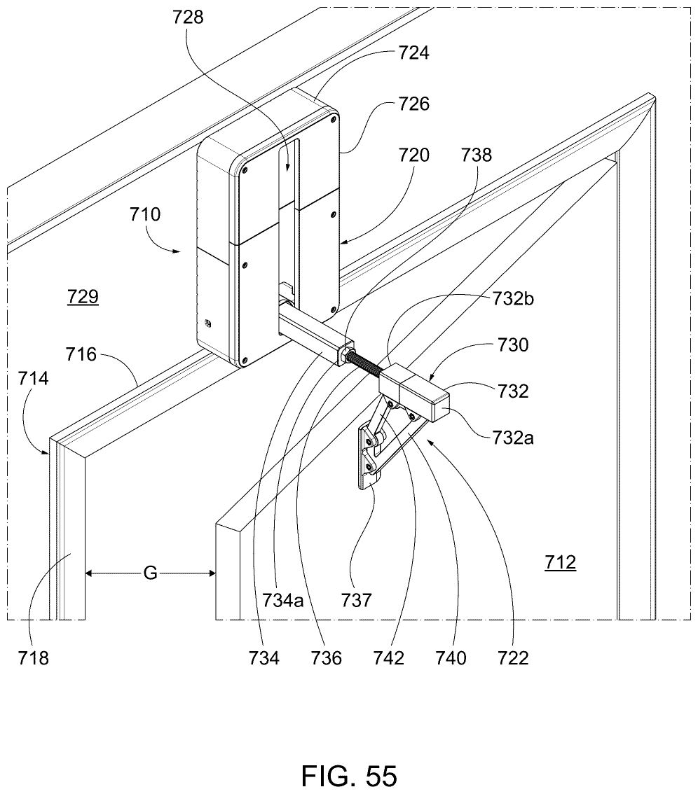

When a user wishes to open the door 712, he or she deploys activation means (not shown), which drives the stepper motor 750 and gears 748a, 748b to cause the pivot 746 to rotate the rod 730, and thereby the stopper arm assembly 722, away from the wall 729 and base 726, through the slot 728 in the cover 726 and downward approximately 90 degrees. This rotation moves the doorstop assembly 710 from its stowed position (shown in FIGS. 52 and 53) to its operational position (shown in FIGS. 54 and 55). At this point, the door-contacting pad 744 and door-contacting member 737 are brought into contact with an inner (i.e., inward-facing) surface of the top (i.e., upper) portion of the door 712 and thereby arrest movement of the door 712 after it has been partially opened to the position illustrated in FIGS. 54 and 55, creating a gap (G) between the door 712 and jamb 718. When the user wishes to close the door 712, the foregoing steps are performed in reverse order, to move doorstop assembly 710 from its operational position (as shown in FIGS. 54 and 55) to its stowed position (as shown in FIGS. 52 and 53).

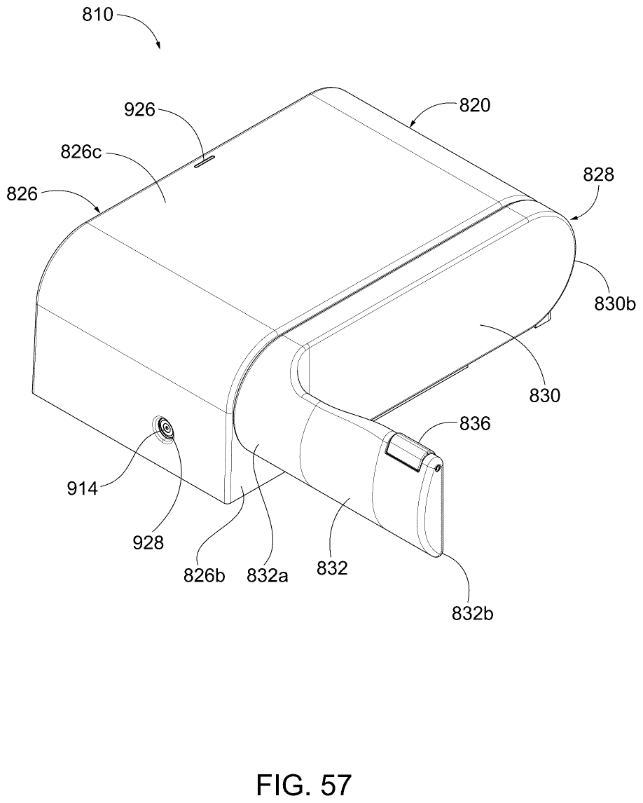

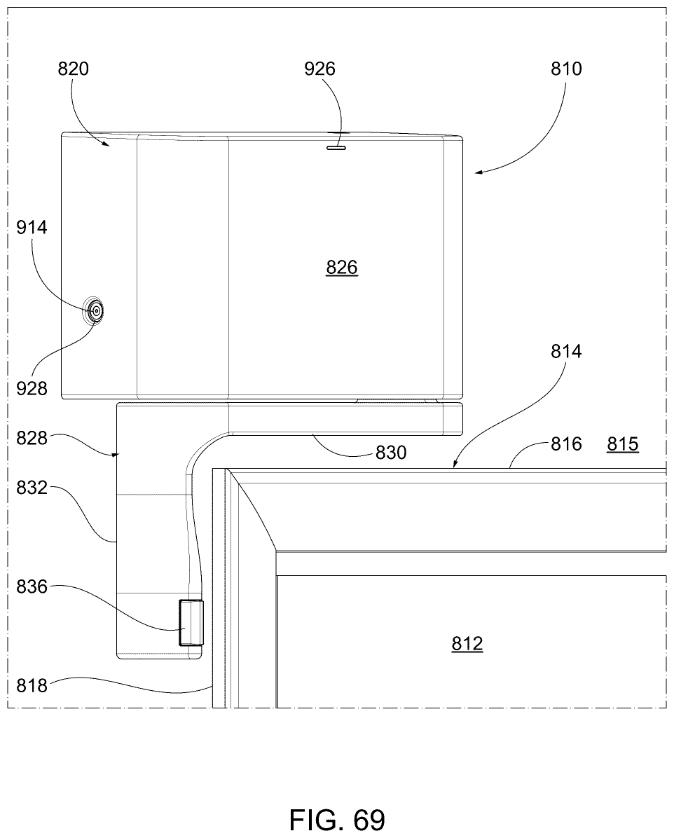

FIGS. 57-68 illustrate a doorstop assembly 810 and FIGS. 69-72 illustrate the doorstop assembly 810 in combination with an inward-opening door 812 and associated frame 814, including a header 816 and jamb 818.

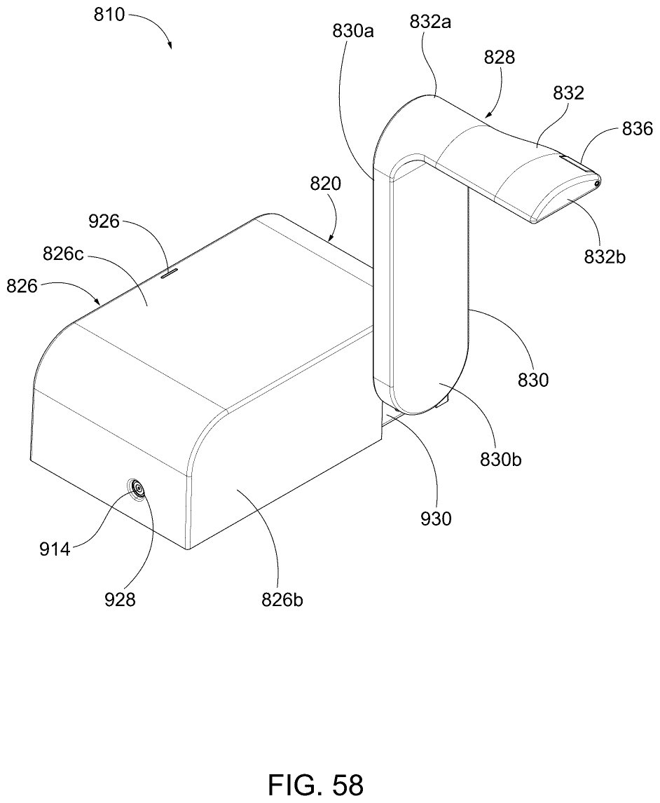

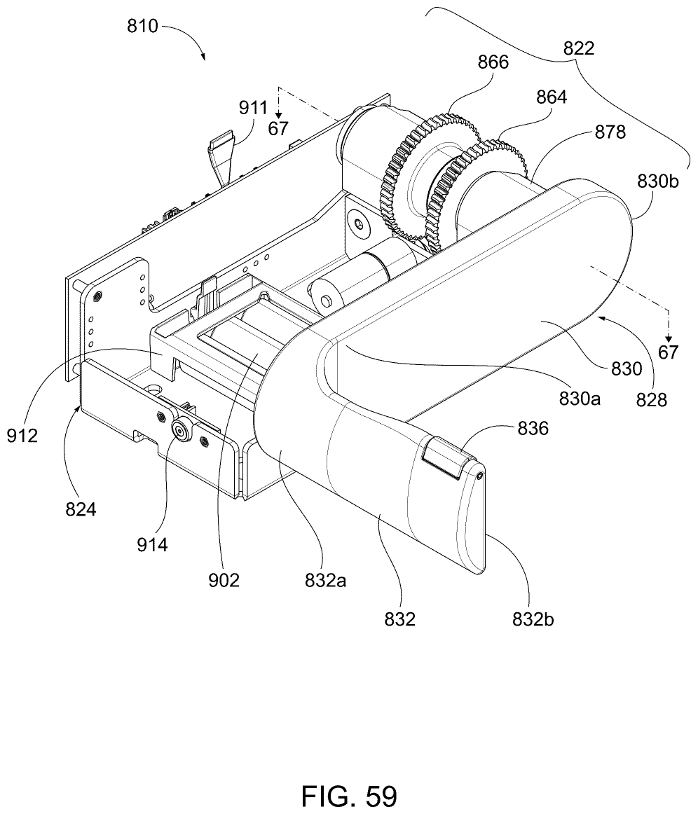

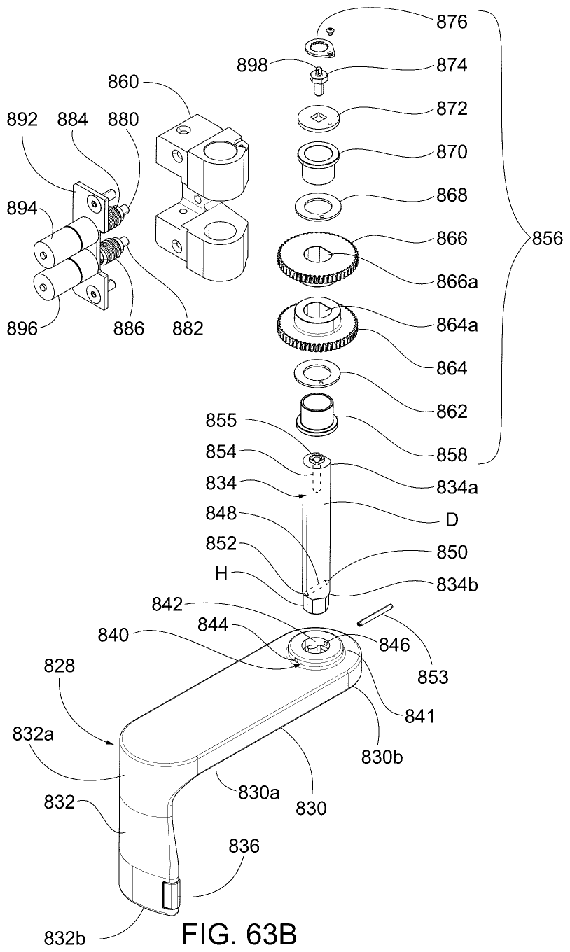

As shown in FIGS. 57-67, the doorstop assembly 810 includes a housing 820 and a stopper arm assembly 822 (see FIG. 63A). As further discussed below, the housing 820 includes a substantially rectangular prism (i.e., cuboid) base 824 configured to contain internal elements of the doorstop assembly 810 (see FIGS. 59-62 and 67) and a removable cover 826 configured to be secured to an open face (see FIGS. 57-58) of the base 824.

Referring now to FIGS. 59-62, the stopper arm assembly 822 includes an L-shaped arm member 828 having a first section 830 that extends along and generally parallel to the housing 820 and base 824 and a second section 832 that extends generally perpendicular to the first section 830 in a direction away from the housing 820 and base 824. The L-shaped arm member 828 is formed monolithically such that the first and second sections 830, 832 are continuous with each other. However, in alternate embodiments, the first and second sections 830, 832 may be formed as separate pieces and joined to each other. The first section 830 includes a first end 830a that is continuous with the second section 832, and a second end 830b opposite the first end 830a. The second end 830b is configured to receive and connect to a rotatable shaft 834 therein, as further discussed below.

The second section 832 of the L-shaped arm member 828 includes a first end 832a that is continuous with the first end 830a of the first section 830, and a second end 832b that is distal to the first section 830 and constitutes a free end. As illustrated in FIGS. 57-61, the second end 832b of the second section 832 includes a padding, or bumper member 836. The bumper member 836 is configured to contact a surface of the door 812 but is formed of a material that does not damage the door surface. In some embodiments, the material of the bumper member 836 includes a plastic material such as POM (Polyoxymethylene) acetal copolymer, also known as POM-C.

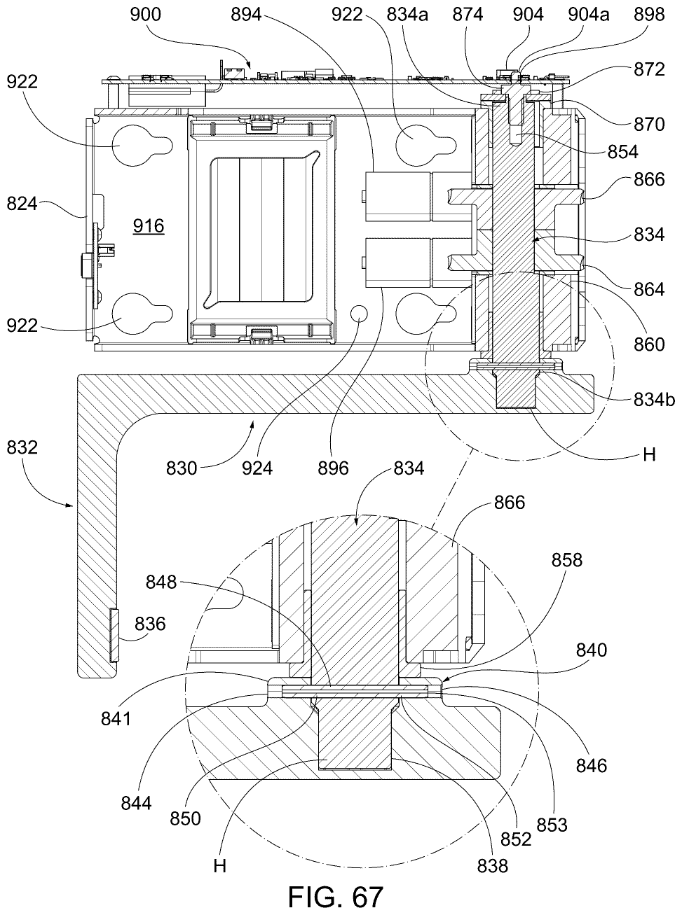

Reference is now made to FIGS. 59-62 and 67, wherein the cover 826 has been removed from the base 824 for illustrative purposes. The rotatable shaft 834 includes opposed first and second ends 834a, 834b (see FIG. 63B). The second end 830b of the first section 830 of the L-shaped arm member 828 defines a cavity 838 that is dimensioned to receive the second end 834b of the shaft 834, as illustrated in FIG. 67. A hex fitment 840 is provided on the second end 830b of the first section 830 of the L-shaped arm member 828, adjacent the cavity 838. The hex fitment 840 includes a sidewall 841 that defines an inner bore 842 which is arranged coaxially with the cavity 838. At least a portion of the second end 834b of the shaft 834 includes a hexagonal configuration/cross-section H such that it securely fits through the inner bore 842 and into the cavity 838, which is also provided with a hexagonal configuration.

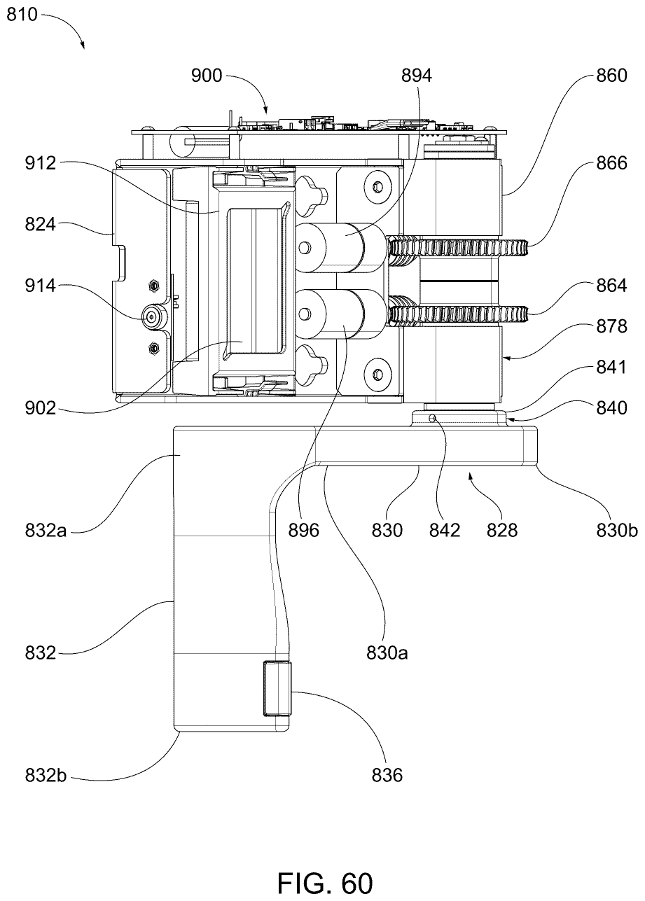

Reference is now made to FIGS. 60, 62, 63B and 67, which further illustrate the engagement between the second end 834b of the shaft 834 and the L-shaped arm member 828. The hex fitment sidewall 841 defines first and second apertures 844, 846 at opposite points on the sidewall 841. The second end 834b of the shaft 834 also defines a bore 848 extending between opposite points on the second end 834b, proximate (i.e., above) the hexagonal portion of the second end 834b. The bore 848 extends between first and second openings 850, 852 formed in the opposite points on the second end 834b, wherein the second end 834b is positionable within the hex fitment bore 842 so as to align the first and second openings 850, 852 of the bore 848 with the first and second apertures 844, 846 of the hex fitment sidewall 841. A pin 853 is provided for insertion through the first and second apertures 844, 846 of the hex fitment sidewall 841 and the bore 848 in the second end 834b of the shaft 834 (i.e., between the first and second openings 850, 852 in the second end 834b). The pin 853 retains the second end 834b of the shaft 834 within the hex fitment bore 842, and further within the cavity 838, which secures the shaft 834 to the first section 830 of the arm member 828.

With continued reference to FIGS. 63A, 63B and 67, the first end 834a of the shaft 834 includes a threaded closed bore 854 formed therein and a cojoining internally threaded protrusion 855, the purpose for which will be discussed below. The shaft 834 also has a D-shaped cross-section D that extends from its first end 834a to a point between the first and second ends, 834a, 834b, and preferably, from its first end 834a to a point between the second end 834b and a halfway point between the first and second ends, 834a, 834b. The purpose for this D-shaped cross section will be discussed below.

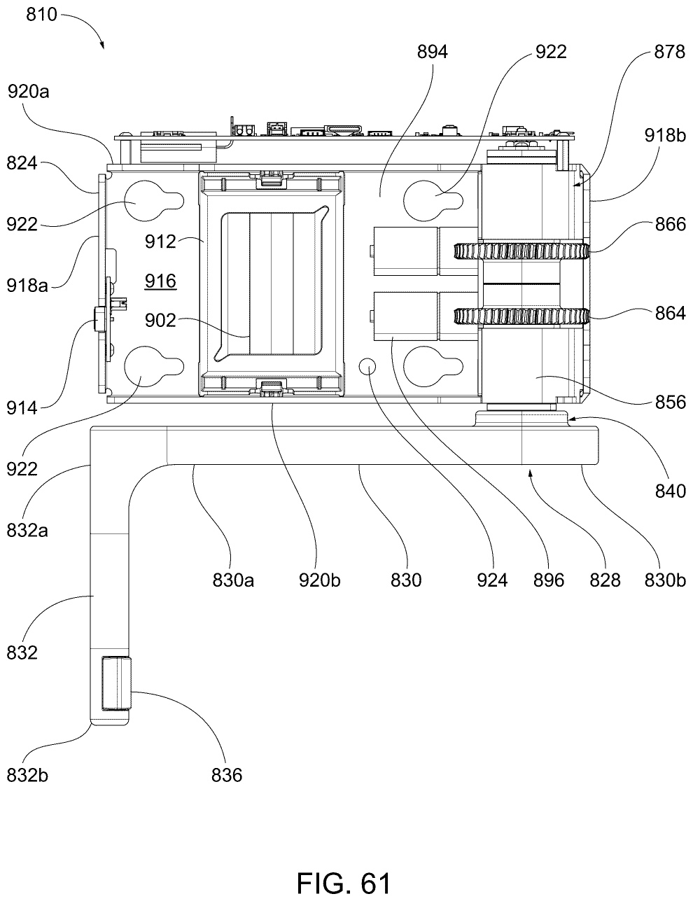

Reference is now made to FIGS. 61-63B, which illustrate a gear train bracket assembly 856. As further discussed below, components of the gear train bracket assembly 856 operatively connect the shaft 834 and arm member 828 to the housing 820 and facilitate the movement of the stopper arm assembly 822, and thereby the doorstop assembly 810, between different positions during deployment thereof.

With continued reference to FIGS. 63A, 63B and 67, the shaft 834 receives multiple components of the gear train bracket assembly 856 thereon. These components are discussed below, and include a first flanged bushing 858, a gear train bracket, or worm mount, 860, a first washer 862, first and second gear worm wheels 864, 866, a second washer 868, a second flanged bushing 870, a retention washer 872, a bolt 874 and a bolt head retainer 876.

With reference to FIGS. 63A, 63B, and 65-67, the gear train bracket 860 is configured to house the first and second gear worm wheels 864, 866 therein, and forms part of a motor/gear subassembly 878 (i.e., of the gear train bracket assembly 856) that is assembled and ultimately mounted on the shaft 834. The first gear worm wheel 864 includes a D-shaped opening 864a therethrough, and the second gear worm wheel 866 includes a D-shaped opening 866a therethrough (see FIG. 63B). The D-shaped openings 864a, 866a are configured to receive the D-shaped cross-section D of the shaft 834 therein and thereby secure the cross-section D of the shaft 834 therein. This arrangement immobilizes the shaft 834 within the motor/gear subassembly 878 to ensure that the shaft 834 rotates with the first and second gear worm wheels 864, 866 during operation of the doorstop assembly 810.

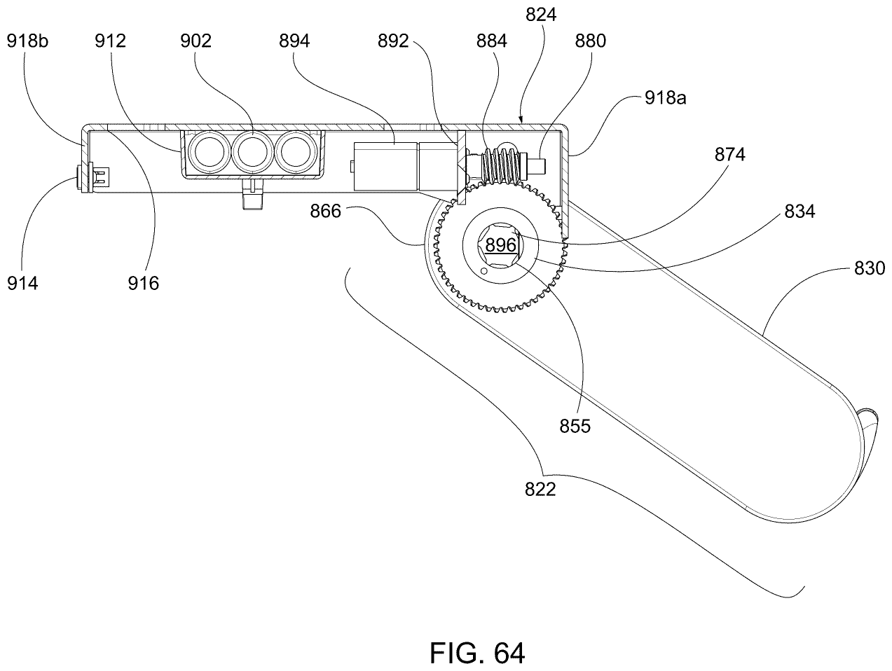

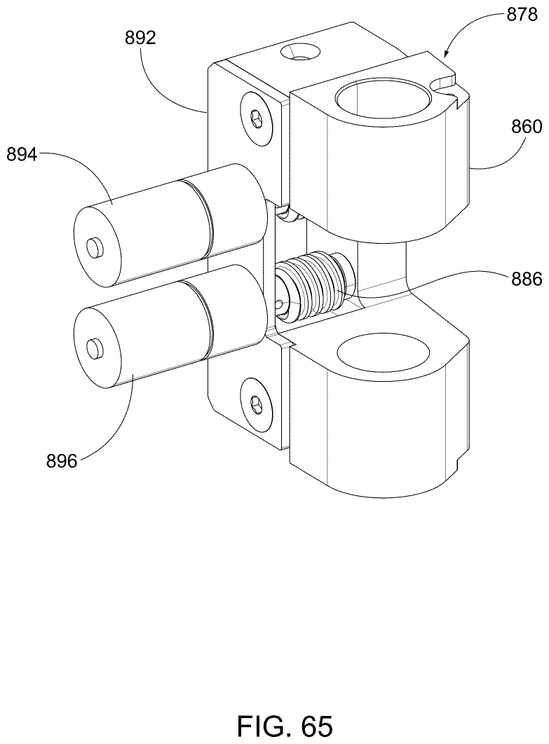

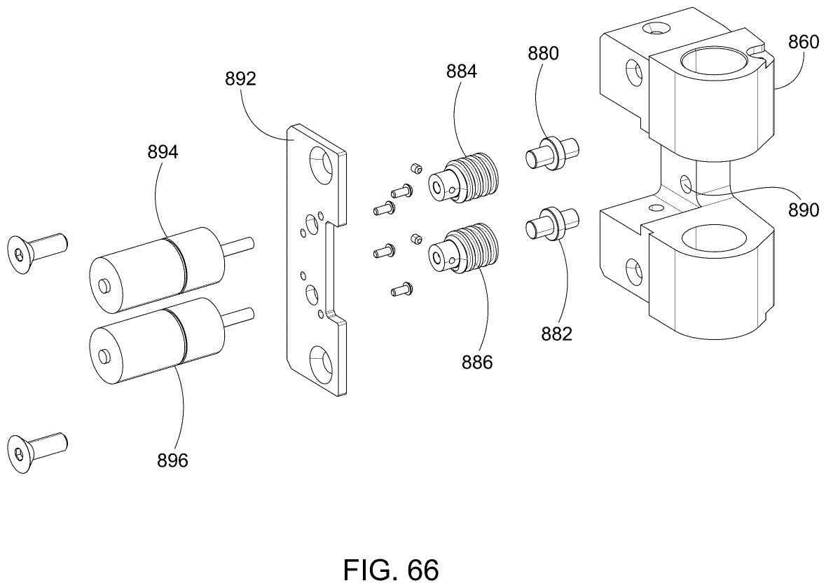

With reference to FIGS. 65 and 66, the motor/gear subassembly 878 further includes first and second thrust bushings 880, 882 and corresponding first and second worm shafts 884, 886 that receive the first and second thrust bushings 880, 882 therein (see FIG. 66). The gear train bracket 860 includes first and second openings 888, 890 (only 890 being visible) that are configured to receive the first thrust bushing 880 and the first worm shaft 884, and the second thrust bushing 882 and the second worm shaft 886 therein, respectively. A motor mounting plate 892 is configured to engage the first and second worm shafts 884, 886 and operatively connect the first and second worm shafts 884, 886 to first and second gear drive motors 894, 896 (see FIGS. 64-66).

As a result of having two gear worm wheels (i.e., first and second gear worm wheels 864, 866) and two gear drive motors (i.e., first and second gear drive motors 894, 896), the doorstop assembly 810 is adapted to provide a greater resistance to striking force (i.e., from a potential intruder's attempted breach/forced entry of the door 812/doorstop assembly 810) than a security system/doorstop assembly having only one gear worm wheel and gear drive motor. To demonstrate and quantify this enhanced resistance, the doorstop assembly 810 was tested against a “control” doorstop assembly having only one drive motor and gear worm wheel, as described below.

The testing apparatus involved the use of a doorframe being arranged parallel to a horizontal surface and having an attached swingable door. The doorframe was provided with 12″ legs to allow the door to swing downward (i.e., towards the horizontal surface). First, a control doorstop assembly having a single drive motor and single gear worm wheel was constructed and installed on the underside of the doorframe. The control doorstop assembly was arranged to be in a passthrough position, with its arm member positioned such that the second section thereof was in contact with the door. Downward force was incrementally then applied to the door by having engineers stand on same. At 500 pounds of force, the gear jammed in the single gear worm wheel, which fused the single motor and caused the control doorstop assembly to fail (see Table 1 below). Next, the doorstop assembly 810 described herein (with two gear worm wheels (i.e., first and second gear worm wheels 864, 866) and two gear drive motors (i.e., first and second gear drive motors 894, 896)) was installed on the underside of the doorframe and arranged to be in its passthrough position, with its arm member positioned such that the second section thereof was in contact with the door. Downward force was incrementally then applied to the door by having the engineers stand on same. About 1,000 pounds of force was required to jam one of the two gear worm wheels, which fused the corresponding motor and caused the doorstop assembly 810 to fail (see Table 1 below). This testing demonstrated that the doorstop assembly 810 resisted up to double the amount of force as the control unit having a single motor and gear, and the advantages provided by the double gear worm wheel/gear drive motors design of the doorstop assembly 810.

TABLE 1

| Force Applied | One Motor & Gear | Two Motor & Gears |
|---|---|---|
| 500 lbs | Failed | Passed |
| 1,000 lbs | Failed | Passed |

With continued reference to FIGS. 63B and 67, the internally threaded protrusion 855 extending from the first end 834a of the shaft 834 receives the retention washer 872 thereon. The bolt 874 is then threadably secured into the internally threaded protrusion 855 and threaded closed bore 854 formed in the first end 834a of the shaft 834. The bolt 874 includes a head 898 having a D-shaped cross-section, for reasons discussed below. The bolt head retainer 876 is then mounted on the retention washer 872 (e.g., with a screw, pin or other fastening means) so as to circumferentially engage the head 898 of the bolt 874. The bolt head retainer 876 is configured to lock the bolt 874 into place on the retention washer 872 and prevent rotation of the bolt 874 and the shaft 834, as further discussed below.

With continued reference to FIGS. 61-63B, the gear train bracket assembly 856 and shaft 834 are housed within the base 824 of the housing 820. The base 824 also contains other elements for operation of the doorstop assembly 810, including a circuit board (i.e., a printed circuit board assembly, or PCBA) 900 and a battery 902. These elements are further discussed below.

With continued reference to FIGS. 63A, 67 and 68, the circuit board 900 is configured to receive and send data between other components of the doorstop assembly 810, and thereby facilitate the operation and control of the stopper arm assembly 822. More particularly, the circuit board 900 includes a potentiometer 904 that is configured as a rotary sensor (i.e., a rotatory potentiometer) and a microcontroller 906 that is operatively connected to the potentiometer 904, as further discussed below. The potentiometer 904 includes a D-shaped opening 904a that is configured to receive the D-shaped head 898 of the bolt 874 extending from the first end 834a of the shaft 834, as described above. This interconnection of the potentiometer 904 and the bolt 874/shaft 834 enables the potentiometer 904 to determine the position of the arm assembly 822, and more specifically, the L-shaped arm member 828, and provide such position information to the microcontroller 906. The microcontroller 906 reads and measures the variable voltage output of the potentiometer 904 to determine the angle at which the L-shaped arm member 828 is positioned in relation to the housing 820 and, if desired/warranted, facilitate movement of the L-shaped arm member 828 to a different position via input to the first and second gear drive motors 894, 896.

In some embodiments, the circuit board 900 also includes an accelerometer 908 operatively connected to the microcontroller 906 and a siren/speaker 910 operatively connected to the accelerometer 908. When the doorstop assembly 810 is subjected to a certain magnitude of force (i.e., from a potential intruder's attempted breach/forced entry of the door 812/doorstop assembly 810), the accelerometer 908 detects the acceleration of the force, and at a predetermined value, is configured to activate/trigger the siren/speaker 910.

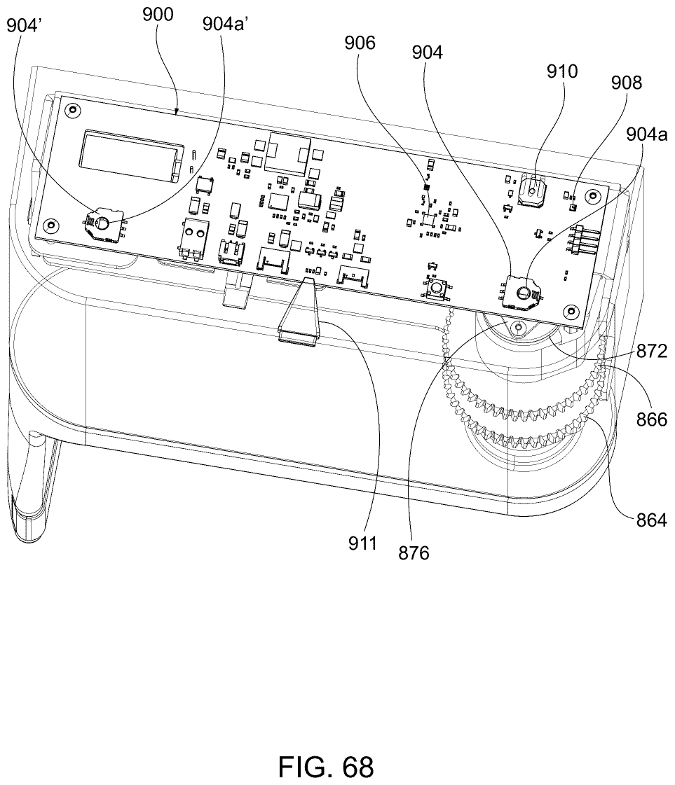

In some embodiments, the circuit board 900 is provided with an illuminating indicator 911. In one such embodiment, the circuit board 900 includes an LED and the illuminating indicator 911 comprises a light pipe that conveys light from the LED (see FIGS. 59 and 68). The illuminating indicator 911 may be used to signal various events, such as charging status, battery level/status, siren/speaker activation, device pairing status, a potential intruder's forced entry and receiving signals from a remote actuator or other activation means.

Referring now to FIGS. 61, 62 and 67, the battery 902 is provided in the base 824 of the housing 820 and operatively connected to the first and second gear drive motors 894, 896 so as to actuate the movement of the drive motors. In some embodiments, the battery 902 is replaceable and/or hot swappable. In some embodiments, the battery 902 is hardwired. In some embodiments, the battery 902 is contained in a battery holder 912, which is configured to be secured within the base 824 of the housing 820. In some embodiments, audio and/or visual signals are provided when the battery 902 is running low on power and/or requires replacement (i.e., with a new battery). In some embodiments, doorstop assembly 810 is configured to move to the stowed position upon loss of battery power (e.g., when less than 5% of the battery power remains).

The doorstop assembly 810 further includes a charger 914 for charging the battery 902 (see FIGS. 59-61, 63A and 64). In some embodiments, the charger 914 is a circuit board (i.e., PCBA) charge port. In some embodiments, the charger 914 communicates with the microcontroller 906 of the main circuit board 900, providing battery data to the microcontroller 906, so as to prevent overcharging the battery 902. The charger 914 is configured to be secured within the base 824 of the housing 820. When charging is required, the charger 914 is connected to an appropriate power source via a pluggable cord or the like (not shown).

The base 824 of the housing 820 is configured to receive and secure the shaft 834 and gear train bracket assembly 856 within the housing 820. As illustrated in FIGS. 61, 62, 63A and 67, the base 824 includes a substantially rectangular wall plate 916, adjoining short sidewalls 918a, 918b that extend perpendicular to the wall plate 916, and adjoining long sidewalls 920a, 920b that extend perpendicular to the wall plate 916 and extend between the adjoining short sidewalls 918a, 918b. The wall plate 916 defines a plurality of mounting keyholes 922 that receive a fastener (i.e., a screw, nail, pin, etc.) therethrough and thereby enable a user to secure the wall plate 916 (and the housing 820) to the wall 815 above the door frame header 816. In addition to the mounting keyholes 922, the wall plate 916 also defines one or more openings 924 for receiving a fastener (i.e., a screw, nail, pin, etc.) by which the wall plate 916 (and the housing 820) is further secured to the header 816. While the wall plate 916 of the illustrated embodiment includes four mounting keyholes 922 and one fastener opening 924, in other embodiments of the doorstop assembly 810, the wall plate 916 may include other numbers of mounting keyholes 922 and fastener openings 924. Alternatively, the wall plate 916 may only include mounting keyholes 922 and not include any fastener openings 924.

The gear train bracket assembly 856 is secured to the wall plate 916 using various combinations of cooperating openings/apertures and fasteners. As a non-limiting example, the gear train bracket 860 of the gear train bracket assembly 856 may have a plurality of apertures defined therein, and appropriately-dimensioned fasteners (i.e., screws, nails, pins, etc.) that insertably engage the apertures and corresponding apertures formed in the wall plate 916, whereby the gear train bracket assembly 856 may be secured to the wall plate 916. In an exemplary embodiment, the gear train bracket 860 has six apertures for receiving the fasteners, and the wall plate 916 has six corresponding apertures.

Upon securing the assembled gear train bracket assembly 856 to the wall plate 916, the shaft 834 is also secured to the wall plate 916. After the gear train bracket assembly 856 and the shaft 834 are secured to the wall plate 916, i.e., within the base 824, the cover 826 may be attached to the base 824 to enclose the gear train bracket assembly 856, shaft 834, circuit board 900 and other components within the housing 820.

With reference to FIGS. 57, 58 and 63A, the cover 826 is configured to removably engage the base 824 of the housing 820. The cover 826 has a top portion 826a, a bottom portion 826b, and a sidewall 826c that extends between the top and bottom portions 826a, 826b. The cover 826 and base 824 include complimentary attachment features (not shown), such as interlocking tabs and slots. In some embodiments, the cover 826 may include sound-dampening and/or soundproofing means, such as an insert and/or lining that is made from foam or another sound-dampening material in order to eliminate or reduce the sound of the first and second gear drive motors 894, 896 during operation.

With continued reference to FIGS. 57, 58 and 63A, the cover 826 further includes an elongated opening 926 proximate the top portion 826a, a charger port 928 formed in the sidewall 826c, and a cutout 930 formed in the bottom portion 826c. The elongated opening 926 is dimensioned to receive a portion of the light pipe of the illuminating indicator 911, thereby enabling light from the LED connected to the light pipe to be visible to a user (i.e., through the elongated opening 926).

The cutout 930 is configured to receive the second end 834b of the shaft 834 therethrough, whereby the second end 834b connects to the second end 830b of the second section 830 of the arm member 828 (see FIG. 58). In the illustrated embodiment, the cutout 930 is generally D-shaped, or otherwise at least partially rounded, to provide clearance for the rotation of the second end 834b of the shaft 834 and the arm member 828 during operation of the doorstop assembly 810.

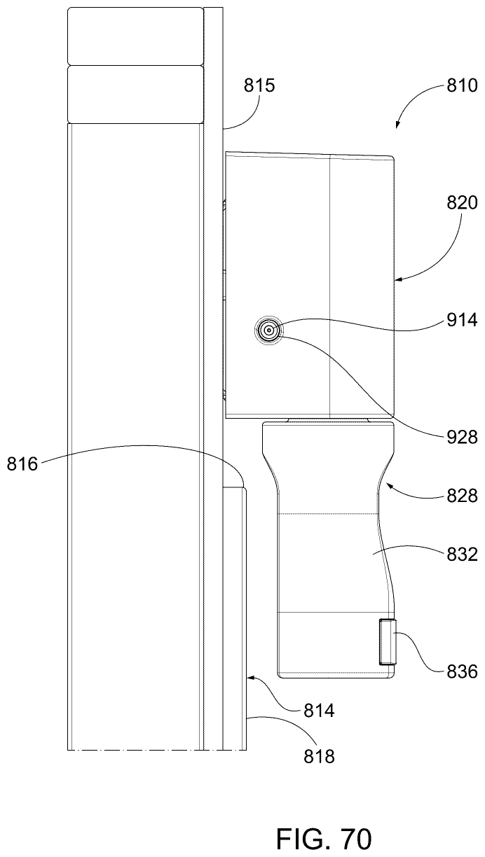

The operation of the doorstop assembly 810 will now be described, with reference to FIGS. 69-21. The doorstop assembly 810 is installed by attaching the housing 820 to the wall 815 at a location proximate/above the doorframe header 816. As shown in FIGS. 69 and 70, the doorstop assembly 810 is in its stowed position when the door 812 is closed.

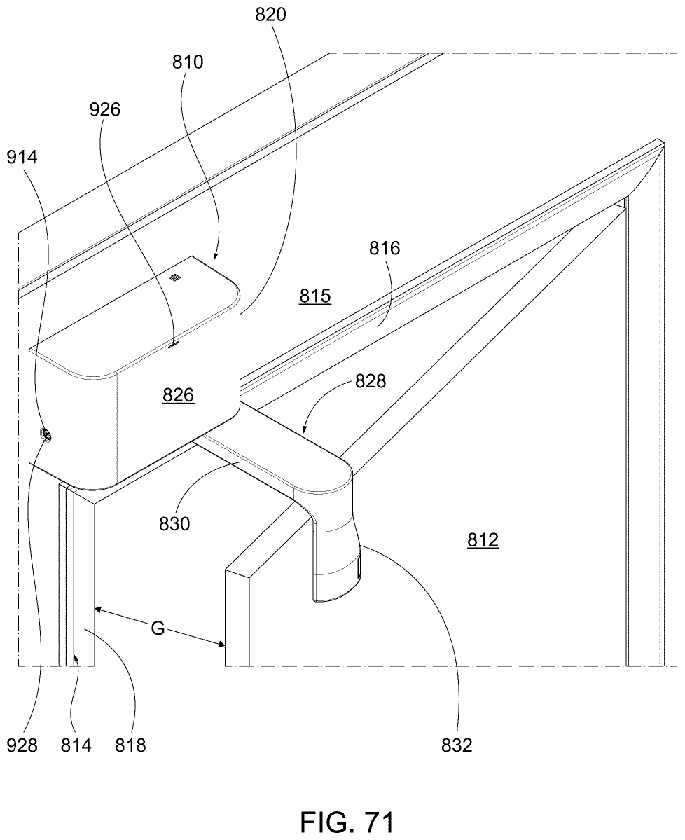

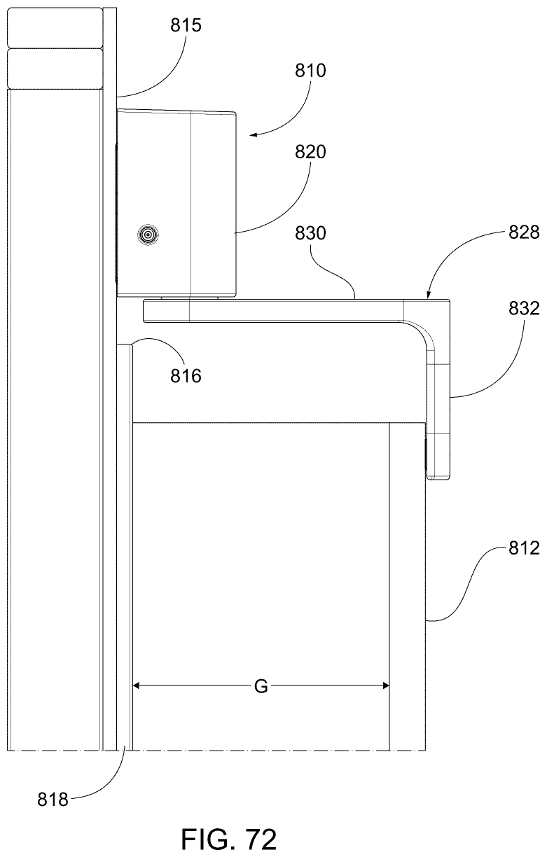

During or following manufacture of the doorstop assembly 810, the microcontroller 906 thereof is programmed to set an angle to which the L-shaped arm member 828 may be rotated to (i.e., an angle formed between the L-shaped arm member 828 and the housing 820), which determines how far the door 812 may be opened (hereinafter the operation, or “passthrough” position, as illustrated in FIGS. 71 and 72). In a preferred embodiment, this default angle is 90 degrees (see FIGS. 71 and 72). However, a user may adjust this angle based on a desired distance relating to how far his or her door 812 is to be opened.

When a user wishes to open the door 812, he or she moves the doorstop assembly 810 from its stowed position (shown in FIGS. 69 and 70) to its operational, or passthrough, position (shown in FIGS. 71 and 72) by deploying activation means (not shown), which drives the first and second gear drive motors 894, 896. The first and second gear drive motors 894, 896 thereby rotate the first and second worm shafts 884, 886, which rotation causes the first and second gear worm wheels 864, 866 to rotate and thereby rotate the shaft 834. Given the secure connection of the second end 834b of the shaft 834 to the second section 832 of the L-shaped arm member 828, such rotation of the shaft 834 causes the L-shaped arm member 828 to rotate as well.

At this point, the bumper member 836 is brought into contact with an inner (i.e., inward-facing) surface of the top (i.e., upper) portion of the door 812 and thereby arrests movement of the door 812 after it has been partially opened to the position illustrated in FIGS. 71 and 72, creating a gap (G) between the door 812 and jamb 818. When the user wishes to close the door 812, the foregoing steps are performed in reverse order, to move doorstop assembly 810 from its passthrough position (as shown in FIGS. 71 and 72) to its stowed position (as shown in FIGS. 69 and 70).

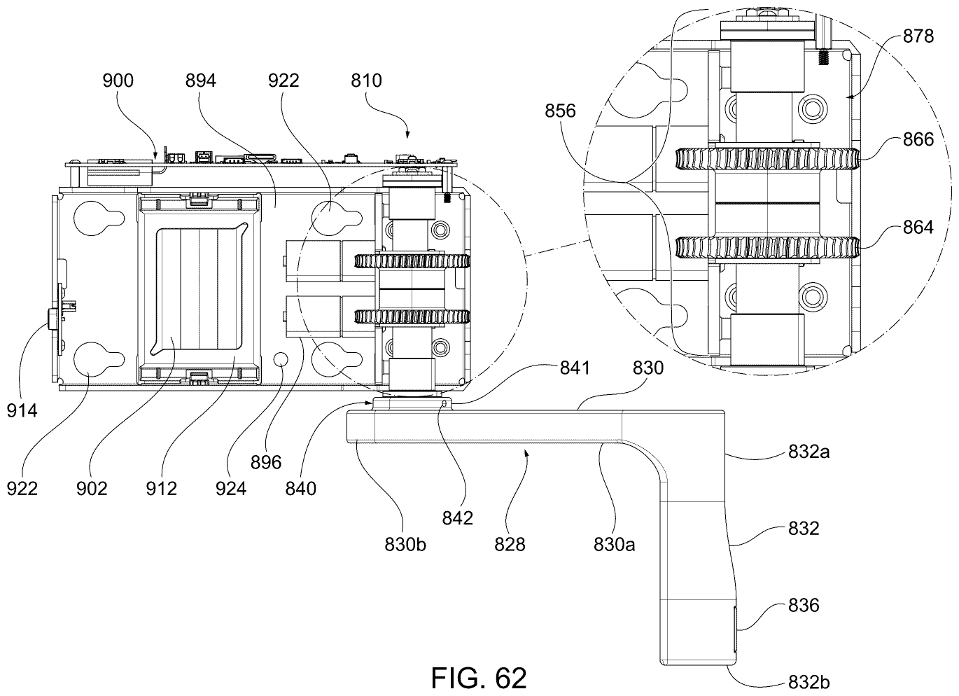

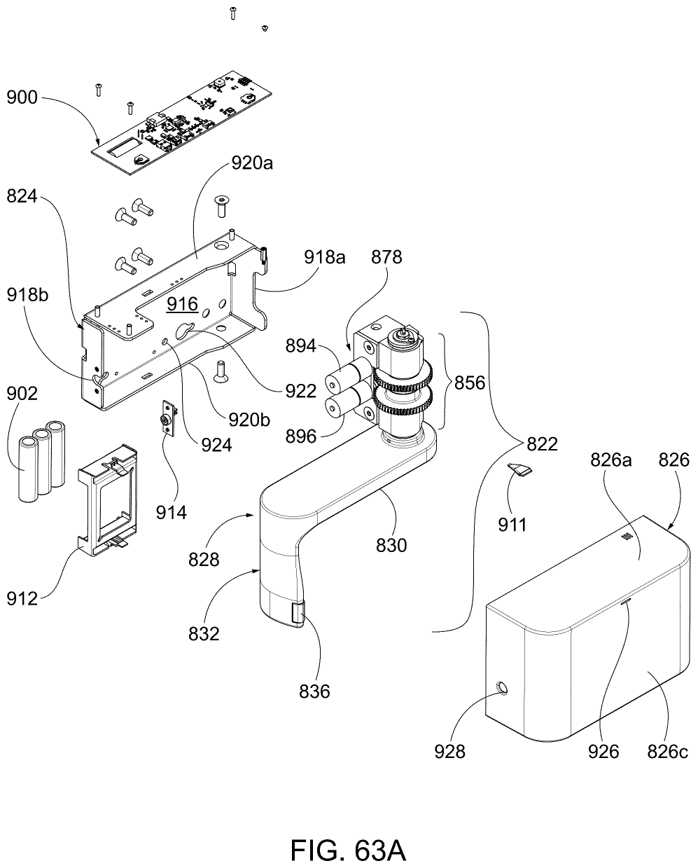

The user may also use the doorstop assembly 810 to secure the door 812 in a closed position, thereby enabling the doorstop assembly 810 to function as a deadbolt lock. This configuration is illustrated in FIG. 62 and involves the user moving the doorstop assembly 810 from its stowed position to its passthrough position, past its passthrough position (as illustrated in FIG. 64), and ultimately to its deadbolt position, where the L-shaped arm member 828 forms an angle of about 180 degrees with the housing 820. In this position, the L-shaped arm member 828 maintains the door 812 in its closed position, whereby the doorstop assembly 810 prevents a potential intruder from opening the door 812.

The doorstop assembly 810 is configured to be securely retained in its stowed, passthrough and deadbolt positions by way of the first and second gear worm wheels 864, 866 interlocking with the second and first worm shafts 886, 884, respectively, to prevent any back drive motion of the first and second gear worm wheels 864, 866. Accordingly, a potential intruder would be unable to manually force the doorstop assembly 810 (i.e., the L-shaped arm member 828 thereof) out of its passthrough or deadbolt positions to overcome the door-securing protection provided by the doorstop assembly 810. This feature is particularly useful in instances where the accelerometer 908 detects the acceleration of a potential intruder's forced entry and the siren/speaker 910 is activated/triggered, and where the doorstop assembly 810 is securely retained in its passthrough or deadbolt positions. This feature is also particularly useful in instances where a “panic button” of the doorstop assembly 810 is activated/triggered (see below), and where the doorstop assembly 810 is securely retained in its passthrough or deadbolt positions.

In some embodiments, the doorstop assembly 810 is configured to move from its passthrough position to its deadbolt position in response to a specific event (e.g., such as siren/speaker activation, a potential intruder's forced entry and receiving signals from a remote actuator or other activation means) to close the door and function as a deadbolt lock to increase security. The deadbolt position of the doorstop assembly 810 is shown in FIG. 62.

In some embodiments, the doorstop assembly 810 is configured to communicate with an external hub, for the purpose of relaying information back and forth, and ultimately to facilitate remote operation of the doorstop assembly 810. Means for remote operation may include, for example, a software application (“app”) on the user's mobile phone. The external hub can also provide means for relaying information from the doorstop assembly 810 to law enforcement agencies and/or private security companies.

The doorstop assembly 810 includes/incorporates various emergency escape modes by which a user may disable/disarm the doorstop assembly 810 in order to escape from a building in which a hazardous condition/event (e.g., a fire) is occurring. One such escape mode involves removing the pin 853 that secures the second end 834b of the shaft 834 within the hex fitment bore 842, which secures the shaft 834 to the second section 832 of the arm member 828. Once the pin 853 is removed, the arm member 828 disengages from the shaft 834, which detaches the stopper arm assembly 822 from the housing 820, and thereby removes the arm member 828 from the doorstop assembly 810 and unblocks the door 812 to allow the user to open the door 812 and escape the building in which a hazardous condition/event (e.g., a fire) is occurring.

Another escape mode involves the expedited removal of the doorstop assembly 810 from the doorway header 816, so as to unblock the door 812. More particularly, the fastener(s) may be removed from the opening(s) 924 in the wall plate 916 to partially disengage the wall plate 916 from the wall 815 (i.e., proximate the door frame header 816). The wall plate 916 may then be moved sideways to disengage the fasteners from the smaller portion of the mounting keyholes 922 formed in the wall plate 916 to the larger portion of the mounting keyholes 922, which releases the fasteners and thereby enables the wall plate 916 (and entire doorstop assembly 810) to be removed from wall 815 proximate the header 816 (i.e., above the door 812). Such removal of the doorstop assembly 810 unblocks the door 812 to allow the user to open the door 812 and escape the building in which a hazardous condition/event (e.g., a fire) is occurring.

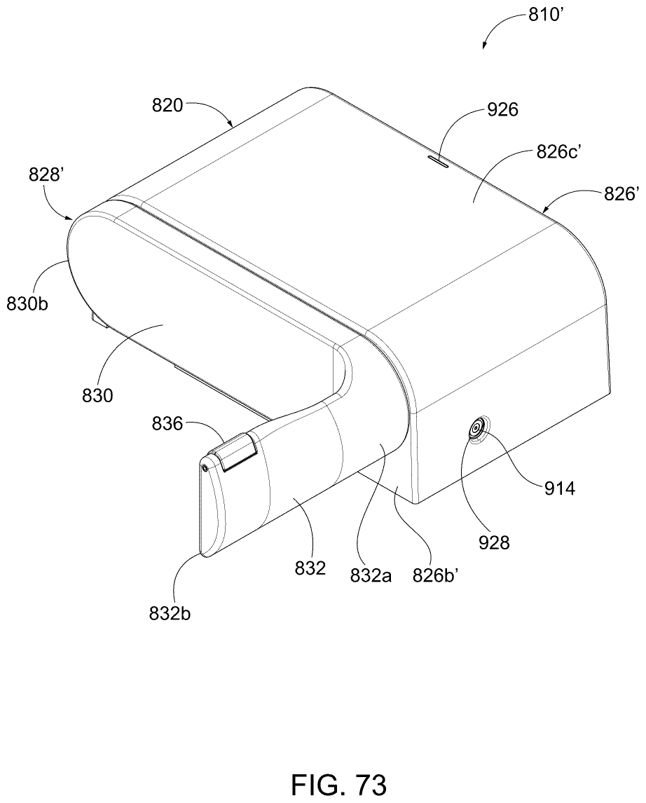

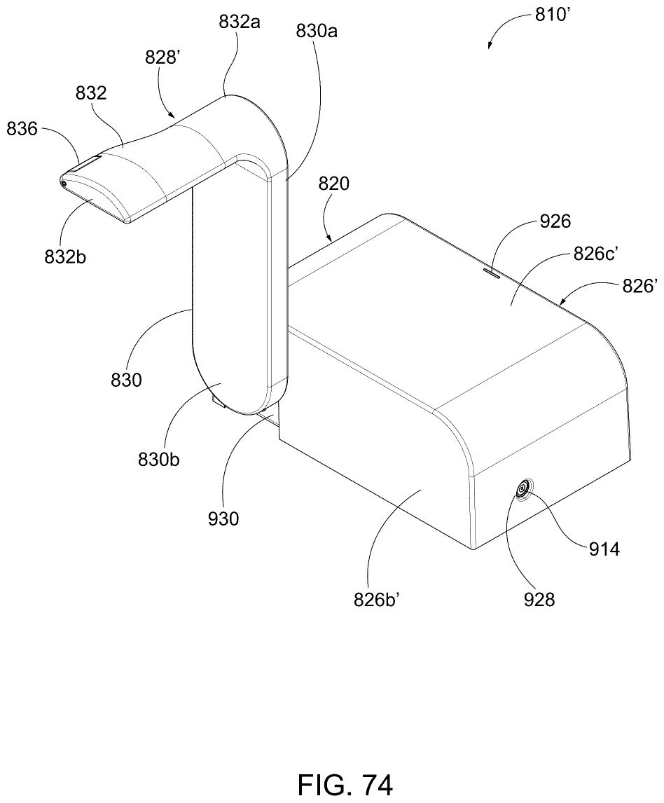

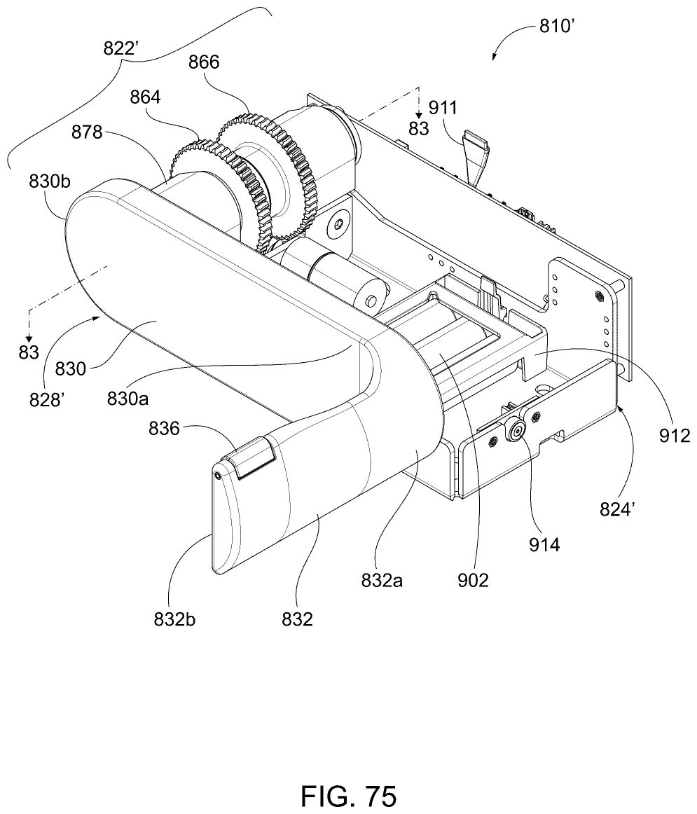

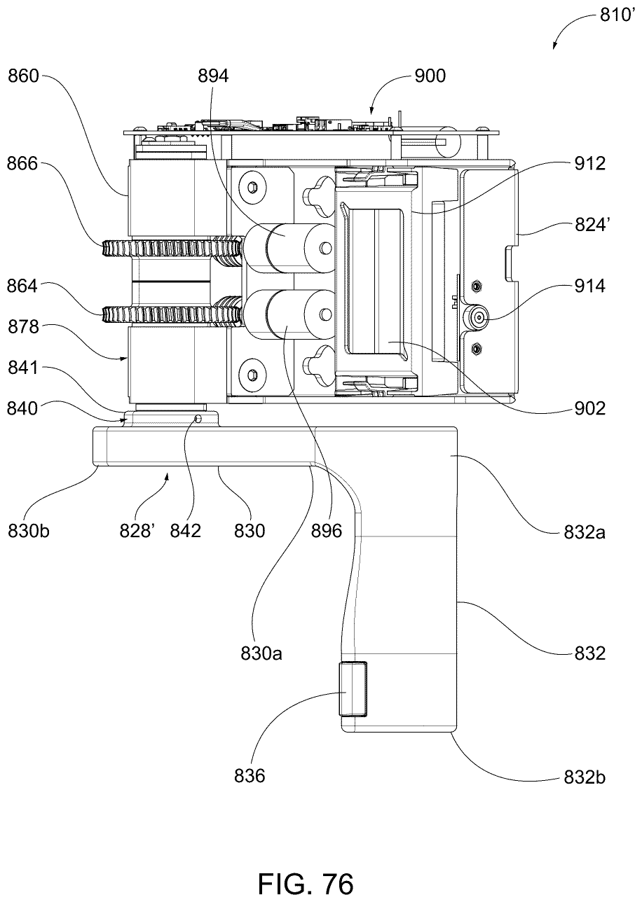

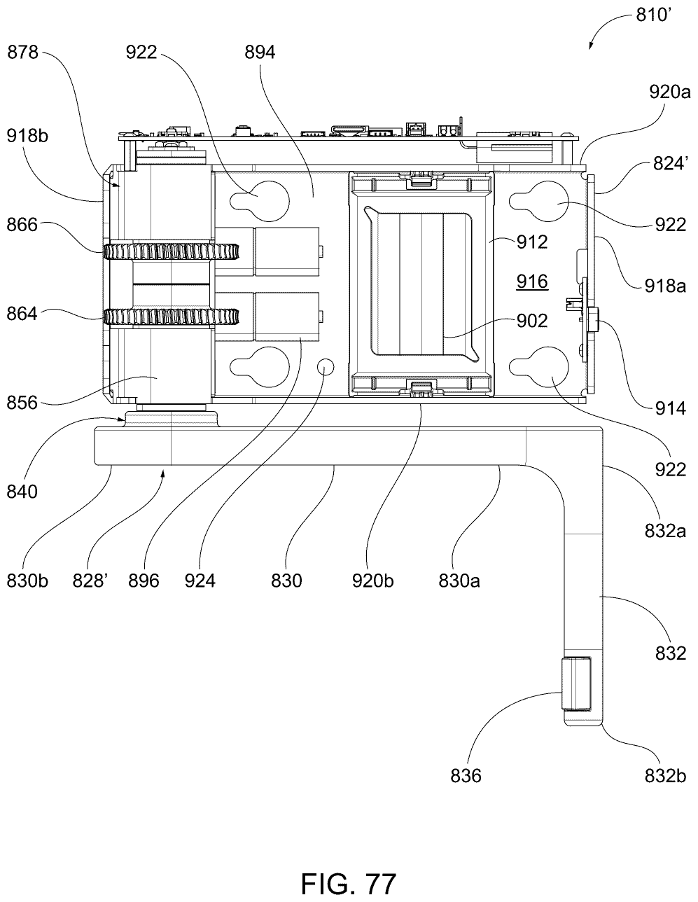

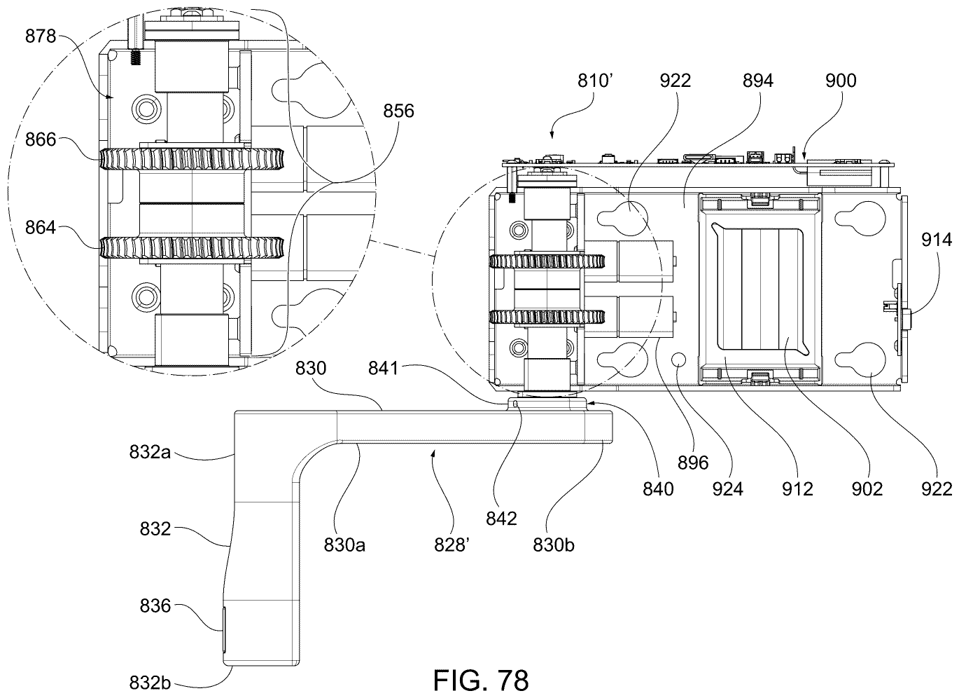

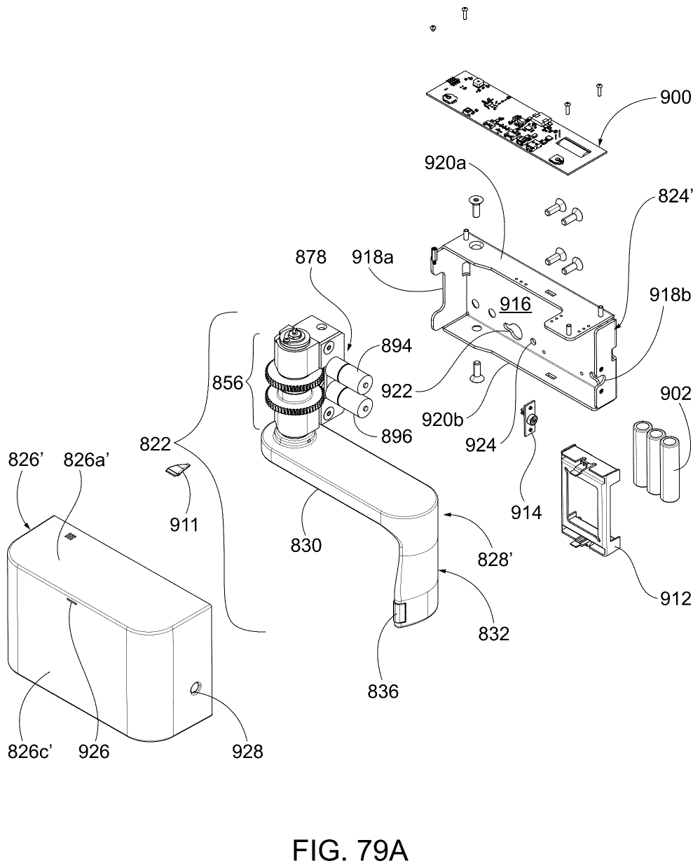

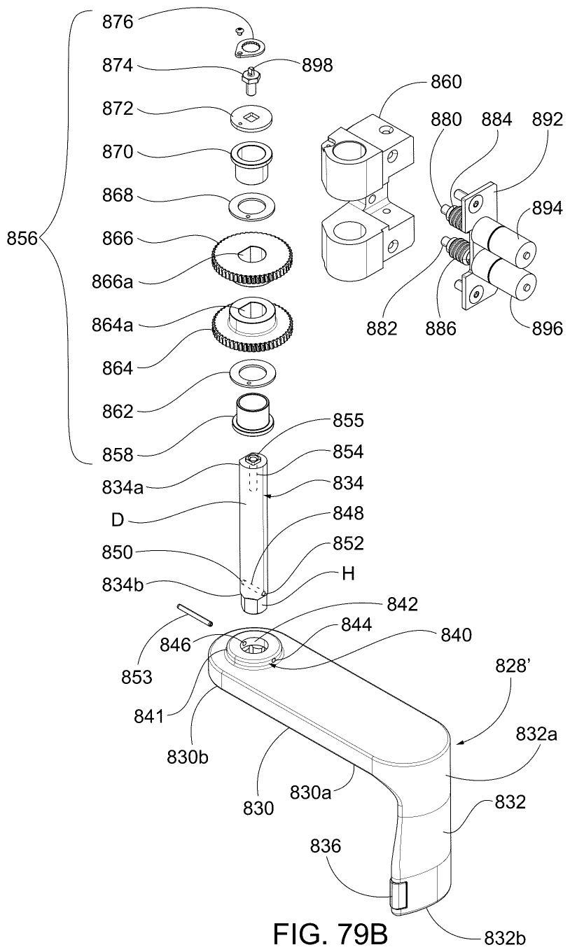

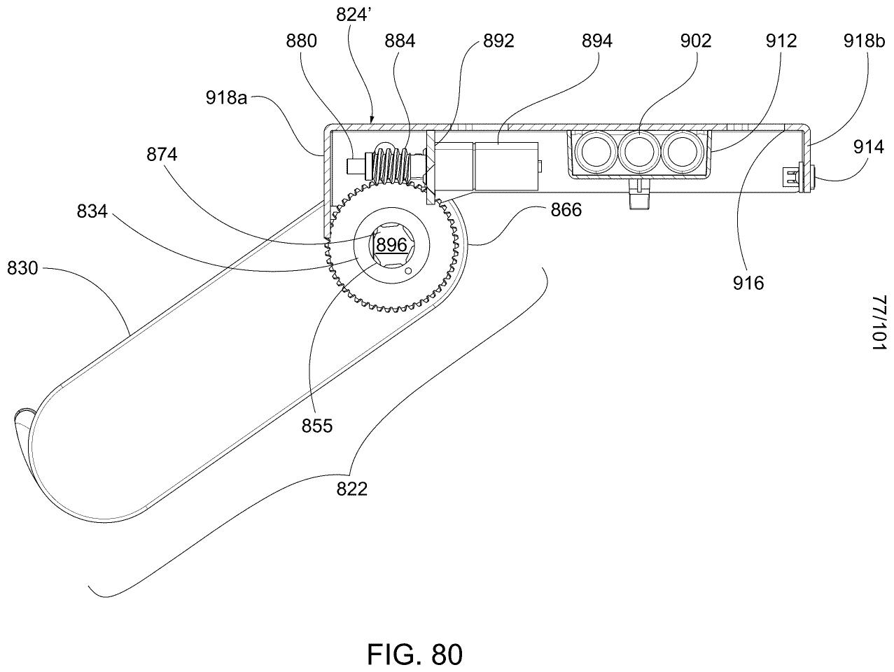

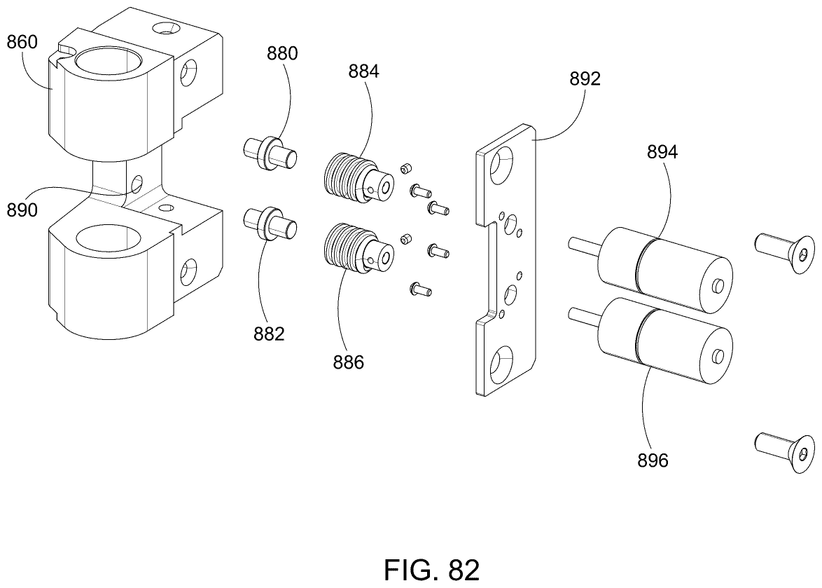

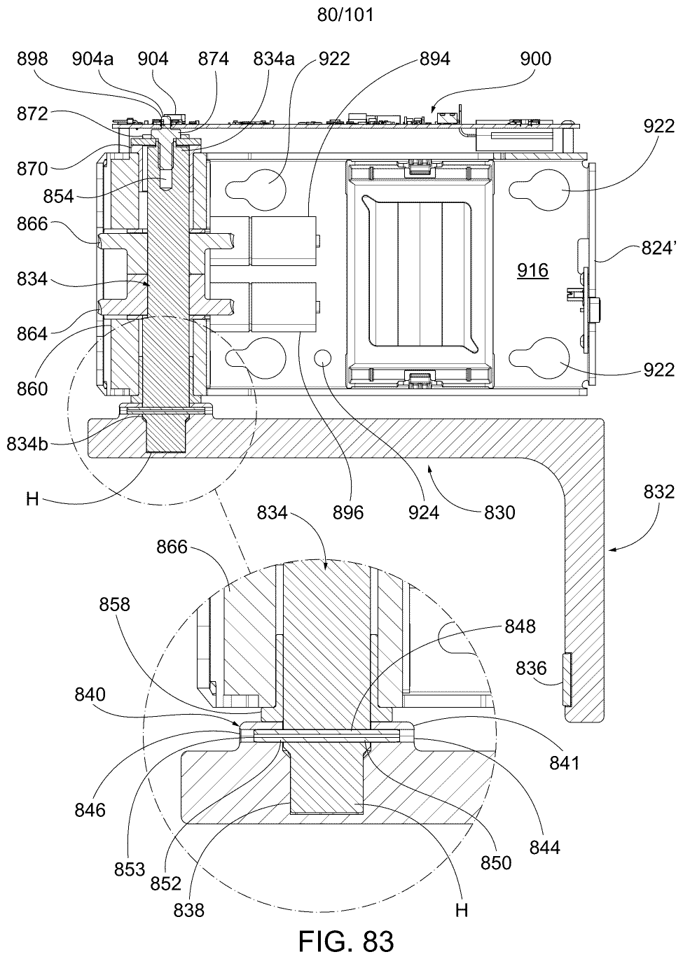

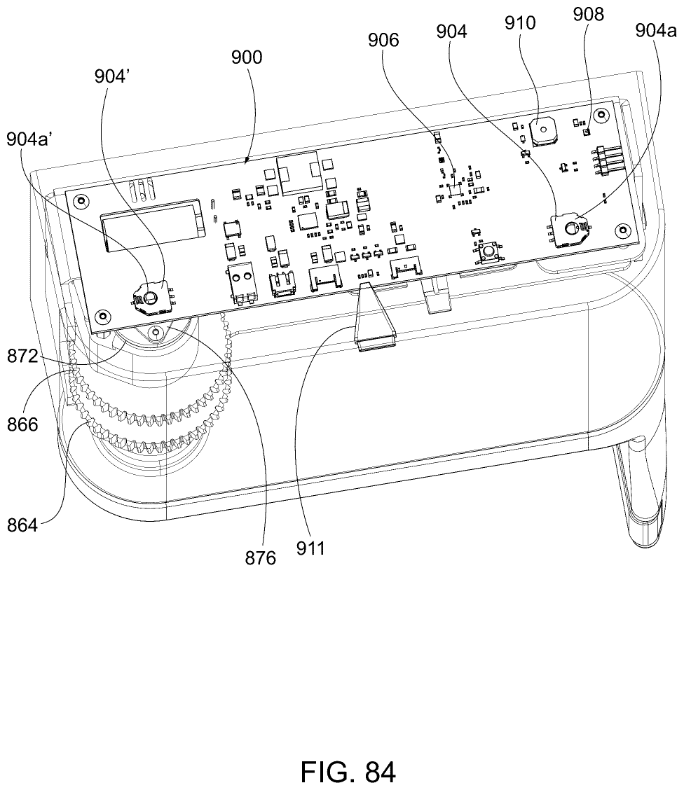

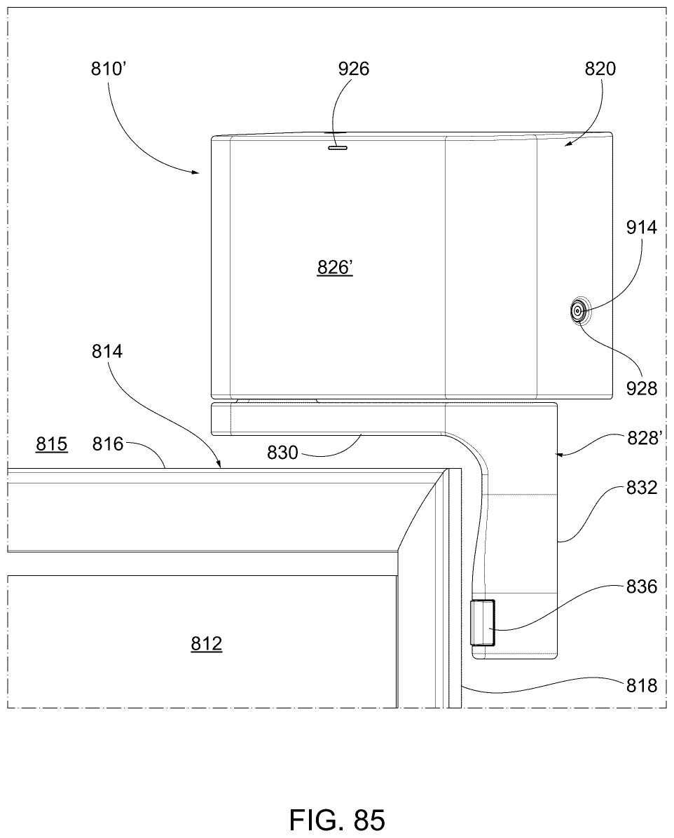

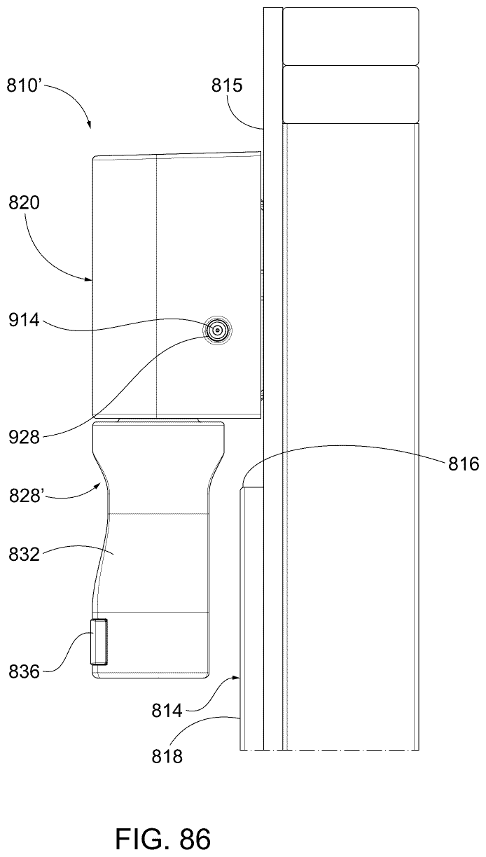

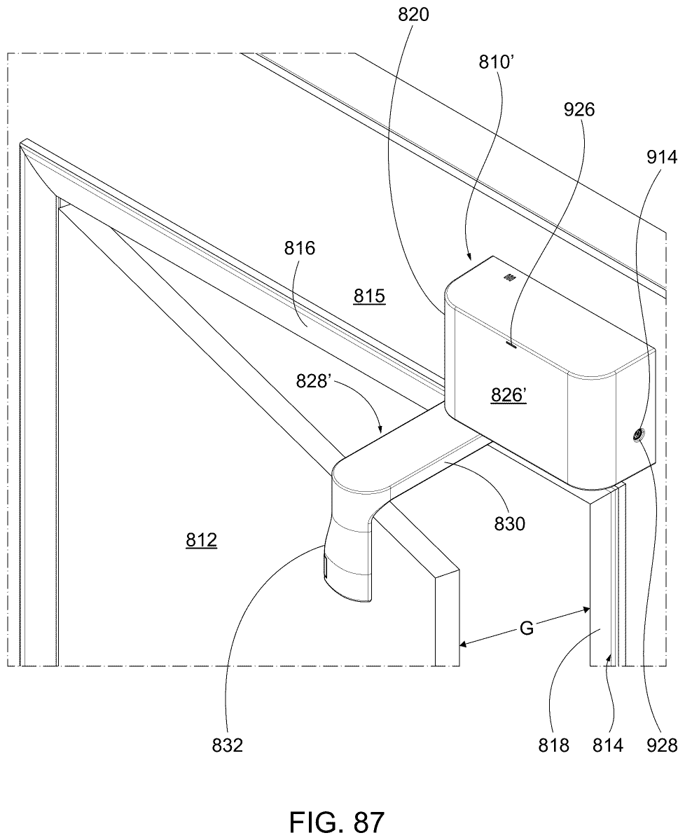

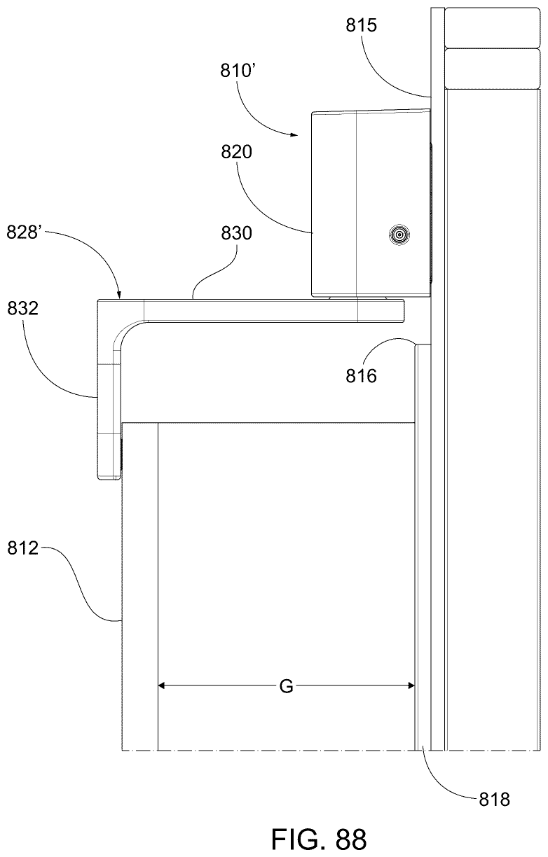

While the embodiment of the doorstop assembly 810 shown in FIGS. 57-72 is configured for left hand-opening doors, variations of this doorstop assembly for use with right hand opening doors are also contemplated. A doorstop assembly 810′ according to an embodiment for use with right hand opening-doors is shown in FIGS. 73-88. Unless otherwise described below, the doorstop assembly 810′ includes the same or similar components as the doorstop assembly 810, and operates in the same or similar fashion.

Components of the doorstop assembly 810′ that are specifically configured for use with right hand opening doors are denoted with the same reference numeral as the corresponding “mirror-image” elements that are specifically configured for use with left hand opening doors (i.e., in the doorstop assembly 810), along with a ′. Such components include the base 824′, cover 826′ and L-shaped arm member 828′ (and components thereof) configured for use with right hand opening doors. The remaining components of the doorstop assembly 810′ are the same as (i.e., identical to) those of the doorstop assembly 810, and are positioned specifically for use with right hand opening doors, as opposed to use with left hand opening doors. The ability to use these components with both right-hand opening doors and left-hand opening doors eliminates the need to manufacture different components for use with one door type or the other, and therefore simplifies the manufacturing process and provides economic savings. To simplify the description of such components, unless indicated otherwise, references to the doorstop assembly 810 below should be understood to include both the doorstop assembly 810 and the doorstop assembly 810′.

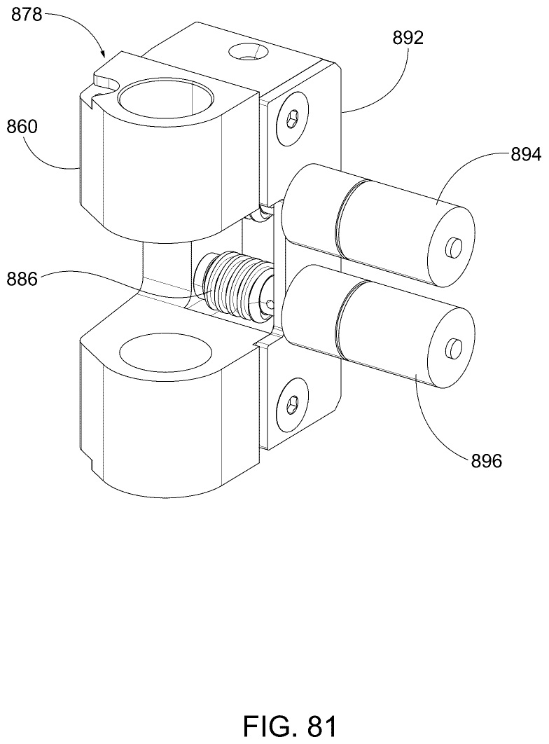

One example of such a component is the gear train bracket 860. The gear train bracket 860 is placed in a first position as part of the doorstop assembly 810 for use with left hand opening-doors, as shown in FIG. 65. The identical gear train bracket 860 is placed in a second position as part of the doorstop assembly 810′ for use with right hand opening-doors, as shown in FIG. 81, wherein the second position is an inverted version of the first position.

Another such component is the circuit board 900, which includes the rotary potentiometer 904 as part of the doorstop assembly 810 for use with left hand opening-doors. As illustrated in FIG. 68, the circuit board 900 also includes a second rotary potentiometer 904′ for when the circuit board 900 is incorporated into the doorstop assembly 810′ for use with right hand opening-doors. In other words, the circuit board 900 is configured for use with both the doorstop assembly 810 (wherein the first rotary potentiometer 904 engages the first end 834a of the shaft 834) and the doorstop assembly 810′ (wherein the second rotary potentiometer 904′ engages the first end 834a of the shaft 834 via a D-shaped opening 904a′ that is configured to receive the D-shaped head 898 of the bolt 874 extending from the first end 834a of the shaft 834, as described above in connection with the potentiometer 904). As also illustrated in FIG. 68, the microcontroller 906, accelerometer 908, and siren/speaker 910 are located on the circuit board 900 as well.

The activation means that is used to cause the deployment of the doorstop assembly 810 can include any suitable electro-mechanical means known in the art. Actuation of any such means can be accomplished by, for instance, a manual, wall-mounted switch or button (not shown). Alternatively, the activation means of the doorstop assembly 810 can be actuated remotely via software provided on a mobile phone or similar device (not shown).

In some embodiments of the doorstop assembly 810, the activation means and/or remote actuators used in the operation of the doorstop assembly 810 includes “panic button” means, by which may be used to the activate/trigger the siren/speaker 910. Activation of the panic button also locks the arm member 828 in place.

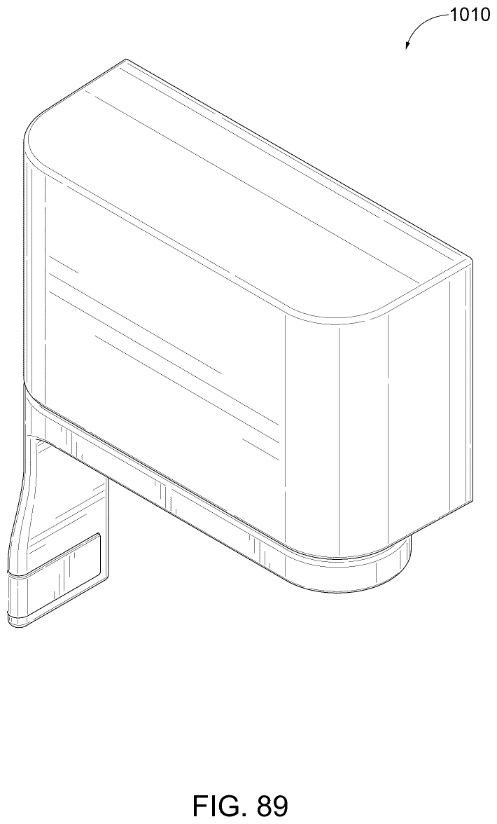

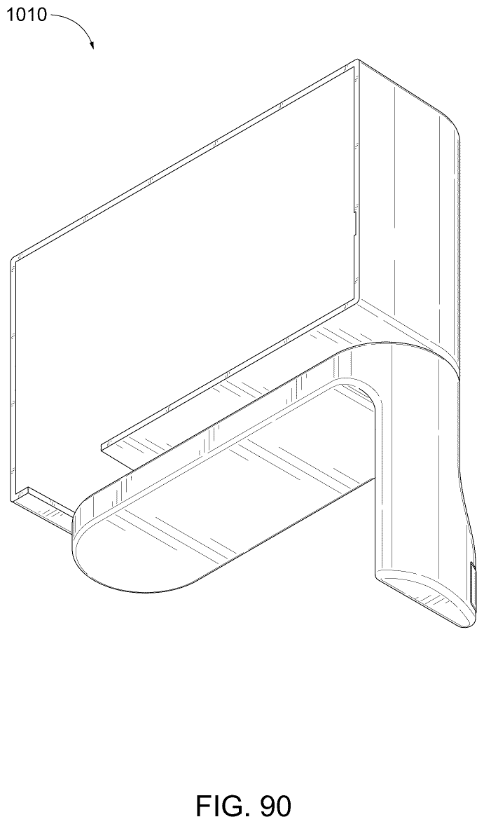

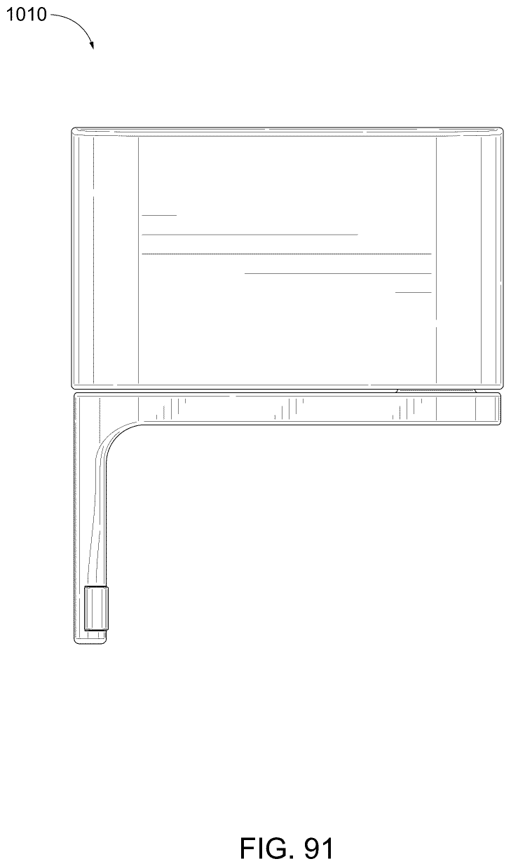

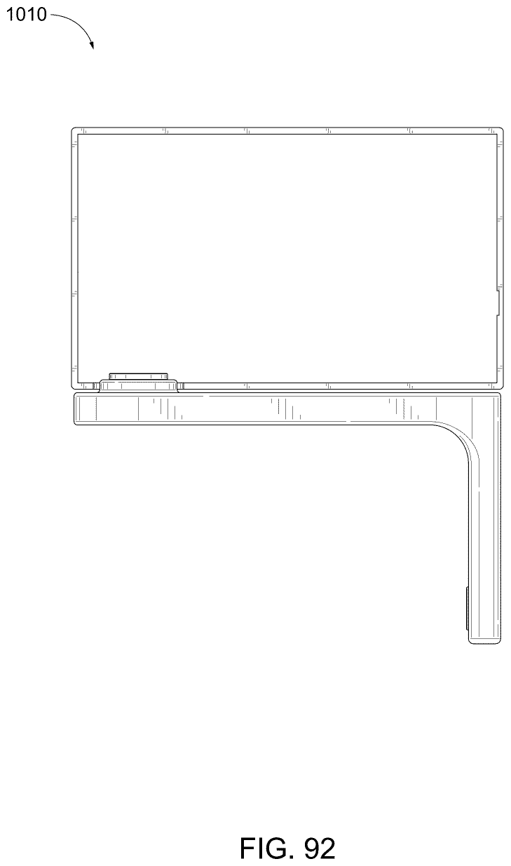

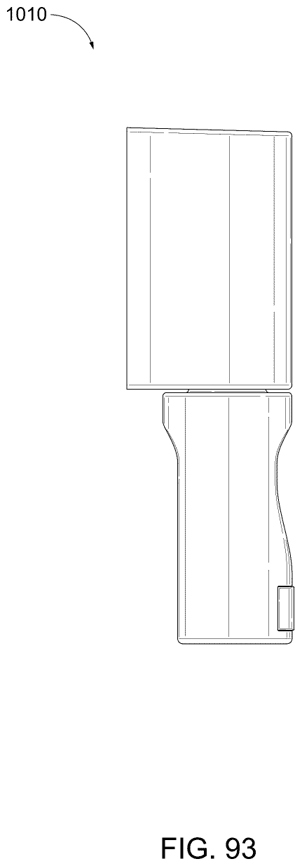

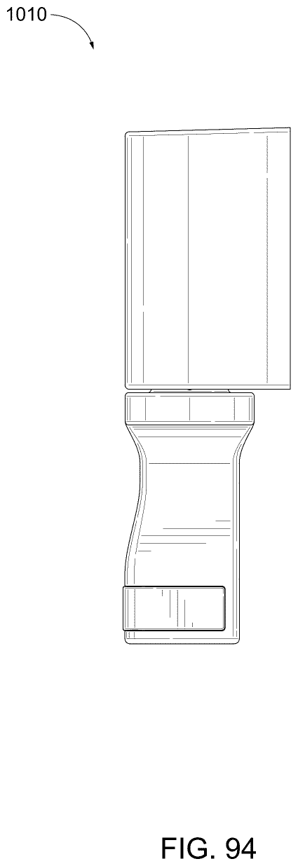

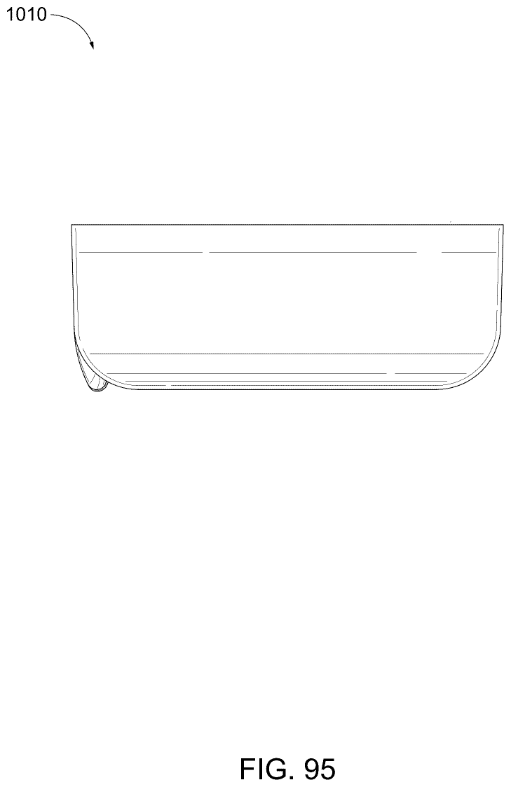

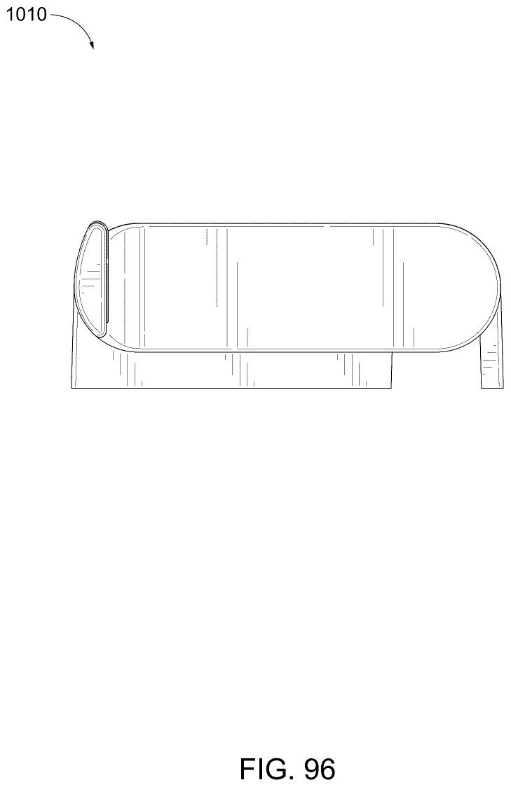

FIGS. 89-96 illustrate an embodiment of a doorstop assembly 1010 configured for use with left hand opening doors.

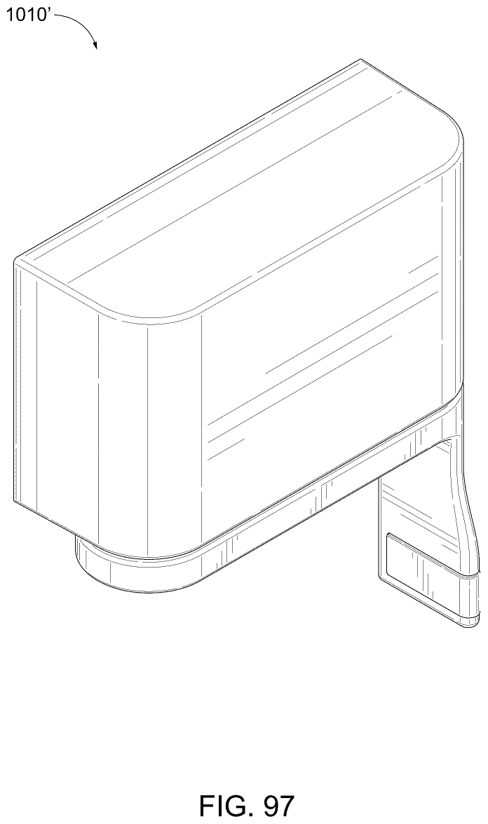

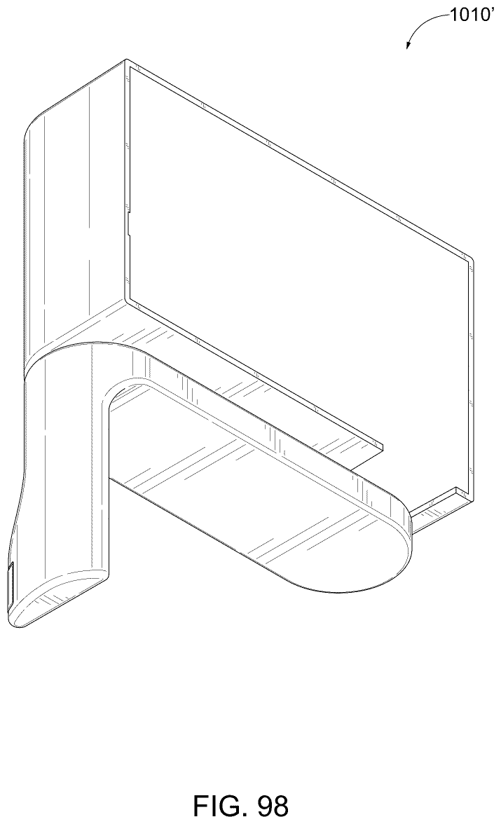

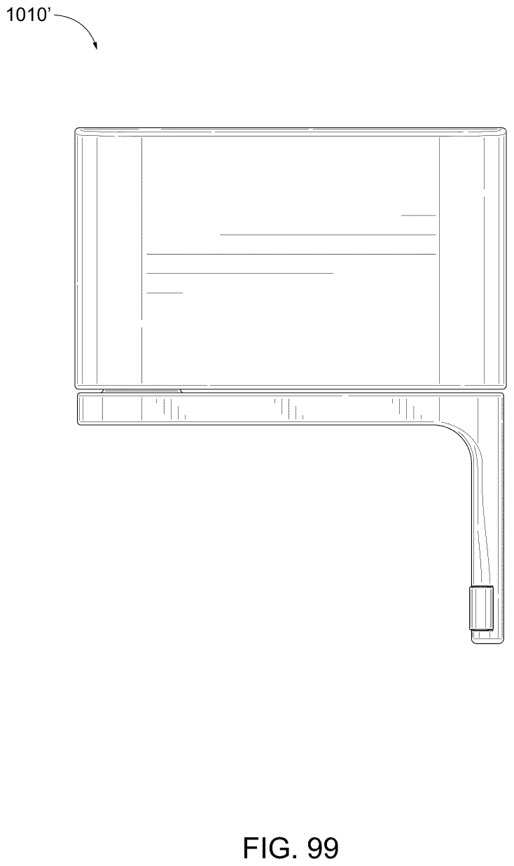

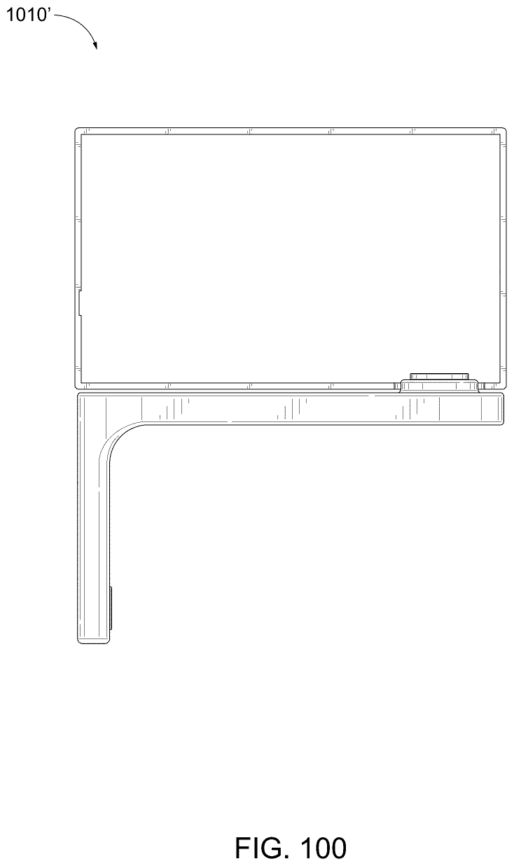

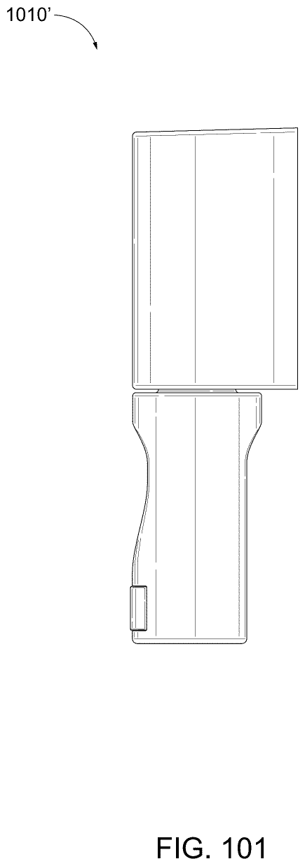

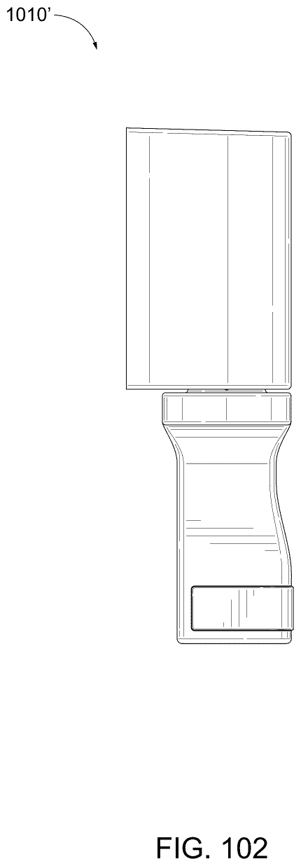

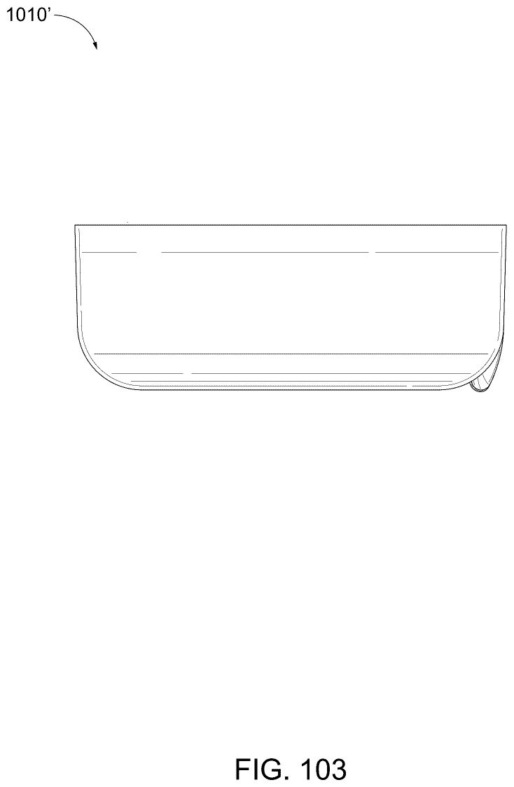

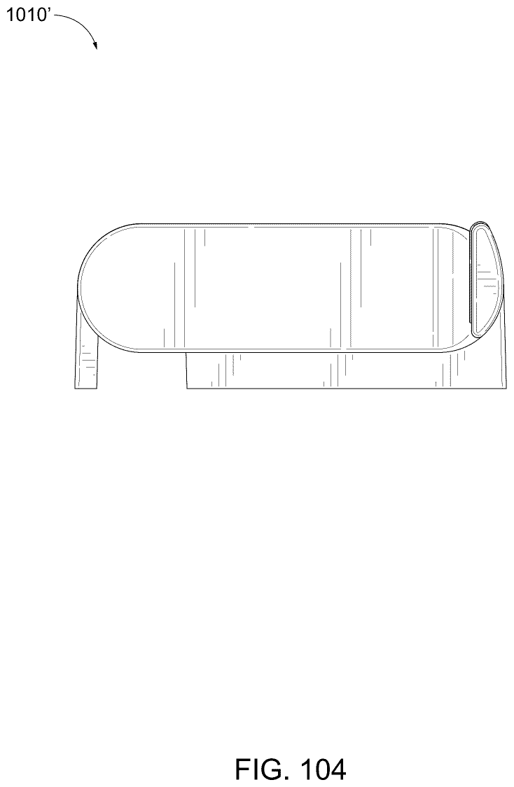

FIGS. 97-104 illustrate an embodiment of a doorstop assembly 1010′ configured for use with right hand opening doors.

It will be understood that the embodiments described herein are merely exemplary and that a person skilled in the art may make many variations and modifications without departing from the spirit and scope of the invention. For instance, all of the embodiments described herein can be actuated in the same manner as the embodiment of FIGS. 1-3 (i.e., by manual means or remotely via a mobile phone or similar device). All such variations and modifications are intended to be included within the scope of the invention described and illustrated herein and the appended claims.

1. A doorstop assembly (510; 610; 710) for a swingable entranceway door (512; 612; 712) having an upper edge bordered by a header (516; 616; 716) of a doorframe (514; 614; 714) mounted in a wall (529; 629; 729), said doorstop assembly comprising:
a base (524; 624; 724) configured to be secured to the wall (529; 629; 729) at a location above and proximate the header (516; 616; 716) of the doorframe (514; 614; 714);
an arm assembly (522; 622; 722) pivotably attached to said base, said arm assembly including means (540, 542a, 542b, 544; 640, 642a, 642b, 644; 746, 748a, 748b, 750) for allowing movement of said arm assembly between an inactive position, in which said arm assembly is located proximate the wall and out of contact with the door, whether it is closed or being swung open, and an active position, in which said arm assembly is remote from the wall and oriented to arrest the movement of the door as it is being swung open, thereby preventing the door from being fully opened, at least a portion of said arm assembly (522; 622; 722) having an adjustable length such that a distance between the wall and an end of said arm assembly (522; 622; 722) farthest from the wall is variable, wherein said arm assembly (522; 622; 722) is configured to pivot vertically from its inactive position to its active position; and
a housing (520; 620; 720) configured to contain at least a portion of said arm assembly (522; 622; 722) when said arm assembly (522; 622; 722) is in its inactive position;
wherein said base (524; 624; 724) forms part of said housing (520; 620; 720);
wherein at least a portion of said arm assembly is stored substantially within said base when said arm assembly is in its inactive position;
wherein at least a portion of said arm assembly is deployed substantially outside of said base when said arm assembly is in its active position;
wherein said base (524; 624; 724) has an open face and a removable cover (526; 626; 726) configured to be secured to said open face; and
wherein said cover (526; 626; 726) includes a slot (528; 628; 728) configured to allow passage of said arm assembly (522; 622; 722) from said base (524; 624; 724) through said cover (526; 626; 726).

2. The doorstop assembly (510; 710) of claim 1, wherein said arm assembly (522; 722) includes a pivotable rod (530; 730) having an adjustable length.

3. The doorstop assembly (510; 710) of claim 2, wherein said pivotable rod (530; 730) is pivotably connected to said movement allowing means (540, 542a, 542b, 544; 746, 748a, 748b, 750).

4. The doorstop assembly (710) of claim 3, wherein said pivotable rod (730) is pivotably connected to the movement allowing means (746, 748a, 748b, 750) and configured to adjust a length of said pivotable rod without having to disassemble said doorstop assembly;
wherein said pivotable rod includes a (i) first rod portion (732) with opposed first and second ends (732a, 732b), (ii) a second rod portion (734) with opposed first and second ends (734a, 734b), and (iii) a threaded bolt (736) that extends between and connects said first and second rod portions (732, 734);
wherein said doorstop assembly further comprises a nut (738) threadably engaging said threaded bolt;
wherein said threaded bolt and said nut are configured to cooperate to enable adjustment of the length of said pivotable rod to accommodate doors of different dimensions and/or adjust the distance an associated door may be opened when said arm assembly (722) is in its active position;
wherein said first end of said second rod portion includes an opening that is configured to threadably and rotatably receive a proximal end of said threaded bolt such that the distance said threaded bolt extends from said second rod portion can be varied to adjust the length of said pivotable rod;
wherein a distal end of said threaded bolt is fixedly secured within said second end of said first rod portion such that said threaded bolt does not rotate relative to said first rod portion, whereby said first rod portion is configured to conjointly rotate said threaded bolt and thereby adjust the length of said pivotable rod; and
wherein said threaded bolt is moveable between a fixed position in relation to said second rod portion, in which said nut is in contact with said first end of said second rod portion, and an adjustable position in which said threaded bolt is free to rotate relative to said second rod portion, in which said nut is rotated to not be in contact with said first end of said second rod portion.

5. The doorstop assembly (510) of claim 3, wherein said pivotable rod (530) includes a first end (530a) and said arm assembly (522) further includes a hollow leg (534) being configured to receive at least said first end (530a) of said pivotable rod (530) therein.

6. The doorstop assembly (510) of claim 5, further comprising connection means (551, 552, 553) for releasably securing said first end (530a) of said pivotable rod (530) within said hollow leg (534).

7. The doorstop assembly (510) of claim 6, wherein said connection means includes a bolt (551), an aperture (552) formed in said pivotable rod (530) and an aligned aperture (553) formed in said hollow leg (534), said aperture (552) and said aligned aperture (553) being configured to receive said bolt (551) therethrough.

8. The doorstop assembly (510) of claim 7, further comprising an internal threading mechanism (554) within said pivotable rod (530), said internal threading mechanism (554) being configured to enable adjustment of the length of said pivotable rod (530) to accommodate doors of different dimensions and/or adjust the distance which the door (512) may be opened when said doorstop assembly (510) is in its operational position.

9. The doorstop assembly (610) of claim 1, wherein said arm assembly (622) includes a rotating linear actuator (630) having an inner member (632) and an outer member (634) telescopically engaging the inner member (632) and having opposed first and second ends (634a, 634b), said first end (634a) of said outer member (634) being pivotably connected to said movement allowing means (640, 642a, 642b, 644).

10. The doorstop assembly (610) of claim 9, wherein said arm assembly (622) further includes a first leg (636) extending from said first end (634a) of said outer member (634) of said linear actuator (630), at least part of said first leg (636) being configured to contact the door (612).

11. A doorstop assembly (410) for a swingable entranceway door (412) having an upper edge bordered by a header (416) of a doorframe (414) mounted in a wall (429), said doorstop assembly comprising:
a base (422) configured to be secured to the wall (429) at a location above and proximate the header (416) of the doorframe (414);
an arm assembly (420) attachable to the wall (429) at a location proximate the header of the doorframe, said arm assembly including an arm member (420) having opposed first and second ends (420a, 420b);
means (424a, 424b 424c) for allowing movement of said arm assembly between an inactive position, in which said arm assembly is located proximate the wall and out of the contact with the door, whether it is closed or being swung open, and an active position, in which said arm assembly is remote from the wall and oriented to arrest the movement of the door as it is being swung open, thereby preventing the door from being fully opened, said means including one component of a hinge (424a) positioned on said first arm end (420a), another cooperating component of a hinge (424b) positioned on said base (422), and a pin (424c), both of said hinge components (424a, 424b) interdigitating to define a cylindrical space configured to receive said pin (424c) therethrough;
an actuator subassembly (430) positioned proximate said first arm end (420a) and configured to cause said arm member (420) to pivot away from the wall (429) between its active position and its inactive position;
a piston subassembly (444) positioned proximate said second arm end (420b) and including a housing (446) and a piston (448) that extends from within said housing (446); and
a door dock (450) having a first portion configured to be secured to the door (412) and a second portion configured to receive a portion of said piston (448) therethrough when said arm member (420) is in its inactive position;
wherein said arm assembly (420) is configured to be pivotable horizontally from its inactive position to its active position.
